(19) United States
(12) Patent Application Publication
(10) Pub. No.: US 2024/0395257 A1
(43) Pub. Date: Nov. 28, 2024

(54) CONCURRENCY RULES FOR NETWORK MICROPHONE DEVICES HAVING MULTIPLE VOICE ASSISTANT SERVICES

(71) Applicant: Sonos, Inc., Santa Barbara, CA (US)

(72) Inventors: Bryan Cox, Edmonds, WA (US); Joshua Adler, Santa Barbara, CA (US); Andi Rusu, Seattle, WA (US); Joseph Dureau, Paris (FR); Luis R. Vega Zayas, Arlington, MA (US)

(21) Appl. No.: 18/693,793

(22) PCT Filed: Sep. 23, 2022
(86) PCT No.: PCT/US2022/076972

§ 371 Date: Mar. 20, 2024

Related U.S. Application Data
(60) Provisional application No. 63/261,611, filed on Sep. 24, 2021.

(51) Int. Cl. G10L 15/32; G10L 15/08; G10L 15/22; G10L 15/30

(52) U.S. Cl. CPC G10L 15/32; G10L 15/08; G10L 15/22; G10L 15/30; G10L 2015/088; G10L 2015/223

(57) ABSTRACT

Systems and methods for managing concurrent voice assistants are disclosed. An example method includes associating a first play back device with a first voice assistant service (VAS). A command is received to form a synchrony group for synchronous audio playback, the group including the first playback device and a second playback device. The method includes obtaining a determination that the second playback device is associated with a second VAS different from the first VAS. A rules engine is accessed to determine concurrency restrictions. Based on the restrictions: (i) the first playback device is disassociated from the first VAS, (ii) the second playback device is disassociated with the second VAS, or (iii) the formation of the synchrony group is precluded.

### CROSS-REFERENCE TO RELATED APPLICATION

The application claims priority to U.S. Patent Application No. 63/261,611, filed Sep. 24, 2021, which is incorporated herein by reference in its entirety

### FIELD OF THE DISCLOSURE

The present disclosure is related to consumer goods and, more particularly, to methods, systems, products, features, services, and other elements directed to media play back or some aspect thereof

### BACKGROUND

Options for accessing and listening to digital audio in an out-loud setting were limited until in 2002, when SONOS, Inc. began development of a new type of play back system. Sonos then filed one of its first patent applications in 2003, entitled “Method for Synchronizing Audio Playback between Multiple Networked Devices,” and began offering its first media playback systems for sale in 2005. The Sonos Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to play back devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A is a partial cutaway view of an environment having a media playback system configured in accordance with aspects of the disclosed technology.

FIG. 1B is a schematic diagram of the media playback system of FIG. 1A and one or more networks.

FIG. 2A is a functional block diagram of an example playback device.

FIG. 2B is an isometric diagram of an example housing of the play back device of FIG. 2A.

FIG. 2C is a diagram of an example voice input.

FIG. 2D is a graph depicting an example sound specimen in accordance with aspects of the disclosure.

FIGS. 3A, 3B, 3C, 3D and 3E are diagrams showing example playback device configurations in accordance with aspects of the disclosure.

FIG. 4 is a functional block diagram of an example controller device in accordance with aspects of the disclosure.

FIGS. 5A and 5B are controller interfaces in accordance with aspects of the disclosure.

FIG. 6 is a message flow diagram of a media play back system.

FIG. 7 is a functional block diagram of certain components of an example network microphone device in accordance with aspects of the disclosure.

FIG. 8 is an example message flow diagram between a media playback system and a voice assistant service.

FIGS. 9A and 9B are example tables illustrating concurrency restrictions for voice assistant services.

FIGS. 10A-10G illustrate example states of various voice assistant services for a network microphone device based on concurrency restrictions.

FIG. 11 is a flow diagram of a method for managing concurrency of voice assistant services.

FIGS. 12A-12W illustrate an example process and associated user interfaces for managing concurrency of voice assistant services.

FIGS. 13A-13L illustrate several example user interfaces in accordance with aspects of the disclosure.

FIGS. 14A-14X illustrate an example process and associated user interfaces for bonding playback devices having voice-control capabilities.

FIGS. 15A-15J illustrate an example process and associated user interfaces for setting up a native voice assistant service.

The drawings are for the purpose of illustrating example embodiments, but those of ordinary skill in the art will understand that the technology disclosed herein is not limited to the arrangements and/or instrumentality shown in the drawings.

### DETAILED DESCRIPTION

### I. Overview

Voice control can be beneficial for a “smart” home having smart appliances and related devices, such as wireless illumination devices, home-automation devices (e.g., thermostats, door locks, etc.), and audio playback devices. In some implementations, a networked microphone device (NMD) (which may be a component of a playback device) may be used to control smart home devices. A network microphone device will typically include a microphone for receiving voice inputs. The network microphone device can forward voice inputs to a voice assistant service (VAS), such as AMAZON's ALEXA, APPLE's SIRI, MICROSOFT's CORTANA, GOOGLE's Assistant, etc. A VAS may be a remote service implemented by cloud servers to process voice inputs. A VAS may process a voice input to determine an intent of the voice input. Based on the response, the network microphone device may cause one or more smart devices to perform an action. For example, the network microphone device may instruct an illumination device to turn on/off based on the response to the instruction from the VAS.

A voice input detected by a network microphone device will typically include an activation word followed by an utterance containing a user request. The activation word is typically a predetermined word or phrase used to “wake up” and invoke the VAS for interpreting the intent of the voice input. For instance, in querying AMAZON's ALEXA, a user might speak the activation word “Alexa.” Other examples include “Ok, Google” for invoking GOOGLE's Assistant, and “Hey, Siri” for invoking APPLE's SIRI, or “Hey, Sonos” for a VAS offered by SONOS. In various examples, an activation word may also be referred to as, e.g., a wake-, trigger-, wakeup-word or phrase, and may take the form of any suitable word: combination of words, such as phrases; and/or audio cues indicating that the network microphone device and/or an associated VAS is to invoke an action.

There are several different types of VASes. For example, a native VAS may pre-installed or otherwise integrated into the NMD and configured primarily for enabling voice control of the NMD itself or other devices of the media playback system of which the NMD is a part. There may be one or more general-purpose VASes, also referred to herein as general or “ask-anything” VASes. These general-purpose VASes can be configured to perform a wide variety of tasks across many domains, such as media playback, information retrieval (e.g., weather reports, stock prices), alarm setting, calendar control, etc. AMAZON'S ALEXA, GOOGLE'S Assistant, APPLE'S SIRI, and MICROSOFT'S CORTANA are each examples of such general-purposes VASes. Another type of VAS is a special-purpose VAS, which may be configured to provide functionality over a relatively limited domain. For example, a special-purpose VAS may be configured to provide smart-home functionality, allowing a user to control lighting, climate control, or home security systems, etc. Another special-purpose VAS may be configured to allow a user to interact with a particular media provider (e.g., XFINITY Voice Remote).

In some instances, a user may wish to utilize multiple VASes within her home or even using a single device. While it can be useful to enable a single NMD to interact with multiple VASes, providing multiple concurrently enabled VASes can lead to poor user experience in some cases. As a result, in some instances, it may be undesirable to concurrently enable certain combinations of VASes on a single NMD or a within a single media play back system including multiple NMDs. For example, if the wake words associated with two different VASes are too similar, the concurrent operation of the two VASes may lead to errors in which a user intends to interact with one VAS but inadvertently enables the other VAS. As another example, if two different VASes are each configured to control the same external equipment (e.g., two different special-purpose VASes that can control the same household appliance), concurrently enabling both VASes can lead to user frustration as one or the other VAS responds to appliance-specific commands in various situations. In still other cases, enabling concurrent VASes can unduly burden the computational resources of a network microphone device, leading to a reduction in device performance. As another example, certain VASes may themselves impose restrictions on which other VASes can be concurrently enabled on a network microphone device. In these and other instances, it may be useful or necessary to limit which VASes may be concurrently enabled on an NMD or a media playback system including multiple NMDs. Such limitations can include, for example, precluding certain VASes from being concurrently enabled, or limiting an overall number of VASes that can be enabled.

In various examples, a VAS can be considered to be associated with or enabled on an NMD by virtue of having software installed and operational on the NMD that facilitates communication between the NMD and one or more remote computing devices associated with that particular VAS. Additionally or alternatively, the VAS can be considered to be associated with or enabled on an NMD by virtue of an operable wake-word engine running on the NMD that is configured to detect one or more wake words associated with that particular VAS. Additionally, a VAS can be considered to be disassociated with or disabled with respect to the NMD by either being placed in an inactive state (e.g., the software such as the wake-word engine remains on the NMD but is not actively operating to detect wake words in voice input) or by being completely removed (e.g. uninstalled or deleted) from the NMD.

Embodiments of the present technology include a concurrency rules engine that provides concurrency restrictions for VASes associated with one or more NMDs. As used herein, a “concurrency rules engine” may also be referred to as a concurrency policy manager or a concurrency state machine, or any other functional component that facilitates management of various concurrency restrictions for one or more NMDs. In various examples, a concurrency rules engine can be stored locally on an NMD or can be maintained at on or more remote computing devices that are accessible to the NMD via a network connection. In operation, an NMD that is already associated with at least a first VAS may receive a request to be associated with a second VAS (and/or to enable a wake-word engine associated with a second VAS). Following this request, the NMD may access the rules engine to determine whether any concurrency restrictions apply that may prohibit the concurrent enablement of the first and second VASes on the same NMD. If no concurrency restrictions apply, the NMD may proceed to associate with the second VAS, after which the NMD can be concurrently associated with the first VAS and the second VAS. If some concurrency restriction does apply (for example, there is a prohibition of concurrent enablement of both the first VAS and second VAS), the NMD may either disable or otherwise disassociate with the first VAS and enable the second VAS, or the NMD may preclude association with the second VAS and maintain association with the first VAS. In some instances, the concurrency rules engine can include prioritization in rules that dictate which VAS will prevail in the event of a concurrency prohibition. In some examples, the most recently selected VAS may prevail in the event of a concurrency restriction. In other examples, the prioritization rules may dictate that a native VAS prevail over a third-party VAS in the event of a concurrency restriction. According to some examples, an indication can be provided to the user regarding which VAS has been enabled and which, if any, has been disabled.

While some examples described herein may refer to functions performed by given actors such as “users,” “listeners,” and/or other entities, it should be understood that this is for purposes of explanation only. The claims should not be interpreted to require action by any such example actor unless explicitly required by the language of the claims themselves.

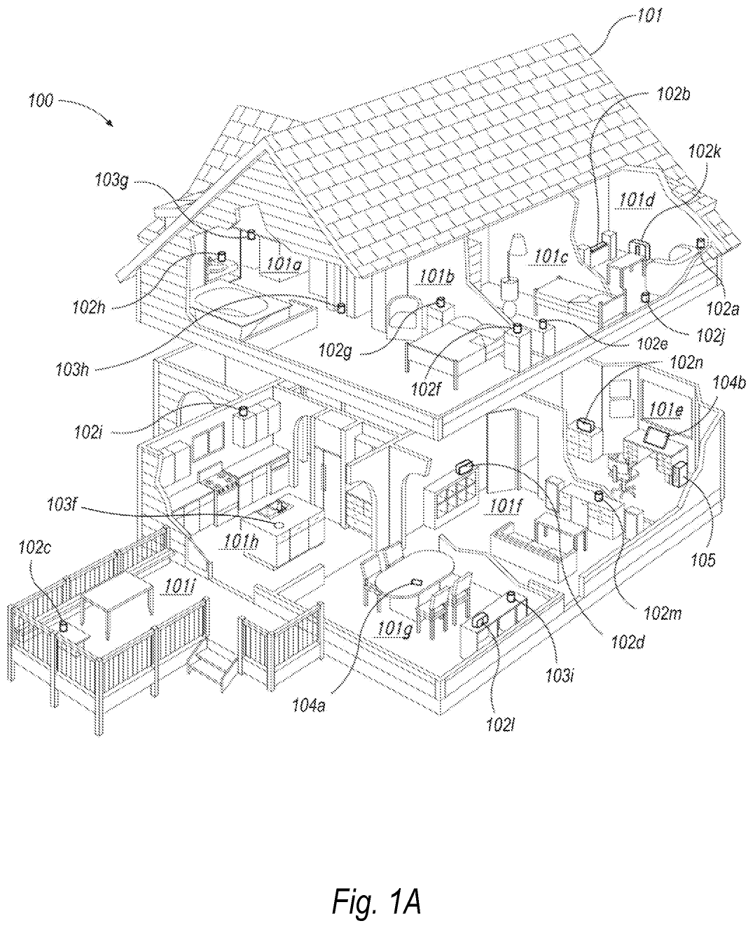

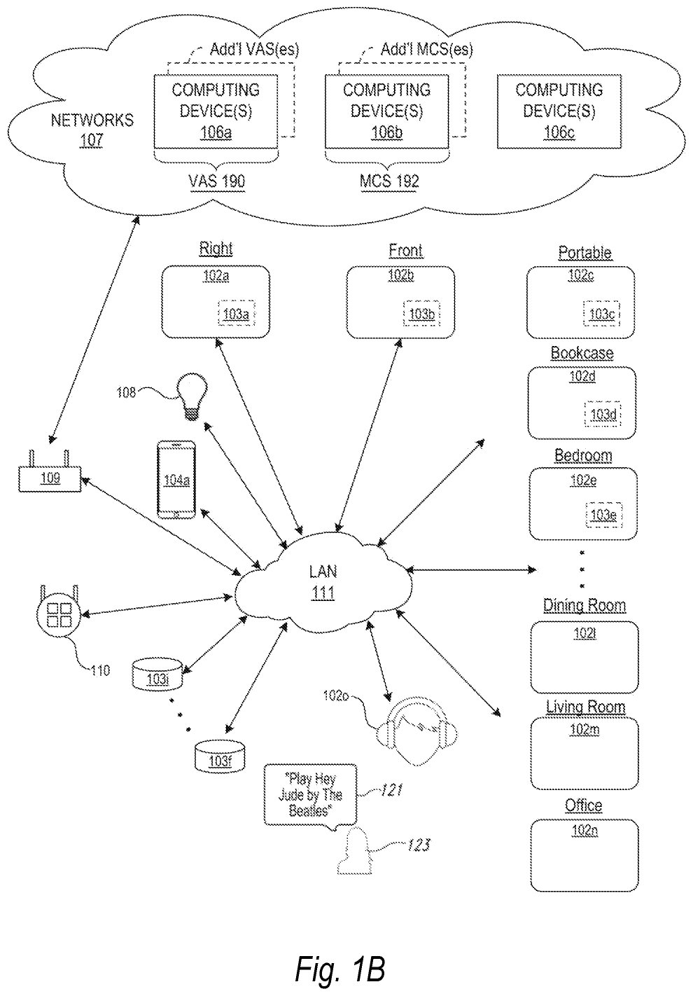

In the Figures, identical reference numbers identify generally similar, and/or identical, elements. To facilitate the discussion of any particular element, the most significant digit or digits of a reference number refers to the Figure in which that element is first introduced. For example, element 110a is first introduced and discussed with reference to FIG. 1A. Many of the details, dimensions, angles and other features shown in the Figures are merely illustrative of particular embodiments of the disclosed technology. Accordingly, other embodiments can have other details, dimensions, angles and features without departing from the spirit or scope of the disclosure. In addition, those of ordinary skill in the art will appreciate that further embodiments of the various disclosed technologies can be practiced without several of the details described below.

### II. Example Operation Environment

FIGS. 1A and 1B illustrate an example configuration of a media play back system 100 (or “MPS 100”) in which one or more embodiments disclosed herein may be implemented. Referring first to FIG. 1A, the MPS 100 as shown is associated with an example home environment having a plurality of rooms and spaces, which may be collectively referred to as a “home environment,” “smart home,” or “environment 101.” The environment 101 comprises a household having several rooms, spaces, and/or playback zones, including a master bathroom 101a, a master bedroom 101b, (referred to herein as “Nick's Room”), a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some examples, for instance, the MPS 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

Within these rooms and spaces, the MPS 100 includes one or more computing devices. Referring to FIGS. 1A and 1B together, such computing devices can include playback devices 102 (identified individually as playback devices 102a-1020), network microphone devices 103 (identified individually as “NMDs” 103a-102i), and controller devices 104a and 104b (collectively “controller devices 104”). Referring to FIG. 1B, the home environment may include additional and/or other computing devices, including local network devices, such as one or more smart illumination devices 108 (FIG. 1B), a smart thermostat 110, and a local computing device 105 (FIG. 1A). In examples described below; one or more of the various playback devices 102 may be configured as portable play back devices, while others may be configured as stationary playback devices. For example, the headphones 1020 (FIG. 1B) are a portable play back device, while the play back device 102d on the bookcase may be a stationary device. As another example, the play back device 102c on the Patio may be a battery-powered device, which may allow it to be transported to various areas within the environment 101, and outside of the environment 101, when it is not plugged in to a wall outlet or the like.

With reference still to FIG. 1B, the various playback, network microphone, and controller devices 102, 103, and 104 and/or other network devices of the MPS 100 may be coupled to one another via point-to-point connections and/or over other connections, which may be wired and/or wireless, via a network 111, such as a local area network (LAN) which may include a network router 109. As used herein, a local area network can include any communications technology that is not configured for wide area communications, for example, WiFi, Bluetooth, Digital Enhanced Cordless Telecommunications (DECT), Ultra-WideBand, etc. For example, the playback device 102j in the Den 101d (FIG. 1A), which may be designated as the “Left” device, may have a point-to-point connection with the play back device 102a, which is also in the Den 101d and may be designated as the “Right” device. In a related example, the Left playback device 102j may communicate with other network devices, such as the playback device 102b, which may be designated as the “Front” device, via a point-to-point connection and/or other connections via the NETWORK 111.

As further shown in FIG. 1B, the MPS 100 may be coupled to one or more remote computing devices 106 via a wide area network (“WAN”) 107. In some examples, each remote computing device 106 may take the form of one or more cloud servers. The remote computing devices 106 may be configured to interact with computing devices in the environment 101 in various ways. For example, the remote computing devices 106 may be configured to facilitate streaming and/or controlling play back of media content, such as audio, in the home environment 101.

In some implementations, the various play back devices, NMDs, and/or controller devices 102-104 may be communicatively coupled to at least one remote computing device associated with a VAS and at least one remote computing device associated with a media content service (“MCS”). For instance, in the illustrated example of FIG. 1B, remote computing devices 106 are associated with a VAS 190 and remote computing devices 106b are associated with an MCS 192. Although only a single VAS 190 and a single MCS 192 are shown in the example of FIG. 1B for purposes of clarity, the MPS 100 may be coupled to multiple, different VASes and/or MCSes. In some implementations, VASes may be operated by one or more of AMAZON, GOOGLE, APPLE, MICROSOFT, SONOS or other voice assistant providers. In some implementations, MCSes may be operated by one or more of SPOTIFY, PANDORA, AMAZON MUSIC, or other media content services.

As further shown in FIG. 1B, the remote computing devices 106 further include remote computing device 106c configured to perform certain operations, such as remotely facilitating media playback functions, managing device and system status information, directing communications between the devices of the MPS 100 and one or multiple VASes and/or MCSes, among other operations. In one example, the remote computing devices 106c provide cloud servers for one or more SONOS Wireless HiFi Systems.

In various implementations, one or more of the playback devices 102 may take the form of or include an on-board (e.g., integrated) network microphone device. For example, the play back devices 102a-e include or are otherwise equipped with corresponding NMDs 103a-e, respectively. A playback device that includes or is equipped with an NMD may be referred to herein interchangeably as a playback device or an NMD unless indicated otherwise in the description. In some cases, one or more of the NMDs 103 may be a stand-alone device. For example, the NMDs 103f and 103g may be stand-alone devices. A stand-alone NMD may omit components and/or functionality that is typically included in a playback device, such as a speaker or related electronics. For instance, in such cases, a stand-alone NMD may not produce audio output or may produce limited audio output (e.g., relatively low-quality audio output).

The various play back and network microphone devices 102 and 103 of the MPS 100 may each be associated with a unique name, which may be assigned to the respective devices by a user, such as during setup of one or more of these devices. For instance, as shown in the illustrated example of FIG. 1B, a user may assign the name “Bookcase” to play back device 102d because it is physically situated on a bookcase. Similarly, the NMD 103f may be assigned the named “Island” because it is physically situated on an island countertop in the Kitchen 101h (FIG. 1A). Some playback devices may be assigned names according to a zone or room, such as the playback devices 102e, 102l, 102m, and 102n, which are named “Bedroom,” “Dining Room,” “Living Room,” and “Office,” respectively. Further, certain play back devices may have functionally descriptive names. For example, the playback devices 102a and 102b are assigned the names “Right” and “Front,” respectively, because these two devices are configured to provide specific audio channels during media playback in the zone of the Den 101d (FIG. 1A). The playback device 102c in the Patio may be named portable because it is battery-powered and/or readily transportable to different areas of the environment 101. Other naming conventions are possible.

As discussed above, an NMD may detect and process sound from its environment, such as sound that includes background noise mixed with speech spoken by a person in the NMD's vicinity. For example, as sounds are detected by the NMD in the environment, the NMD may process the detected sound to determine if the sound includes speech that contains voice input intended for the NMD and ultimately a particular VAS. For example, the NMD may identify whether speech includes a wake word associated with a particular VAS.

In the illustrated example of FIG. 1B, the NMDs 103 are configured to interact with the VAS 190 over a network via the network 111 and the router 109. Interactions with the VAS 190 may be initiated, for example, when an NMD identifies in the detected sound a potential wake word. The identification causes a wake-word event, which in turn causes the NMD to begin transmitting detected-sound data to the VAS 190. In some implementations, the various local network devices 102-105 (FIG. 1A) and/or remote computing devices 106c of the MPS 100 may exchange various feedback, information, instructions, and/or related data with the remote computing devices associated with the selected VAS. Such exchanges may be related to or independent of transmitted messages containing voice inputs. In some examples, the remote computing device(s) and the MPS 100 may exchange data via communication paths as described herein and/or using a metadata exchange channel as described in U.S. application Ser. No. 15/438,749 filed Feb. 21, 2017, and titled “Voice Control of a Media Playback System,” which is herein incorporated by reference in its entirety.

Upon receiving the stream of sound data, the VAS 190 determines whether there is voice input in the streamed data from the NMD, and if so the VAS 190 will also determine an underlying intent in the voice input. The VAS 190 may next transmit a response back to the MPS 100, which can include transmitting the response directly to the NMD that caused the wake-word event. The response is typically based on the intent that the VAS 190 determined was present in the voice input. As an example, in response to the VAS 190 receiving a voice input with an utterance to “Play Hey Jude by The Beatles,” the VAS 190 may determine that the underlying intent of the voice input is to initiate playback and further determine that intent of the voice input is to play the particular song “Hey Jude.” After these determinations, the VAS 190 may transmit a command to a particular MCS 192 to retrieve content (i.e., the song “Hey Jude”), and that MCS 192, in turn, provides (e.g., streams) this content directly to the MPS 100 or indirectly via the VAS 190. In some implementations, the VAS 190 may transmit to the MPS 100 a command that causes the MPS 100 itself to retrieve the content from the MCS 192.

In certain implementations, NMDs may facilitate arbitration amongst one another when voice input is identified in speech detected by two or more NMDs located within proximity of one another. For example, the NMD-equipped playback device 102d in the environment 101 (FIG. 1A) is in relatively close proximity to the NMD-equipped Living Room playback device 102m, and both devices 102d and 102m may at least sometimes detect the same sound. In such cases, this may require arbitration as to which device is ultimately responsible for providing detected-sound data to the remote VAS. Examples of arbitrating between NMDs may be found, for example, in previously referenced U.S. application Ser. No. 15/438,749. When performing local command-keyword detection, as described in more detail below; it may be useful to forego or delay any such arbitration, such that two or more NMDs may process the same voice input for command-keyword detection. This can allow results of voice processing of two or more different NMDS to be compared to one another as a way to cross-check keyword detection results. In some examples, results of NLU determinations associated with different NMDs can be used to arbitrate between them. For example, if a first NLU associated with a first NMD identifies a keyword with a higher confidence level than that of a second NLU associated with the second NMD, then the first NMD may be selected over the second NMD.

In certain implementations, an NMD may be assigned to, or otherwise associated with, a designated or default play back device that may not include an NMD. For example, the Island NMD 103f in the Kitchen 101h (FIG. 1A) may be assigned to the Dining Room playback device 102l, which is in relatively close proximity to the Island NMD 103f. In practice, an NMD may direct an assigned play back device to play audio in response to a remote VAS receiving a voice input from the NMD to play the audio, which the NMD might have sent to the VAS in response to a user speaking a command to play a certain song, album, playlist, etc. Additional details regarding assigning NMDs and playback devices as designated or default devices may be found, for example, in previously referenced U.S. Patent Application No.

Further aspects relating to the different components of the example MPS 100 and how the different components may interact to provide a user with a media experience may be found in the following sections. While discussions herein may generally refer to the example MPS 100, technologies described herein are not limited to applications within, among other things, the home environment described above. For instance, the technologies described herein may be useful in other home environment configurations comprising more or fewer of any of the play back, network microphone, and/or controller devices 102-104. For example, the technologies herein may be utilized within an environment having a single play back device 102 and/or a single NMD 103. In some examples of such cases, the NETWORK 111 (FIG. 1B) may be eliminated and the single play back device 102 and/or the single NMD 103 may communicate directly with the remote computing devices 106-d. In some examples, a telecommunication network (e.g., an LTE network, a 5G network, etc.) may communicate with the various play back, network microphone, and/or controller devices 102-104 independent of a LAN.

a. Example Playback & Network Microphone Devices

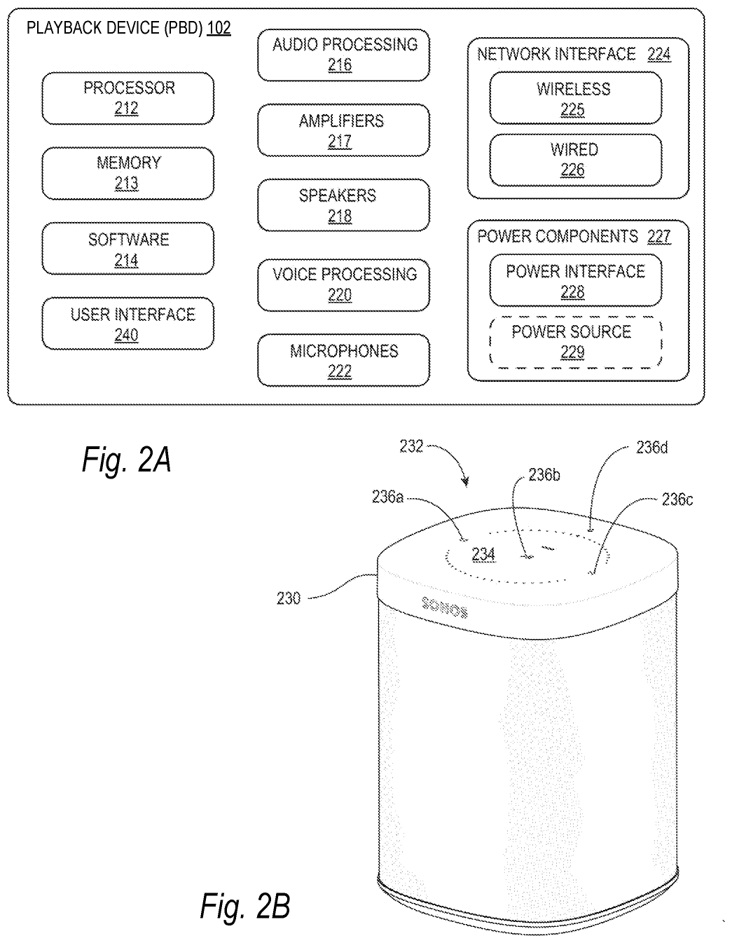

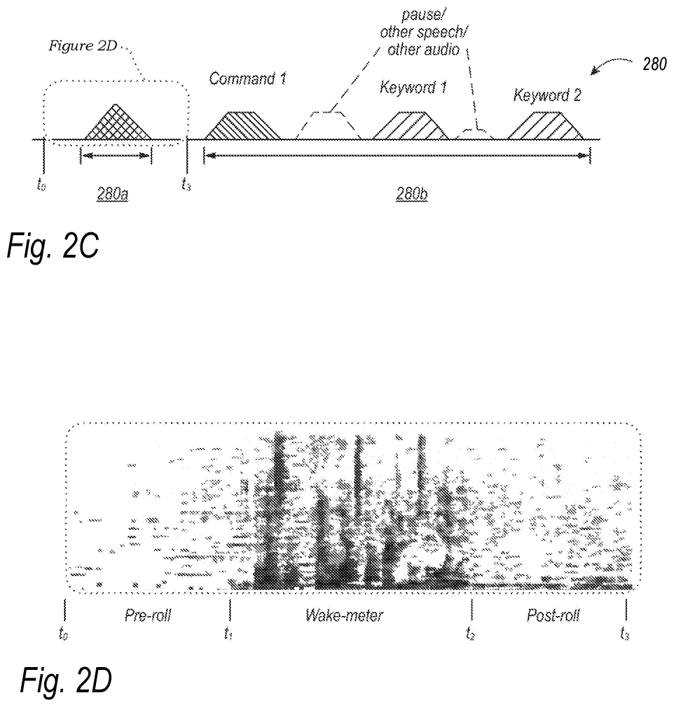

FIG. 2A is a functional block diagram illustrating certain aspects of one of the play back devices 102 of the MPS 100 of FIGS. 1A and 1B. As shown, the playback device 102 includes various components, each of which is discussed in further detail below, and the various components of the playback device 102 may be operably coupled to one another via a system bus, communication network, or some other connection mechanism. In the illustrated example of FIG. 2A, the play back device 102 may be referred to as an “NMD-equipped” playback device because it includes components that support the functionality of an NMD, such as one of the NMDs 103 shown in FIG. 1A.

As shown, the play back device 102 includes at least one processor 212, which may be a clock-driven computing component configured to process input data according to instructions stored in memory 213. The memory 213 may be a tangible, non-transitory, computer-readable medium configured to store instructions that are executable by the processor 212. For example, the memory 213 may be data storage that can be loaded with software code 214 that is executable by the processor 212 to achieve certain functions.

In one example, these functions may involve the playback device 102 retrieving audio data from an audio source, which may be another playback device. In another example, the functions may involve the playback device 102 sending audio data, detected-sound data (e.g., corresponding to a voice input), and/or other information to another device on a network via at least one network interface 224. In yet another example, the functions may involve the play back device 102 causing one or more other playback devices to synchronously play back audio with the playback device 102. In yet a further example, the functions may involve the playback device 102 facilitating being paired or otherwise bonded with one or more other playback devices to create a multi-channel audio environment. Numerous other example functions are possible, some of which are discussed below.

As just mentioned, certain functions may involve the playback device 102 synchronizing playback of audio content with one or more other playback devices. During synchronous playback, a listener may not perceive time-delay differences between play back of the audio content by the synchronized playback devices. U.S. Pat. No. 8,234,395 filed on Apr. 4, 2004, and titled “System and method for synchronizing operations among a plurality of independently clocked digital data processing devices,” which is hereby incorporated by reference in its entirety, provides in more detail some examples for audio playback synchronization among playback devices.

To facilitate audio playback, the play back device 102 includes audio processing components 216 that are generally configured to process audio prior to the play back device 102 rendering the audio. In this respect, the audio processing components 216 may include one or more digital-to-analog converters (“DAC”), one or more audio preprocessing components, one or more audio enhancement components, one or more digital signal processors (“DSPs”), and so on. In some implementations, one or more of the audio processing components 216 may be a subcomponent of the processor 212. In operation, the audio processing components 216 receive analog and/or digital audio and process and/or otherwise intentionally alter the audio to produce audio signals for play back.

The produced audio signals may then be provided to one or more audio amplifiers 217 for amplification and play back through one or more speakers 218 operably coupled to the amplifiers 217. The audio amplifiers 217 may include components configured to amplify audio signals to a level for driving one or more of the speakers 218.

Each of the speakers 218 may include an individual transducer (e.g., a “driver”) or the speakers 218 may include a complete speaker system involving an enclosure with one or more drivers. A particular driver of a speaker 218 may include, for example, a subwoofer (e.g., for low frequencies), a mid-range driver (e.g., for middle frequencies), and/or a tweeter (e.g., for high frequencies). In some cases, a transducer may be driven by an individual corresponding audio amplifier of the audio amplifiers 217. In some implementations, a play back device may not include the speakers 218, but instead may include a speaker interface for connecting the play back device to external speakers. In certain examples, a playback device may include neither the speakers 218 nor the audio amplifiers 217, but instead may include an audio interface (not shown) for connecting the play back device to an external audio amplifier or audio-visual receiver.

In addition to producing audio signals for playback by the playback device 102, the audio processing components 216 may be configured to process audio to be sent to one or more other play back devices, via the network interface 224, for playback. In example scenarios, audio content to be processed and/or played back by the playback device 102 may be received from an external source, such as via an audio line-in interface (e.g., an auto-detecting 3.5 mm audio line-in connection) of the play back device 102 (not shown) or via the network interface 224, as described below.

As shown, the at least one network interface 224, may take the form of one or more wireless interfaces 225 and/or one or more wired interfaces 226. A wireless interface may provide network interface functions for the playback device 102 to wirelessly communicate with other devices (e.g., other playback device(s), NMD(s), and/or controller device(s)) in accordance with a communication protocol (e.g., any wireless standard including IEEE 802.11a, 802.11b, 802.11g, 802.11n, 802.11ac, 802.15, 4G mobile communication standard, and so on). A wired interface may provide network interface functions for the play back device 102 to communicate over a wired connection with other devices in accordance with a communication protocol (e.g., IEEE 802.3). While the network interface 224 shown in FIG. 2A include both wired and wireless interfaces, the playback device 102 may in some implementations include only wireless interface(s) or only wired interface(s).

In general, the network interface 224 facilitates data flow between the playback device 102 and one or more other devices on a data network. For instance, the playback device 102 may be configured to receive audio content over the data network from one or more other play back devices, network devices within a LAN, and/or audio content sources over a WAN, such as the Internet. In one example, the audio content and other signals transmitted and received by the playback device 102 may be transmitted in the form of digital packet data comprising an Internet Protocol (IP)-based source address and IP-based destination addresses. In such a case, the network interface 224 may be configured to parse the digital packet data such that the data destined for the play back device 102 is properly received and processed by the play back device 102.

As shown in FIG. 2A, the play back device 102 also includes voice processing components 220 that are operably coupled to one or more microphones 222. The microphones 222 are configured to detect sound (i.e., acoustic waves) in the environment of the playback device 102, which is then provided to the voice processing components 220. More specifically, each microphone 222 is configured to detect sound and convert the sound into a digital or analog signal representative of the detected sound, which can then cause the voice processing component 220 to perform various functions based on the detected sound, as described in greater detail below. In one implementation, the microphones 222 are arranged as an array of microphones (e.g., an array of six microphones). In some implementations, the play back device 102 includes more than six microphones (e.g., eight microphones or twelve microphones) or fewer than six microphones (e.g., four microphones, two microphones, or a single microphones).

In operation, the voice-processing components 220 are generally configured to detect and process sound received via the microphones 222, identify potential voice input in the detected sound, and extract detected-sound data to enable a VAS, such as the VAS 190 (FIG. 1B), to process voice input identified in the detected-sound data. The voice processing components 220 may include one or more analog-to-digital converters, an acoustic echo canceller (“AEC”), a spatial processor (e.g., one or more multi-channel Wiener filters, one or more other filters, and/or one or more beam former components), one or more buffers (e.g., one or more circular buffers), one or more wake-word engines, one or more voice extractors, and/or one or more speech processing components (e.g., components configured to recognize a voice of a particular user or a particular set of users associated with a household), among other example voice processing components. In example implementations, the voice processing components 220 may include or otherwise take the form of one or more DSPs or one or more modules of a DSP. In this respect, certain voice processing components 220 may be configured with particular parameters (e.g., gain and/or spectral parameters) that may be modified or otherwise tuned to achieve particular functions. In some implementations, one or more of the voice processing components 220 may be a subcomponent of the processor 212.

As further shown in FIG. 2A, the playback device 102 also includes power components 227. The power components 227 include at least an external power source interface 228, which may be coupled to a power source (not shown) via a power cable or the like that physically connects the playback device 102 to an electrical outlet or some other external power source. Other power components may include, for example, transformers, converters, and like components configured to format electrical power.

In some implementations, the power components 227 of the playback device 102 may additionally include an internal power source 229 (e.g., one or more batteries) configured to power the playback device 102 without a physical connection to an external power source. When equipped with the internal power source 229, the playback device 102 may operate independent of an external power source. In some such implementations, the external power source interface 228 may be configured to facilitate charging the internal power source 229. As discussed before, a playback device comprising an internal power source may be referred to herein as a “portable playback device.” On the other hand, a playback device that operates using an external power source may be referred to herein as a “stationary playback device,” although such a device may in fact be moved around a home or other environment.

The play back device 102 further includes a user interface 240 that may facilitate user interactions independent of or in conjunction with user interactions facilitated by one or more of the controller devices 104. In various examples, the user interface 240) includes one or more physical buttons and/or supports graphical interfaces provided on touch sensitive screen(s) and/or surface(s), among other possibilities, for a user to directly provide input. The user interface 240) may further include one or more of lights (e.g., LEDs) and the speakers to provide visual and/or audio feedback to a user.

As an illustrative example, FIG. 2B shows an example housing 230 of the playback device 102 that includes a user interface in the form of a control area 232 at a top portion 234 of the housing 230. The control area 232 includes buttons 236a-c for controlling audio playback, volume level, and other functions. The control area 232 also includes a button 236d for toggling the microphones 222 to either an on state or an off state.

As further shown in FIG. 2B, the control area 232 is at least partially surrounded by apertures formed in the top portion 234 of the housing 230 through which the microphones 222 (not visible in FIG. 2B) receive the sound in the environment of the play back device 102. The microphones 222 may be arranged in various positions along and/or within the top portion 234 or other areas of the housing 230 so as to detect sound from one or more directions relative to the playback device 102.

By way of illustration, SONOS, Inc. presently offers (or has offered) for sale certain playback devices that may implement certain of the examples disclosed herein, including a “SONOS ONE,” “PLAY: 5,” “BEAM,” “ARC.” “SUB,” and “CONNECT.” Any other past, present, and/or future playback devices may additionally or alternatively be used to implement the playback devices of examples disclosed herein. Additionally, it should be understood that a playback device is not limited to the examples illustrated in FIG. 2A or 2B or to the SONOS product offerings. For example, a playback device may include, or otherwise take the form of, a wired or wireless headphone set, which may operate as a part of the MPS 100 via a network interface or the like. In another example, a playback device may include or interact with a docking station for personal mobile media play back devices. In yet another example, a playback device may be integral to another device or component such as a television, a lighting fixture, or some other device for indoor or outdoor use.

FIG. 2C is a diagram of an example voice input 280 that may be processed by an NMD or an NMD-equipped playback device. The voice input 280 may include a keyword portion 280a and an utterance portion 280b. The keyword portion 280a may include a wake word or a command keyword. In the case of a wake word, the keyword portion 280a corresponds to detected sound that caused a command-keyword event. The utterance portion 280b corresponds to detected sound that potentially comprises a user request following the keyword portion 280a. An utterance portion 280b can be processed to identify the presence of any words in detected-sound data by the NMD in response to the event caused by the keyword portion 280a. In various implementations, an underlying intent can be determined based on the words in the utterance portion 280b. In certain implementations, an underlying intent can also be based or at least partially based on certain words in the keyword portion 280a, such as when keyword portion includes a command keyword. In any case, the words may correspond to one or more commands, as well as a certain command and certain keywords. A keyword in the voice utterance portion 280b may be, for example, a word identifying a particular device or group in the MPS 100. For instance, in the illustrated example, the keywords in the voice utterance portion 280b may be one or more words identifying one or more zones in which the music is to be played, such as the Living Room and the Dining Room (FIG. 1A). In some cases, the utterance portion 280b may include additional information, such as detected pauses (e.g., periods of non-speech) between words spoken by a user, as shown in FIG. 2C. The pauses may demarcate the locations of separate commands, keywords, or other information spoke by the user within the utterance portion 280b.

Based on certain command criteria, the NMD and/or a remote VAS may take actions as a result of identifying one or more commands in the voice input. Command criteria may be based on the inclusion of certain keywords within the voice input, among other possibilities. Additionally, or alternatively, command criteria for commands may involve identification of one or more control-state and/or zone-state variables in conjunction with identification of one or more particular commands. Control-state variables may include, for example, indicators identifying a level of volume, a queue associated with one or more devices, and playback state, such as whether devices are playing a queue, paused, etc. Zone-state variables may include, for example, indicators identifying which, if any, zone players are grouped.

In some implementations, the MPS 100 is configured to temporarily reduce the volume of audio content that it is playing upon detecting a certain keyword, such as a wake word, in the keyword portion 280a. The MPS 100 may restore the volume after processing the voice input 280. Such a process can be referred to as ducking, examples of which are disclosed in U.S. patent application Ser. No. 15/438,749, incorporated by reference herein in its entirety.

FIG. 2D shows an example sound specimen. In this example, the sound specimen corresponds to the sound-data stream (e.g., one or more audio frames) associated with a spotted wake word or command keyword in the keyword portion 280a of FIG. 2A. As illustrated, the example sound specimen comprises sound detected in an NMD's environment (i) immediately before a wake or command word was spoken, which may be referred to as a pre-roll portion (between times t₀ and t₁), (ii) while a wake or command word was spoken, which may be referred to as a wake-meter portion (between times t₁ and t₂), and/or (iii) after the wake or command word was spoken, which may be referred to as a post-roll portion (between times t₂ and t₃). Other sound specimens are also possible. In various implementations, aspects of the sound specimen can be evaluated according to an acoustic model which aims to map mels/spectral features to phonemes in a given language model for further processing. For example, automatic speech recognition (ASR) may include such mapping for keyword detection. Wake-word detection engines, by contrast, may be precisely tuned to identify a specific wake-word, and a downstream action of invoking a VAS (e.g., by targeting only nonce words in the voice input processed by the play back device).

ASR for command keyword detection may be tuned to accommodate a wide range of keywords (e.g., 5, 10, 100, 1,000, 10,000 keywords). Command-keyword detection, in contrast to wake-word detection, may involve feeding ASR output to an onboard, local NLU which together with the ASR determine when command-keyword events have occurred. In some implementations described below, the local NLU may determine an intent based on one or more other keywords in the ASR output produced by a particular voice input. In these or other implementations, a playback device may act on a detected command-keyword event only when the playback devices determines that certain conditions have been met, such as environmental conditions (e.g., low background noise). In some examples, multiple devices within a single media play back system may have different onboard, local ASRs and/or NLUs, for example supporting different libraries of keywords.

b. Example Playback Device Configurations

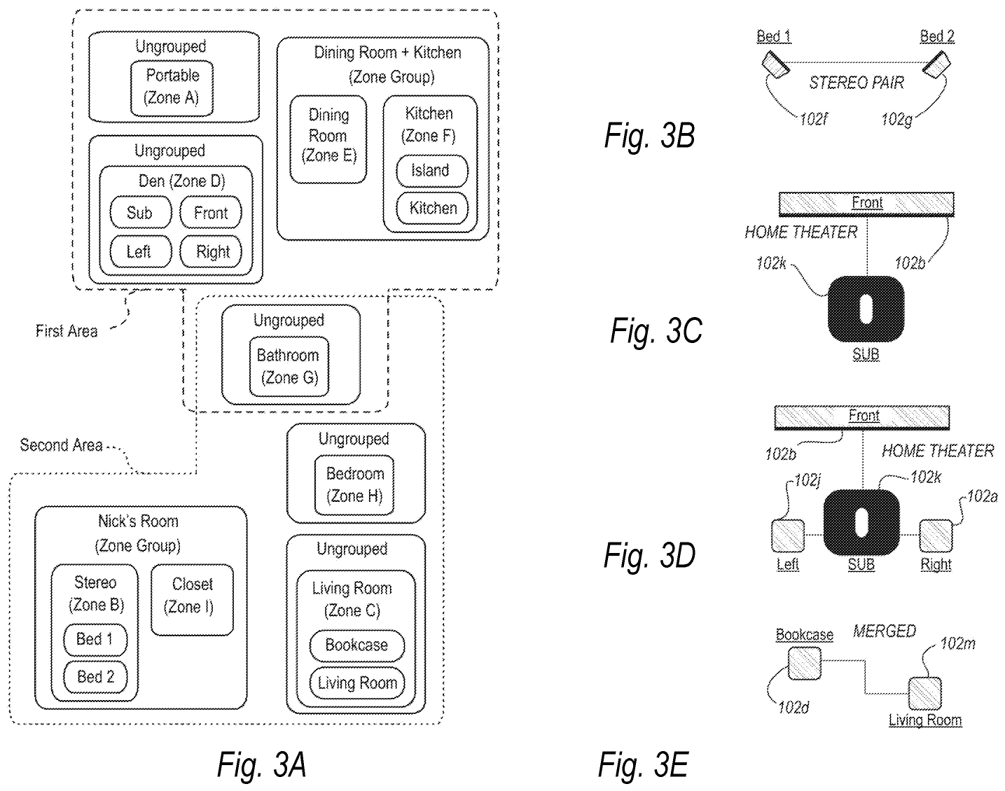

FIGS. 3A-3E show example configurations of playback devices. Referring first to FIG. 3A, in some example instances, a single play back device may belong to a zone. For example, the play back device 102c (FIG. 1A) on the Patio may belong to Zone A. In some implementations described below, multiple playback devices may be “bonded” to form a “bonded pair,” which together form a single zone. For example, the playback device 102f (FIG. 1A) named “Bed 1” in FIG. 3A may be bonded to the playback device 102g (FIG. 1A) named “Bed 2” in FIG. 3A to form Zone B. Bonded play back devices may have different playback responsibilities (e.g., channel responsibilities). In another implementation described below, multiple playback devices may be merged to form a single zone. For example, the playback device 102d named “Bookcase” may be merged with the playback device 102m named “Living Room” to form a single Zone C. The merged playback devices 102d and 102m may not be specifically assigned different playback responsibilities. That is, the merged play back devices 102d and 102m may, aside from playing audio content in synchrony, each play audio content as they would if they were not merged.

For purposes of control, each zone in the MPS 100 may be represented as a single user interface (“UI”) entity. For example, as displayed by the controller devices 104, Zone A may be provided as a single entity named “Portable,” Zone B may be provided as a single entity named “Stereo,” and Zone C may be provided as a single entity named “Living Room.”

In various examples, a zone may take on the name of one of the play back devices belonging to the zone. For example, Zone C may take on the name of the Living Room device 102m (as shown). In another example, Zone C may instead take on the name of the Bookcase device 102d. In a further example, Zone C may take on a name that is some combination of the Bookcase device 102d and Living Room device 102m. The name that is chosen may be selected by a user via inputs at a controller device 104. In some examples, a zone may be given a name that is different than the device(s) belonging to the zone. For example, Zone B in FIG. 3A is named “Stereo” but none of the devices in Zone B have this name. In one aspect, Zone B is a single UI entity representing a single device named “Stereo,” composed of constituent devices “Bed 1” and “Bed 2.” In one implementation, the Bed 1 device may be playback device 102f in the master bedroom 101b (FIG. 1A) and the Bed 2 device may be the playback device 102g also in the master bedroom 101h (FIG. 1A).

As noted above, playback devices that are bonded may have different play back responsibilities, such as playback responsibilities for certain audio channels. For example, as shown in FIG. 3B, the Bed 1 and Bed 2 devices 102f and 102g may be bonded so as to produce or enhance a stereo effect of audio content. In this example, the Bed 1 play back device 102f may be configured to play a left channel audio component, while the Bed 2 play back device 102g may be configured to play a right channel audio component. In some implementations, such stereo bonding may be referred to as “pairing.”

Additionally, playback devices that are configured to be bonded may have additional and/or different respective speaker drivers. As shown in FIG. 3C, the playback device 102b named “Front” may be bonded with the play back device 102k named “SUB.” The Front device 102b may render a range of mid to high frequencies, and the SUB device 102k may render low frequencies as, for example, a subwoofer. When unbonded, the Front device 102b may be configured to render a full range of frequencies. As another example, FIG. 3D shows the Front and SUB devices 102b and 102k further bonded with Right and Left play back devices 102a and 102j, respectively. In some implementations, the Right and Left devices 102a and 102j may form surround or “satellite” channels of a home theater system. The bonded playback devices 102a, 102b, 102j, and 102k may form a single Zone D (FIG. 3A).

In some implementations, play back devices may also be “merged.” In contrast to certain bonded playback devices, playback devices that are merged may not have assigned playback responsibilities, but may each render the full range of audio content that each respective playback device is capable of. Nevertheless, merged devices may be represented as a single UI entity (i.e., a zone, as discussed above). For instance, FIG. 3E shows the playback devices 102d and 102m in the Living Room merged, which would result in these devices being represented by the single UI entity of Zone C. In one example, the playback devices 102d and 102m may playback audio in synchrony, during which each outputs the full range of audio content that each respective playback device 102d and 102m is capable of rendering.

In some examples, a stand-alone NMD may be in a zone by itself. For example, the NMD 103h from FIG. 1A is named “Closet” and forms Zone I in FIG. 3A. An NMD may also be bonded or merged with another device so as to form a zone. For example, the NMD 103f named “Island” may be bonded with the playback device 102i Kitchen, which together form Zone F, which is also named “Kitchen.” Additional details regarding assigning NMDs and play back devices as designated or default devices may be found, for example, in previously referenced U.S. patent application Ser. No. 15/438,749. In some examples, a stand-alone NMD may not be assigned to a zone.

Zones of individual, bonded, and/or merged devices may be arranged to form a set of playback devices that playback audio in synchrony. Such a set of playback devices may be referred to as a “group.” “zone group.” “synchrony group,” or “play back group.” In response to inputs provided via a controller device 104, playback devices may be dynamically grouped and ungrouped to form new or different groups that synchronously play back audio content. For example, referring to FIG. 3A, Zone A may be grouped with Zone B to form a zone group that includes the playback devices of the two zones. As another example, Zone A may be grouped with one or more other Zones C-I. The Zones A-I may be grouped and ungrouped in numerous ways. For example, three, four, five, or more (e.g., all) of the Zones A-I may be grouped. When grouped, the zones of individual and/or bonded playback devices may play back audio in synchrony with one another, as described in previously referenced U.S. Pat. No. 8,234,395. Grouped and bonded devices are example types of associations between portable and stationary play back devices that may be caused in response to a trigger event, as discussed above and described in greater detail below.

In various implementations, the zones in an environment may be assigned a particular name, which may be the default name of a zone within a zone group or a combination of the names of the zones within a zone group, such as “Dining Room+Kitchen,” as shown in FIG. 3A. In some examples, a zone group may be given a unique name selected by a user, such as “Nick's Room,” as also shown in FIG. 3A. The name “Nick's Room” may be a name chosen by a user over a prior name for the zone group, such as the room name “Master Bedroom.”

Referring back to FIG. 2A, certain data may be stored in the memory 213 as one or more state variables that are periodically updated and used to describe the state of a play back zone, the playback device(s), and/or a zone group associated therewith. The memory 213 may also include the data associated with the state of the other devices of the MPS 100, which may be shared from time to time among the devices so that one or more of the devices have the most recent data associated with the system.

In some examples, the memory 213 of the playback device 102 may store instances of various variable types associated with the states. Variables instances may be stored with identifiers (e.g., tags) corresponding to type. For example, certain identifiers may be a first type “a1” to identify play back device(s) of a zone, a second type “b1” to identify play back device(s) that may be bonded in the zone, and a third type “c1” to identify a zone group to which the zone may belong. As a related example, in FIG. 1A, identifiers associated with the Patio may indicate that the Patio is the only playback device of a particular zone and not in a zone group. Identifiers associated with the Living Room may indicate that the Living Room is not grouped with other zones but includes bonded playback devices 102a, 102b, 102j, and 102k. Identifiers associated with the Dining Room may indicate that the Dining Room is part of Dining Room+Kitchen group and that devices 103f and 102i are bonded. Identifiers associated with the Kitchen may indicate the same or similar information by virtue of the Kitchen being part of the Dining Room+Kitchen zone group. Other example zone variables and identifiers are described below.

In yet another example, the MPS 100 may include variables or identifiers representing other associations of zones and zone groups, such as identifiers associated with Areas, as shown in FIG. 3A. An Area may involve a cluster of zone groups and/or zones not within a zone group. For instance, FIG. 3A shows a first area named “First Area” and a second area named “Second Area.” The First Area includes zones and zone groups of the Patio, Den, Dining Room, Kitchen, and Bathroom. The Second Area includes zones and zone groups of the Bathroom, Nick's Room, Bedroom, and Living Room. In one aspect, an Area may be used to invoke a cluster of zone groups and/or zones that share one or more zones and/or zone groups of another cluster. In this respect, such an Area differs from a zone group, which does not share a zone with another zone group. Further examples of techniques for implementing Areas may be found, for example, in U.S. application Ser. No. 15/682,506 filed Aug. 21, 2017 and titled “Room Association Based on Name,” and U.S. Pat. No. 8,483,853 filed Sep. 11, 2007, and titled “Controlling and manipulating groupings in a multi-zone media system.” Each of these applications is incorporated herein by reference in its entirety. In some examples, the MPS 100 may not implement Areas, in which case the system may not store variables associated with Areas.

The memory 213 may be further configured to store other data. Such data may pertain to audio sources accessible by the playback device 102 or a playback queue that the playback device (or some other playback device(s)) may be associated with. In examples described below; the memory 213 is configured to store a set of command data for selecting a particular VAS when processing voice inputs. During operation, one or more play back zones in the environment of FIG. 1A may each be playing different audio content. For instance, the user may be grilling in the Patio zone and listening to hip hop music being played by the playback device 102c, while another user may be preparing food in the Kitchen zone and listening to classical music being played by the playback device 102i. In another example, a play back zone may play the same audio content in synchrony with another playback zone.

For instance, the user may be in the Office zone where the play back device 102n is playing the same hip-hop music that is being playing by playback device 102c in the Patio zone. In such a case, play back devices 102c and 102n may be playing the hip-hop in synchrony such that the user may seamlessly (or at least substantially seamlessly) enjoy the audio content that is being played out-loud while moving between different playback zones. Synchronization among playback zones may be achieved in a manner similar to that of synchronization among play back devices, as described in previously referenced U.S. Pat. No. 8,234,395.

As suggested above, the zone configurations of the MPS 100 may be dynamically modified. As such, the MPS 100 may support numerous configurations. For example, if a user physically moves one or more playback devices to or from a zone, the MPS 100 may be reconfigured to accommodate the change(s). For instance, if the user physically moves the play back device 102c from the Patio zone to the Office zone, the Office zone may now include both the play back devices 102c and 102n. In some cases, the user may pair or group the moved play back device 102c with the Office zone and/or rename the players in the Office zone using, for example, one of the controller devices 104 and/or voice input. As another example, if one or more play back devices 102 are moved to a particular space in the home environment that is not already a playback zone, the moved playback device(s) may be renamed or associated with a playback zone for the particular space.

Further, different playback zones of the MPS 100 may be dynamically combined into zone groups or split up into individual playback zones. For example, the Dining Room zone and the Kitchen zone may be combined into a zone group for a dinner party such that playback devices 102i and 102l may render audio content in synchrony. As another example, bonded playback devices in the Den zone may be split into (i) a television zone and (ii) a separate listening zone. The television zone may include the Front play back device 102b. The listening zone may include the Right, Left, and SUB play back devices 102a, 102j, and 102k, which may be grouped, paired, or merged, as described above. Splitting the Den zone in such a manner may allow one user to listen to music in the listening zone in one area of the living room space, and another user to watch the television in another area of the living room space. In a related example, a user may utilize either of the NMD 103a or 103b (FIG. 1B) to control the Den zone before it is separated into the television zone and the listening zone. Once separated, the listening zone may be controlled, for example, by a user in the vicinity of the NMD 103a, and the television zone may be controlled, for example, by a user in the vicinity of the NMD 103b. As described above, however, any of the NMDs 103 may be configured to control the various playback and other devices of the MPS 100.

### C. Example Controller Devices

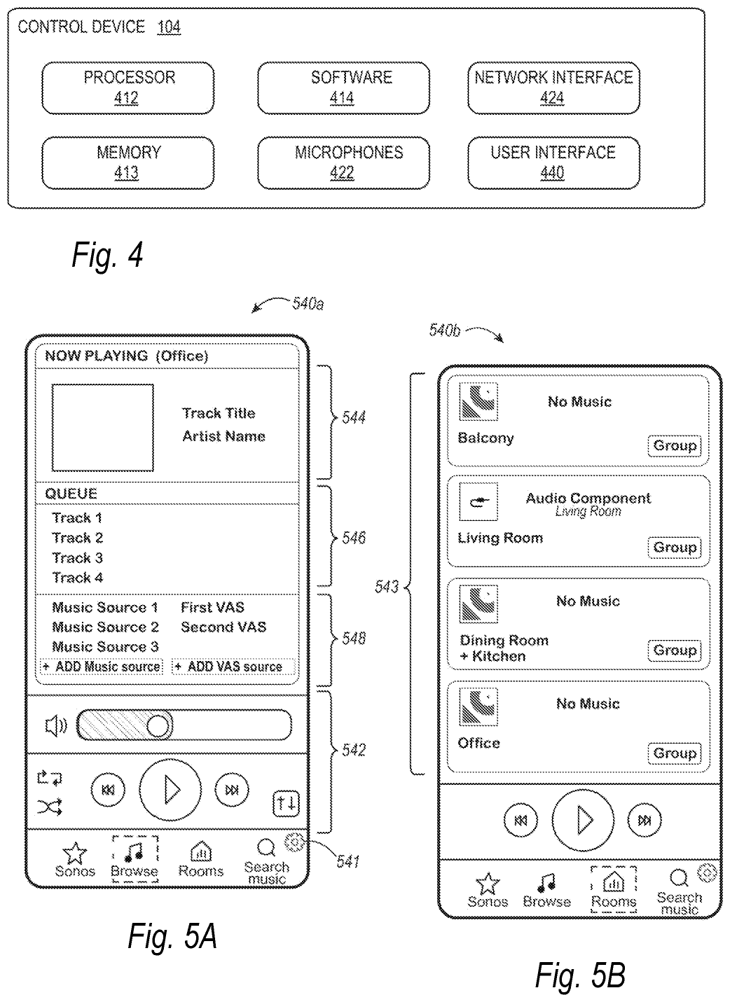

FIG. 4 is a functional block diagram illustrating certain aspects of a selected one of the controller devices 104 of the MPS 100 of FIG. 1A. Such controller devices may also be referred to herein as a “control device” or “controller.” The controller device shown in FIG. 4 may include components that are generally similar to certain components of the network devices described above, such as a processor 412, memory 413 storing program software 414, at least one network interface 424, and one or more microphones 422. In one example, a controller device may be a dedicated controller for the MPS 100. In another example, a controller device may be a network device on which media playback system controller application software may be installed, such as for example, an iPhone™, iPad™ or any other smart phone, tablet, or network device (e.g., a networked computer such as a PC or Mac™).

The memory 413 of the controller device 104 may be configured to store controller application software and other data associated with the MPS 100 and/or a user of the system 100. The memory 413 may be loaded with instructions in software 414 that are executable by the processor 412 to achieve certain functions, such as facilitating user access, control, and/or configuration of the MPS 100. The controller device 104 is configured to communicate with other network devices via the network interface 424, which may take the form of a wireless interface, as described above.

In one example, system information (e.g., such as a state variable) may be communicated between the controller device 104 and other devices via the network interface 424. For instance, the controller device 104 may receive playback zone and zone group configurations in the MPS 100 from a play back device, an NMD, or another network device. Likewise, the controller device 104 may transmit such system information to a playback device or another network device via the network interface 424. In some cases, the other network device may be another controller device.

The controller device 104 may also communicate playback device control commands, such as volume control and audio playback control, to a playback device via the network interface 424. As suggested above, changes to configurations of the MPS 100 may also be performed by a user using the controller device 104. The configuration changes may include adding/removing one or more playback devices to/from a zone, adding/removing one or more zones to/from a zone group, forming a bonded or merged player, separating one or more playback devices from a bonded or merged player, among others.

As shown in FIG. 4, the controller device 104 also includes a user interface 440 that is generally configured to facilitate user access and control of the MPS 100. The user interface 440 may include a touch-screen display or other physical interface configured to provide various graphical controller interfaces, such as the controller interfaces 540a and 540b shown in FIGS. 5A and 5B. Referring to FIGS. 5A and 5B together, the controller interfaces 540a and 540b includes a play back control region 542, a play back zone region 543, a play back status region 544, a playback queue region 546, and a sources region 548. The user interface as shown is just one example of an interface that may be provided on a network device, such as the controller device shown in FIG. 4, and accessed by users to control a media playback system, such as the MPS 100. Other user interfaces of varying formats, styles, and interactive sequences may alternatively be implemented on one or more network devices to provide comparable control access to a media playback system.

The play back control region 542 (FIG. 5A) may include selectable icons (e.g., by way of touch or by using a cursor) that, when selected, cause playback devices in a selected playback zone or zone group to play or pause, fast forward, rewind, skip to next, skip to previous, enter/exit shuffle mode, enter/exit repeat mode, enter/exit cross fade mode, etc. The play back control region 542 may also include selectable icons that, when selected, modify equalization settings and/or play back volume, among other possibilities.

The play back zone region 543 (FIG. 5B) may include representations of play back zones within the MPS 100. The play back zones regions 543 may also include a representation of zone groups, such as the Dining Room+Kitchen zone group, as shown.

In some examples, the graphical representations of playback zones may be selectable to bring up additional selectable icons to manage or configure the play back zones in the MPS 100, such as a creation of bonded zones, creation of zone groups, separation of zone groups, and renaming of zone groups, among other possibilities.

For example, as shown, a “group” icon may be provided within each of the graphical representations of playback zones. The “group” icon provided within a graphical representation of a particular zone may be selectable to bring up options to select one or more other zones in the MPS 100 to be grouped with the particular zone. Once grouped, playback devices in the zones that have been grouped with the particular zone will be configured to play audio content in synchrony with the play back device(s) in the particular zone. Analogously, a “group” icon may be provided within a graphical representation of a zone group. In this case, the “group” icon may be selectable to bring up options to deselect one or more zones in the zone group to be removed from the zone group. Other interactions and implementations for grouping and ungrouping zones via a user interface are also possible. The representations of playback zones in the play back zone region 543 (FIG. 5B) may be dynamically updated as playback zone or zone group configurations are modified.

The play back status region 544 (FIG. 5A) may include graphical representations of audio content that is presently being played, previously played, or scheduled to play next in the selected play back zone or zone group. The selected playback zone or zone group may be visually distinguished on a controller interface, such as within the play back zone region 543 and/or the playback status region 544. The graphical representations may include track title, artist name, album name, album year, track length, and/or other relevant information that may be useful for the user to know when controlling the MPS 100 via a controller interface.

The playback queue region 546 may include graphical representations of audio content in a playback queue associated with the selected playback zone or zone group. In some examples, each playback zone or zone group may be associated with a playback queue comprising information corresponding to zero or more audio items for playback by the playback zone or zone group. For instance, each audio item in the playback queue may comprise a uniform resource identifier (URI), a uniform resource locator (URL), or some other identifier that may be used by a playback device in the playback zone or zone group to find and/or retrieve the audio item from a local audio content source or a networked audio content source, which may then be played back by the playback device.

In one example, a playlist may be added to a playback queue, in which case information corresponding to each audio item in the playlist may be added to the play back queue. In another example, audio items in a playback queue may be saved as a playlist. In a further example, a playback queue may be empty, or populated but “not in use” when the playback zone or zone group is playing continuously streamed audio content, such as Internet radio that may continue to play until otherwise stopped, rather than discrete audio items that have playback durations. In an alternative example, a playback queue can include Internet radio and/or other streaming audio content items and be “in use” when the playback zone or zone group is playing those items. Other examples are also possible.

When playback zones or zone groups are “grouped” or “ungrouped.” playback queues associated with the affected playback zones or zone groups may be cleared or re-associated. For example, if a first playback zone including a first playback queue is grouped with a second playback zone including a second playback queue, the established zone group may have an associated playback queue that is initially empty, that contains audio items from the first playback queue (such as if the second playback zone was added to the first play back zone), that contains audio items from the second playback queue (such as if the first play back zone was added to the second playback zone), or a combination of audio items from both the first and second playback queues. Subsequently, if the established zone group is ungrouped, the resulting first playback zone may be re-associated with the previous first playback queue or may be associated with a new playback queue that is empty or contains audio items from the playback queue associated with the established zone group before the established zone group was ungrouped. Similarly, the resulting second playback zone may be re-associated with the previous second playback queue or may be associated with a new playback queue that is empty or contains audio items from the playback queue associated with the established zone group before the established zone group was ungrouped. Other examples are also possible.

With reference still to FIGS. 5A and 5B, the graphical representations of audio content in the play back queue region 646 (FIG. 5A) may include track titles, artist names, track lengths, and/or other relevant information associated with the audio content in the play back queue. In one example, graphical representations of audio content may be selectable to bring up additional selectable icons to manage and/or manipulate the play back queue and/or audio content represented in the play back queue. For instance, a represented audio content may be removed from the play back queue, moved to a different position within the play back queue, or selected to be played immediately, or after any currently playing audio content, among other possibilities. A playback queue associated with a playback zone or zone group may be stored in a memory on one or more playback devices in the playback zone or zone group, on a playback device that is not in the playback zone or zone group, and/or some other designated device. Playback of such a playback queue may involve one or more playback devices playing back media items of the queue, perhaps in sequential or random order.

The sources region 548 may include graphical representations of selectable audio content sources and/or selectable voice assistants associated with a corresponding VAS. The VASes may be selectively assigned. In some examples, multiple VASes, such as AMAZON's Alexa, MICROSOFT's Cortana, etc., may be invokable by the same NMD. In some examples, a user may assign a VAS exclusively to one or more NMDs. For example, a user may assign a first VAS to one or both of the play back devices 102a and 102b in the Living Room shown in FIG. 1A, and a second VAS to the NMD 103f in the Kitchen. Other examples are possible.

d. Example Audio Content Sources

The audio sources in the sources region 548 may be audio content sources from which audio content may be retrieved and played by the selected playback zone or zone group. One or more playback devices in a zone or zone group may be configured to retrieve for playback audio content (e.g., according to a corresponding URI or URL for the audio content) from a variety of available audio content sources. In one example, audio content may be retrieved by a playback device directly from a corresponding audio content source (e.g., via a line-in connection). In another example, audio content may be provided to a playback device over a network via one or more other playback devices or network devices. As described in greater detail below, in some examples, audio content may be provided by one or more media content services.

Example audio content sources may include a memory of one or more play back devices in a media play back system such as the MPS 100 of FIG. 1, local music libraries on one or more network devices (e.g., a controller device, a network-enabled personal computer, or a networked-attached storage (“NAS”)), streaming audio services providing audio content via the Internet (e.g., cloud-based music services), or audio sources connected to the media play back system via a line-in input connection on a play back device or network device, among other possibilities.

In some examples, audio content sources may be added or removed from a media play back system such as the MPS 100 of FIG. 1A. In one example, an indexing of audio items may be performed whenever one or more audio content sources are added, removed, or updated. Indexing of audio items may involve scanning for identifiable audio items in all folders/directories shared over a network accessible by playback devices in the media play back system and generating or updating an audio content database comprising metadata (e.g., title, artist, album, track length, among others) and other associated information, such as a URI or URL for each identifiable audio item found. Other examples for managing and maintaining audio content sources may also be possible.

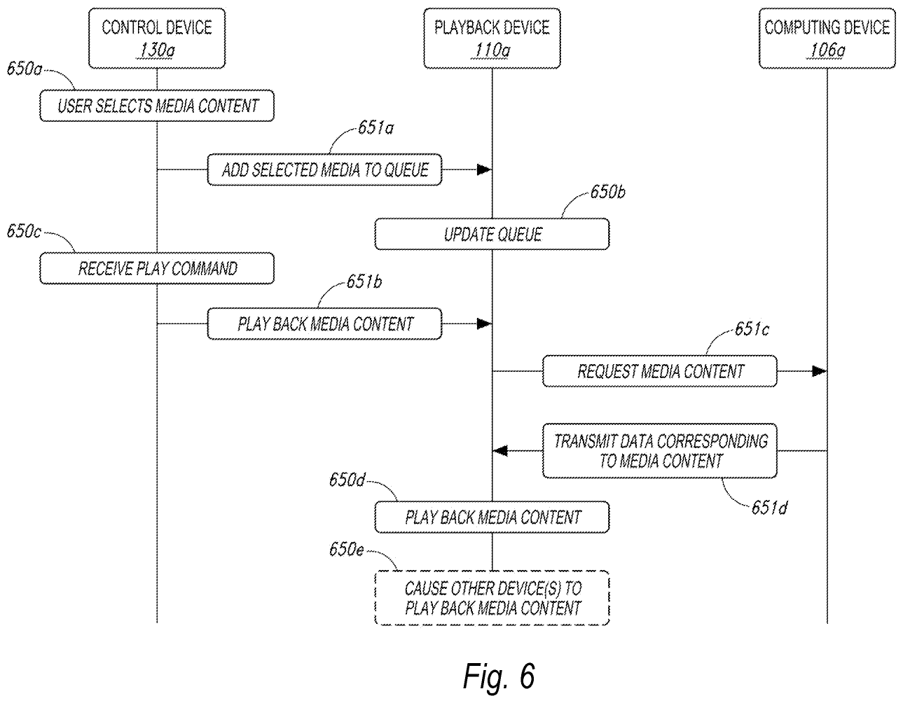

FIG. 6 is a message flow diagram illustrating data exchanges between devices of the MPS 100. At step 650a, the MPS 100 receives an indication of selected media content (e.g., one or more songs, albums, playlists, podcasts, videos, stations) via the control device 104. The selected media content can comprise, for example, media items stored locally on or more devices (e.g., the audio source 105 of FIG. 1C) connected to the media play back system and/or media items stored on one or more media service servers (one or more of the remote computing devices 106 of FIG. 1B). In response to receiving the indication of the selected media content, the control device 104 transmits a message 651a to the playback device 102 (FIGS. 1A-1C) to add the selected media content to a playback queue on the playback device 102.

At step 650b, the play back device 102 receives the message 651a and adds the selected media content to the playback queue for play back.

At step 650c, the control device 104 receives input corresponding to a command to play back the selected media content. In response to receiving the input corresponding to the command to play back the selected media content, the control device 104 transmits a message 651b to the playback device 102 causing the playback device 102 to play back the selected media content. In response to receiving the message 651b, the playback device 102 transmits a message 651c to the computing device 106 requesting the selected media content. The computing device 106, in response to receiving the message 651c, transmits a message 651d comprising data (e.g., audio data, video data, a URL, a URI) corresponding to the requested media content.

At step 650d, the playback device 102 receives the message 651d with the data corresponding to the requested media content and plays back the associated media content.

At step 650e, the playback device 102 optionally causes one or more other devices to play back the selected media content. In one example, the playback device 102 is one of a bonded zone of two or more players (FIG. 1M). The play back device 102 can receive the selected media content and transmit all or a portion of the media content to other devices in the bonded zone. In another example, the playback device 102 is a coordinator of a group and is configured to transmit and receive timing information from one or more other devices in the group. The other one or more devices in the group can receive the selected media content from the computing device 106, and begin play back of the selected media content in response to a message from the play back device 102 such that all of the devices in the group play back the selected media content in synchrony.

### III. Example Configurations of Network Microphone Devices and Interactions with Voice Assistant Services

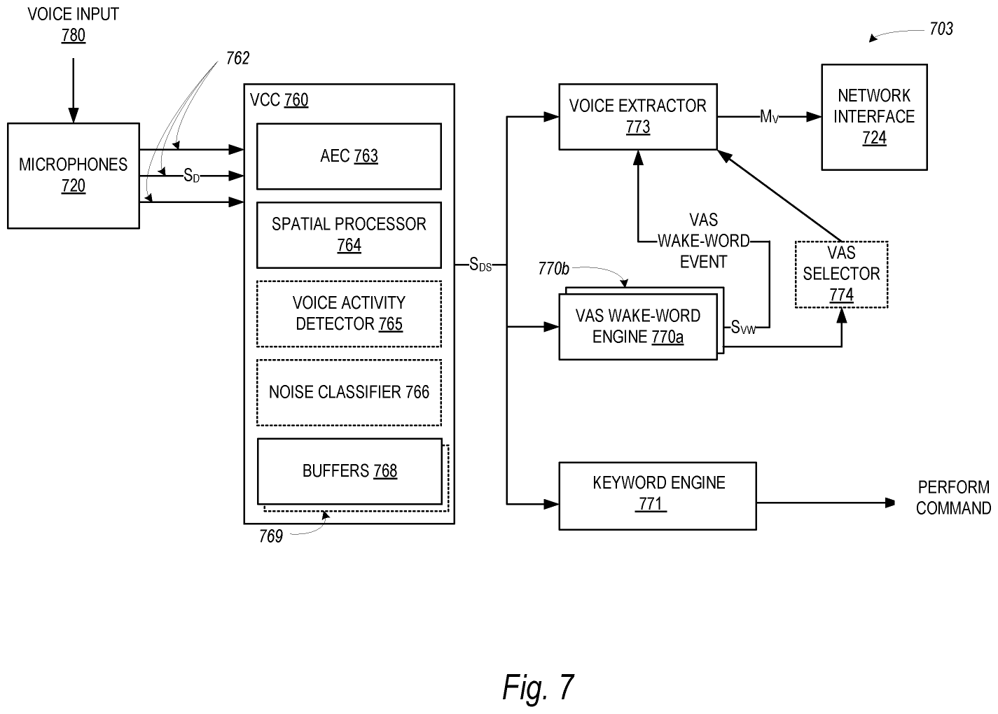

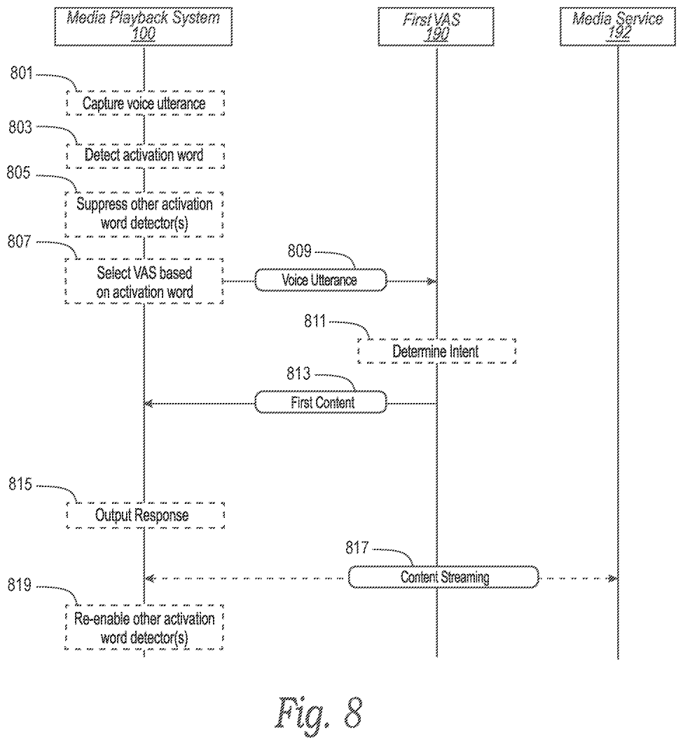

FIG. 7 is functional block diagram showing aspects of an NMD 703 configured in accordance with examples of the disclosure. The NMD 703 may be generally similar to the NMD 103 and include similar components. As described in more detail below, the NMD 703 (FIG. 7) is configured to handle certain voice inputs locally, without necessarily transmitting data representing the voice input to a voice assistant service. However, the NMD 703 is also configured to process other voice inputs using a voice assistant service.

Referring to FIG. 7, the NMD 703 includes voice capture components (“VCC”) 760, a VAS wake-word engine 770a, and a voice extractor 773. The VAS wake-word engine 770a and the voice extractor 773 are operably coupled to the VCC 760. The NMD 703 further comprises a keyword engine 771 operably coupled to the VCC 760.

The NMD 703 further includes microphones 720 and the at least one network interface 724 as described above and may also include other components, such as audio amplifiers, a user interface, etc., which are not shown in FIG. 7 for purposes of clarity. The microphones 720 of the NMD 703 are configured to provide detected sound, SD, from the environment of the NMD 703 to the VCC 760. The detected sound Sp may take the form of one or more analog or digital signals. In example implementations, the detected sound SD may be composed of a plurality signals associated with respective channels 762 that are fed to the VCC 760.

Each channel 762 may correspond to a particular microphone 720. For example, an NMD having six microphones may have six corresponding channels. Each channel of the detected sound SD may bear certain similarities to the other channels but may differ in certain regards, which may be due to the position of the given channel's corresponding microphone relative to the microphones of other channels. For example, one or more of the channels of the detected sound SD may have a greater signal to noise ratio (“SNR”) of speech to background noise than other channels.

As further shown in FIG. 7, the VCC 760 includes an AEC 763, a spatial processor 764, and one or more buffers 768. In operation, the AEC 763 receives the detected sound SD and filters or otherwise processes the sound to suppress echoes and/or to otherwise improve the quality of the detected sound SD. That processed sound may then be passed to the spatial processor 764.

The spatial processor 764 is typically configured to analyze the detected sound S_{D} and identify certain characteristics, such as a sound's amplitude (e.g., decibel level), frequency spectrum, directionality, etc. In one respect, the spatial processor 764 may help filter or suppress ambient noise in the detected sound S_{D} from potential user speech based on similarities and differences in the constituent channels 762 of the detected sound S_{D}, as discussed above. As one possibility, the spatial processor 764 may monitor metrics that distinguish speech from other sounds. Such metrics can include, for example, energy within the speech band relative to background noise and entropy within the speech band-a measure of spectral structure-which is typically lower in speech than in most common background noise. In some implementations, the spatial processor 764 may be configured to determine a speech presence probability, examples of such functionality are disclosed in U.S. patent application Ser. No. 15/984,073, filed May 18, 2018, titled “Linear Filtering for Noise-Suppressed Speech Detection,” which is incorporated herein by reference in its entirety.

In operation, the one or more buffers 768—one or more of which may be part of or separate from the memory 213 (FIG. 2A)—capture data corresponding to the detected sound S_{D}. More specifically, the one or more buffers 768 capture detected-sound data that was processed by the upstream AEC 764 and spatial processor 764.

The network interface 724 may then provide this information to a remote server that may be associated with the MPS 100. In one aspect, the information stored in the additional buffer 769 does not reveal the content of any speech but instead is indicative of certain unique features of the detected sound itself. In a related aspect, the information may be communicated between computing devices, such as the various computing devices of the MPS 100, without necessarily implicating privacy concerns. In practice, the MPS 100 can use this information to adapt and fine tune voice processing algorithms, including sensitivity tuning as discussed below. In some implementations the additional buffer may comprise or include functionality similar to lookback buffers disclosed, for example, in U.S. patent application Ser. No. 15/989,715, filed May 25, 2018, titled “Determining and Adapting to Changes in Microphone Performance of Play back Devices”: U.S. patent application Ser. No. 16/141,875, filed Sep. 25, 2018, titled “Voice Detection Optimization Based on Selected Voice Assistant Service”; and U.S. patent application Ser. No. 16/138,111, filed Sep. 21, 2018, titled “Voice Detection Optimization Using Sound Metadata,” which are incorporated herein by reference in their entireties.

In any event, the detected-sound data forms a digital representation (i.e., sound-data stream), S_{DS}, of the sound detected by the microphones 720. In practice, the sound-data stream S_{DS} may take a variety of forms. As one possibility, the sound-data stream S_{DS} may be composed of frames, each of which may include one or more sound samples. The frames may be streamed (i.e., read out) from the one or more buffers 768 for further processing by downstream components, such as the VAS wake-word engines 770) and the voice extractor 773 of the NMD 703.

In some implementations, at least one buffer 768 captures detected-sound data utilizing a sliding window approach in which a given amount (i.e., a given window) of the most recently captured detected-sound data is retained in the at least one buffer 768 while older detected sound data is overwritten when it falls outside of the window. For example, at least one buffer 768 may temporarily retain 20 frames of a sound specimen at given time, discard the oldest frame after an expiration time, and then capture a new frame, which is added to the 19 prior frames of the sound specimen.

In practice, when the sound-data stream S_{DS} is composed of frames, the frames may take a variety of forms having a variety of characteristics. As one possibility, the frames may take the form of audio frames that have a certain resolution (e.g., 16 bits of resolution), which may be based on a sampling rate (e.g., 44,100 Hz). Additionally, or alternatively, the frames may include information corresponding to a given sound specimen that the frames define, such as metadata that indicates frequency response, power input level, SNR, microphone channel identification, and/or other information of the given sound specimen, among other examples. Thus, in some examples, a frame may include a portion of sound (e.g., one or more samples of a given sound specimen) and metadata regarding the portion of sound. In other examples, a frame may only include a portion of sound (e.g., one or more samples of a given sound specimen) or metadata regarding a portion of sound.

In any case, downstream components of the NMD 703 may process the sound-data stream S_{DS}. For instance, the VAS wake-word engines 770 are configured to apply one or more identification algorithms to the sound-data stream S_{DS} (e.g., streamed sound frames) to spot potential wake words in the detected-sound S_{D}. This process may be referred to as automatic speech recognition. The VAS wake-word engine 770a and keyword engine 771 apply different identification algorithms corresponding to their respective wake words, and further generate different events based on detecting a wake word in the detected sound S_{D}.

Example wake word detection algorithms accept audio as input and provide an indication of whether a wake word is present in the audio. Many first- and third-party wake word detection algorithms are known and commercially available. For instance, operators of a voice service may make their algorithm available for use in third-party devices. Alternatively, an algorithm may be trained to detect certain wake-words.

For instance, when the VAS wake-word engine 770a detects a potential VAS wake word, the VAS work-word engine 770a provides an indication of a “VAS wake-word event” (also referred to as a “VAS wake-word trigger”). In the illustrated example of FIG. 7, the VAS wake word engine 770a outputs a signal, S_{VW}, that indicates the occurrence of a VAS wake-word event to the voice extractor 773.

In multi-VAS implementations, the NMD 703 may include a VAS selector 774 (shown in dashed lines) that is generally configured to direct extraction by the voice extractor 773 and transmission of the sound-data stream S_{DS} to the appropriate VAS when a given wake-word is identified by a particular wake-word engine (and a corresponding wake-word trigger), such as the VAS wake-word engine 770a and at least one additional VAS wake-word engine 770b (shown in dashed lines). In such implementations, the NMD 703 may include multiple, different VAS wake word engines and/or voice extractors, each supported by a respective VAS.

Similar to the discussion above, each VAS wake-word engine 770 may be configured to receive as input the sound-data stream S_{DS} from the one or more buffers 768 and apply identification algorithms to cause a wake-word trigger for the appropriate VAS. Thus, as one example, the VAS wake-word engine 770a may be configured to identify the wake word “Alexa” and cause the NMD 703 to invoke the AMAZON VAS when “Alexa” is spotted. As another example, the wake-word engine 770b may be configured to identify the wake word “Ok, Google” and cause the NMD 520 to invoke the GOOGLE VAS when “Ok, Google” is spotted. In single-VAS implementations, the VAS selector 774 may be omitted.

As described in more detail elsewhere herein, in various examples, the NMD 703 can be configured to support various combinations wake-word engines and to facilitate communication with various combinations of VASes. In certain cases, two ore more particular VASes (or two or more particular wake-word engines) may be prohibited from being enabled concurrently in order to safeguard the user experience or to avoid other problems. For example, if two wake-word engines are configured to detect very similar wake words, then the NMD 703 can be configured to permit only one of those wake-word engines to be enabled at a time. Additionally or alternatively, if a plurality of particular VASes being enabled concurrently would strain the available computational resources of the NMD (e.g., processing power, available memory, etc.), then concurrent enablement may be limited to a certain subset of the available VASes. In some examples, such concurrency restrictions can be maintained and governed by a concurrency rules engine, which can be stored locally on the NMD 703 or may be stored remotely on one or more computing devices accessible to the NMD via a network.

For purposes of concurrency restrictions, in some examples the keyword engine 771 and associated downstream commands can be considered a native VAS. For example, the keyword engine 771 can cause the NMD to perform commands (or to transmit instructions to other devices to perform commands) with or without transmitting a voice utterance to remote computing devices for evaluation. Such voice-enabled operation of the NMD or related devices via the keyword engine 771 can be considered a native VAS, which as discussed elsewhere herein, which may be restricted from being concurrently enabled with certain other VASes (e.g., as reflected in a concurrency rules engine). Accordingly, in some instances, the keyword engine 771 can be selectively enabled or disabled based at least in part on concurrency restrictions.

In response to the VAS wake-word event (e.g., in response to the signal S_{VW} indicating the wake-word event), the voice extractor 773 is configured to receive and format (e.g., packetize) the sound-data stream S_{DS}. For instance, the voice extractor 773 packetizes the frames of the sound-data stream S_{DS} into messages. The voice extractor 773 transmits or streams these messages, M_{V}, that may contain voice input in real time or near real time to a remote VAS via the network interface 724.

The VAS is configured to process the sound-data stream S_{DS} contained in the messages M_{V} sent from the NMD 703. More specifically, the NMD 703 is configured to identify a voice input 780 based on the sound-data stream S_{DS}. As described in connection with FIG. 2C, the voice input 780 may include a keyword portion and an utterance portion. The keyword portion corresponds to detected sound that caused a wake-word event, or leads to a command-keyword event when one or more certain conditions, such as certain playback conditions, are met. For instance, when the voice input 780 includes a VAS wake word, the keyword portion corresponds to detected sound that caused the wake-word engine 770a to output the wake-word event signal SVW to the voice extractor 773. The utterance portion in this case corresponds to detected sound that potentially comprises a user request following the keyword portion.

When a VAS wake-word event occurs, the VAS may first process the keyword portion within the sound data stream S_{DS} to verify the presence of a VAS wake word. In some instances, the VAS may determine that the keyword portion comprises a false wake word (e.g., the word “Election” when the word “Alexa” is the target VAS wake word). In such an occurrence, the VAS may send a response to the NMD 703 with an instruction for the NMD 703 to cease extraction of sound data, which causes the voice extractor 773 to cease further streaming of the detected-sound data to the VAS. The VAS wake-word engine 770a may resume or continue monitoring sound specimens until it spots another potential VAS wake word, leading to another VAS wake-word event. In some implementations, the VAS does not process or receive the keyword portion but instead processes only the utterance portion.

In any case, the VAS processes the utterance portion to identify the presence of any words in the detected-sound data and to determine an underlying intent from these words. The words may correspond to one or more commands, as well as certain keywords. The keyword may be, for example, a word in the voice input identifying a particular device or group in the MPS 100. For instance, in the illustrated example, the keyword may be one or more words identifying one or more zones in which the music is to be played, such as the Living Room and the Dining Room (FIG. 1A).

To determine the intent of the words, the VAS is typically in communication with one or more databases associated with the VAS (not shown) and/or one or more databases (not shown) of the MPS 100. Such databases may store various user data, analytics, catalogs, and other information for natural language processing and/or other processing. In some implementations, such databases may be updated for adaptive learning and feedback for a neural network based on voice-input processing. In some cases, the utterance portion may include additional information, such as detected pauses (e.g., periods of non-speech) between words spoken by a user, as shown in FIG. 2C. The pauses may demarcate the locations of separate commands, keywords, or other information spoke by the user within the utterance portion.

After processing the voice input, the VAS may send a response to the MPS 100 with an instruction to perform one or more actions based on an intent it determined from the voice input. For example, based on the voice input, the VAS may direct the MPS 100 to initiate play back on one or more of the playback devices 102, control one or more of these playback devices 102 (e.g., raise/lower volume, group/ungroup devices, etc.), or turn on/off certain smart devices, among other actions. After receiving the response from the VAS, the wake-word engine 770a of the NMD 703 may resume or continue to monitor the sound-data stream S_{DS1} until it spots another potential wake-word, as discussed above.

In general, the one or more identification algorithms that a particular VAS wake-word engine, such as the VAS wake-word engine 770a, applies are configured to analyze certain characteristics of the detected sound stream S_{DS} and compare those characteristics to corresponding characteristics of the particular VAS wake-word engine's one or more particular VAS wake words. For example, the wake-word engine 770a may apply one or more identification algorithms to spot temporal and spectral characteristics in the detected sound stream S_{DS} that match the temporal and spectral characteristics of the engine's one or more wake words, and thereby determine that the detected sound S_{D} comprises a voice input including a particular VAS wake word.

In some implementations, the one or more identification algorithms may be third-party identification algorithms (i.e., developed by a company other than the company that provides the NMD 703). For instance, operators of a voice service (e.g., AMAZON) may make their respective algorithms (e.g., identification algorithms corresponding to AMAZON's ALEXA) available for use in third-party devices (e.g., the NMDs 103), which are then trained to identify one or more wake words for the particular voice assistant service. Additionally, or alternatively, the one or more identification algorithms may be first-party identification algorithms that are developed and trained to identify certain wake words that are not necessarily particular to a given voice service. Other possibilities also exist.

As noted above, the NMD 703 also includes a keyword engine 771 in parallel with the VAS wake-word engine 770a. Like the VAS wake-word engine 770a, the keyword engine 771 may apply one or more identification algorithms corresponding to one or more wake words. A “command-keyword event” is generated when a particular command keyword is identified in the detected sound S_{D}. In contrast to the nonce words typically as utilized as VAS wake words, command keywords function as both the wake word and the command itself. For instance, example command keywords may correspond to play back commands (e.g., “play,” “pause,” “skip,” etc.) as well as control commands (“turn on”), among other examples. Under appropriate conditions, based on detecting one of these command keywords, the NMD 703 performs the corresponding command.

The keyword engine 771 can employ an automatic speech recognizer (ASR). The ASR is configured to output phonetic or phonemic representations, such as text corresponding to words, based on sound in the sound-data stream S_{DS} to text. For instance, the ASR may transcribe spoken words represented in the sound-data stream S_{DS} to one or more strings representing the voice input 780 as text. The keyword engine 771 can feed ASR output to a local natural language unit (NLU) that identifies particular keywords as being command keywords for invoking command-keyword events, as described below.

As noted above, in some example implementations, the NMD 703 is configured to perform natural language processing, which may be carried out using an onboard natural language understanding processor, referred to herein as a natural language unit (NLU). The local NLU is configured to analyze text output of the ASR of the keyword engine 771 to spot (i.e., detect or identify) keywords in the voice input 780. The local keyword engine 771 includes a library of keywords (i.e., words and phrases) corresponding to respective commands and/or parameters.

In one aspect, the library of the local keyword engine 771 includes command keywords. When the local keyword engine 771 identifies a command keyword in the signal, the keyword engine 771 generates a command-keyword event and performs a command corresponding to the command keyword in the signal.

Further, the library of the local keyword engine 771 may also include keywords corresponding to parameters. The local keyword engine 771 may then determine an underlying intent from the matched keywords in the voice input 780. For instance, if the local keyword engine 771 matches the keywords “David Bowie” and “kitchen” in combination with a play command, the local keyword engine 771 may determine an intent of playing David Bowie in the Kitchen 101h on the play back device 102i. In contrast to a processing of the voice input 780 by a cloud-based VAS, local processing of the voice input 780 by the local keyword engine 771 may be relatively less sophisticated, as the keyword engine 771 does not have access to the relatively greater processing capabilities and larger voice databases that a VAS generally has access to.

In some examples, the local keyword engine 771 may determine an intent with one or more slots, which correspond to respective keywords. For instance, referring back to the play David Bowie in the Kitchen example, when processing the voice input, the local keyword engine 771 may determine that an intent is to play music (e.g., intent=playMusic), while a first slot includes David Bowie as target content (e.g., slot1-DavidBowie) and a second slot includes the Kitchen 101h as the target playback device (e.g., slot2-kitchen). Here, the intent (to “play Music”) is based on the command keyword and the slots are parameters modifying the intent to a particular target content and play back device.

Some error in performing local automatic speech recognition is expected. Within examples, the keyword engine 771 may generate a confidence score when transcribing spoken words to text, which indicates how closely the spoken words in the voice input 780 matches the sound patterns for that word. In some implementations, generating a command-keyword event is based on the confidence score for a given command keyword. For instance, the keyword engine 771 may generate a command-keyword event when the confidence score for a given sound exceeds a given threshold value (e.g., 0.5 on a scale of 0-1, indicating that the given sound is more likely than not the command keyword). Conversely, when the confidence score for a given sound is at or below the given threshold value, the keyword engine 771 does not generate the command-keyword event.

Similarly, some error in performing keyword matching is expected. Within examples, the keyword engine 771 may generate a confidence score when determining an intent, which indicates how closely the transcribed words in the signal match the corresponding keywords in the library of the local keyword engine 771. In some implementations, performing an operation according to a determined intent is based on the confidence score for keywords. For instance, the NMD 703 may perform an operation according to a determined intent when the confidence score for a given sound exceeds a given threshold value (e.g., 0.5 on a scale of 0-1, indicating that the given sound is more likely than not the command keyword). Conversely, when the confidence score for a given intent is at or below the given threshold value, the NMD 703 does not perform the operation according to the determined intent.

As noted above, in some implementations, a phrase may be used as a command keyword, which provides additional syllables to match (or not match). For instance, the phrase “play me some music” has more syllables than “play,” which provides additional sound patterns to match to words. Accordingly, command keywords that are phrases may generally be less prone to false wake word triggers.

As indicated above, the NMD 703 generates a command-keyword event (and performs a command corresponding to the detected command keyword) only when certain conditions corresponding to a detected command keyword are met. These conditions are intended to lower the prevalence of false positive command-keyword events. For instance, after detecting the command keyword “skip.” the NMD 703 generates a command-keyword event (and skips to the next track) only when certain playback conditions indicating that a skip should be performed are met. These playback conditions may include, for example, (i) a first condition that a media item is being played back, (ii) a second condition that a queue is active, and (iii) a third condition that the queue includes a media item subsequent to the media item being played back. If any of these conditions are not satisfied, the command-keyword event is not generated (and no skip is performed).

The NMD 703 can include one or more state machine(s) to facilitate determining whether the appropriate conditions are met. The state machine transitions between a first state and a second state based on whether one or more conditions corresponding to the detected command keyword are met. In particular, for a given command keyword corresponding to a particular command requiring one or more particular conditions, the state machine transitions into a first state when one or more particular conditions are satisfied and transitions into a second state when at least one condition of the one or more particular conditions is not satisfied.

Within example implementations, the command conditions are based on states indicated in state variables. As noted above, the devices of the MPS 100 may store state variables describing the state of the respective device. For instance, the playback devices 102 may store state variables indicating the state of the playback devices 102, such as the audio content currently playing (or paused), the volume levels, network connection status, and the like). These state variables are updated (e.g., periodically, or based on an event (i.e., when a state in a state variable changes)) and the state variables further can be shared among the devices of the MPS 100, including the NMD 703.

Similarly, the NMD 703 may maintain these state variables (either by virtue of being implemented in a play back device or as a stand-alone NMD). The state machine monitors the states indicated in these state variables, and determines whether the states indicated in the appropriate state variables indicate that the command condition(s) are satisfied. Based on these determinations, the state machine transitions between the first state and the second state, as described above.

Other example conditions may be based on the output of a voice activity detector (“VAD”) 765. The VAD 765 is configured to detect the presence (or lack thereof) of voice activity in the sound-data stream S_{DS}. In particular, the VAD 765 may analyze frames corresponding to the pre-roll portion of the voice input 780 (FIG. 2D) with one or more voice detection algorithms to determine whether voice activity was present in the environment in certain time windows prior to a keyword portion of the voice input 780.

The VAD 765 may utilize any suitable voice activity detection algorithms. Example voice detection algorithms involve determining whether a given frame includes one or more features or qualities that correspond to voice activity, and further determining whether those features or qualities diverge from noise to a given extent (e.g., if a value exceeds a threshold for a given frame). Some example voice detection algorithms involve filtering or otherwise reducing noise in the frames prior to identifying the features or qualities.

In some examples, the VAD 765 may determine whether voice activity is present in the environment based on one or more metrics. For example, the VAD 765 can be configured distinguish between frames that include voice activity and frames that don't include voice activity. The frames that the VAD determines have voice activity may be caused by speech regardless of whether it near- or far-field. In this example and others, the VAD 765 may determine a count of frames in the pre-roll portion of the voice input 780 that indicate voice activity. If this count exceeds a threshold percentage or number of frames, the VAD 765 may be configured to output a signal or set a state variable indicating that voice activity is present in the environment. Other metrics may be used as well in addition to, or as an alternative to, such a count.

The presence of voice activity in an environment may indicate that a voice input is being directed to the NMD 73. Accordingly, when the VAD 765 indicates that voice activity is not present in the environment (perhaps as indicated by a state variable set by the VAD 765) this may be configured as one of the command conditions for the command keywords. When this condition is met (i.e., the VAD 765 indicates that voice activity is present in the environment), the state machine 775 will transition to the first state to enable performing commands based on command keywords, so long as any other conditions for a particular command keyword are satisfied.

Further, in some implementations, the NMD 703 may include a noise classifier 766. The noise classifier 766 is configured to determine sound metadata (frequency response, signal levels, etc.) and identify signatures in the sound metadata corresponding to various noise sources. The noise classifier 766 may include a neural network or other mathematical model configured to identify different types of noise in detected sound data or metadata. One classification of noise may be speech (e.g., far-field speech). Another classification may be a specific type of speech, such as background speech, and example of which is described in greater detail with reference to FIG. 8. Background speech may be differentiated from other types of voice-like activity, such as more general voice activity (e.g., cadence, pauses, or other characteristics) of voice-like activity detected by the VAD 765.

For example, analyzing the sound metadata can include comparing one or more features of the sound metadata with known noise reference values or a sample population data with known noise. For example, any features of the sound metadata such as signal levels, frequency response spectra, etc. can be compared with noise reference values or values collected and averaged over a sample population. In some examples, analyzing the sound metadata includes projecting the frequency response spectrum onto an eigenspace corresponding to aggregated frequency response spectra from a population of NMDs. Further, projecting the frequency response spectrum onto an eigenspace can be performed as a pre-processing step to facilitate downstream classification.

In various examples, any number of different techniques for classification of noise using the sound metadata can be used, for example machine learning using decision trees, or Bayesian classifiers, neural networks, or any other classification techniques. Alternatively or additionally, various clustering techniques may be used, for example K-Means clustering, mean-shift clustering, expectation-maximization clustering, or any other suitable clustering technique. Techniques to classify noise may include one or more techniques disclosed in U.S. application Ser. No. 16/227,308 filed Dec. 20, 2018, and titled “Optimization of Network Microphone Devices Using Noise Classification,” which is herein incorporated by reference in its entirety.

With continued reference to FIG. 7, in some implementations, the additional buffer 769 (shown in dashed lines) may store information (e.g., metadata or the like) regarding the detected sound S_{D} that was processed by the upstream AEC 763 and spatial processor 764. This additional buffer 769 may be referred to as a “sound metadata buffer.” Examples of such sound metadata include: (1) frequency response data. (2) echo return loss enhancement measures, (3) voice direction measures: (4) arbitration statistics; and/or (5) speech spectral data. In example implementations, the noise classifier 766 may analyze the sound metadata in the buffer 769 to classify noise in the detected sound S_{D}.

As noted above, one classification of sound may be background speech, such as speech indicative of far-field speech and/or speech indicative of a conversation not involving the NMD 703. The noise classifier 766 may output a signal and/or set a state variable indicating that background speech is present in the environment. The presence of voice activity (i.e., speech) in the pre-roll portion of the voice input 780 indicates that the voice input 780 might not be directed to the NMD 703, but instead be conversational speech within the environment. For instance, a household member might speak something like “our kids should have a play date soon” without intending to direct the command keyword “play” to the NMD 703.

Further, when the noise classifier indicates that background speech is present is present in the environment, this condition may disable the keyword engine 771. In some implementations, the condition of background speech being absent in the environment (perhaps as indicated by a state variable set by the noise classifier 766) is configured as one of the command conditions for the command keywords. Accordingly, the state machine 775 will not transition to the first state when the noise classifier 766 indicates that background speech is present in the environment.

Further, the noise classifier 766 may determine whether background speech is present in the environment based on one or more metrics. For example, the noise classifier 766 may determine a count of frames in the pre-roll portion of the voice input 780 that indicate background speech. If this count exceeds a threshold percentage or number of frames, the noise classifier 766 may be configured to output the signal or set the state variable indicating that background speech is present in the environment. Other metrics may be used as well in addition to, or as an alternative to, such a count.

Referring still to FIG. 7, in some examples, one or more additional keyword engines may be provided, for example including custom keyword engines. Cloud service providers, such as streaming audio services, may provide a custom keyword engine pre-configured with identification algorithms configured to spot service-specific command keywords. These service-specific command keywords may include commands for custom service features and/or custom names used in accessing the service.

For instance, the NMD 703 may include a particular streaming audio service (e.g., Apple Music) keyword engine. This particular keyword engine may be configured to detect command keywords specific to the particular streaming audio service and generate streaming audio service wake word events. For instance, one command keyword may be “Friends Mix,” which corresponds to a command to play back a custom playlist generated from playback histories of one or more “friends” within the particular streaming audio service.

In some examples, different NMDs 703 of the same media play back system 100 can have different additional custom keyword engines. For example, a first NMD may include a custom keyword engine configured with a library of keywords configured for a particular streaming audio service (e.g., Apple Music) while a second NMD includes a custom-command keyword engine configured with a library of keywords configured to a different streaming audio service (e.g., Spotify). In operation, voice input received at either NMD may be transmitted to the other NMD for processing, such that in combination the media playback system may effectively evaluate voice input for keywords with the benefit of multiple different custom keyword engines distributed among multiple different NMDs 703.

Referring back to FIG. 7, in certain examples, the VAS wake-word engine 770a and the keyword engine 771 may take a variety of forms. For example, the VAS wake-word engine 770a and the keyword engine 771 may take the form of one or more modules that are stored in memory of the NMD 703 (e.g., the memory 112b of FIG. 1F). As another example, the VAS wake-word engine 770a and the keyword engine 771 may take the form of a general purposes or special-purpose processor, or modules thereof. In this respect, multiple wake word engines 770) and 771 may be part of the same component of the NMD 703 or each wake-word engine 770) and 771 may take the form of a component that is dedicated for the particular wake-word engine. Other possibilities also exist.

To further reduce false positives, the keyword engine 771 may utilize a relative low sensitivity compared with the VAS wake-word engine 770a. In practice, a wake-word engine may include a sensitivity level setting that is modifiable. The sensitivity level may define a degree of similarity between a word identified in the detected sound stream S_{DS1} and the wake-word engine's one or more particular wake words that is considered to be a match (i.e., that triggers a VAS wake-word or command-keyword event). In other words, the sensitivity level defines how closely, as one example, the spectral characteristics in the detected sound stream S_{DS2} must match the spectral characteristics of the engine's one or more wake words to be a wake-word trigger.

In this respect, the sensitivity level generally controls how many false positives that the VAS wake-word engine 770a and keyword engine 771 identifies. For example, if the VAS wake-word engine 770a is configured to identify the wake-word “Alexa” with a relatively high sensitivity, then false wake words of “Election” or “Lexus” may cause the wake-word engine 770a to flag the presence of the wake-word “Alexa.” In contrast, if the keyword engine 771 is configured with a relatively low sensitivity, then the false wake words of “may” or “day” would not cause the keyword engine 771 to flag the presence of the command keyword “Play.”

In practice, a sensitivity level may take a variety of forms. In example implementations, a sensitivity level takes the form of a confidence threshold that defines a minimum confidence (i.e., probability) level for a wake-word engine that serves as a dividing line between triggering or not triggering a wake-word event when the wake-word engine is analyzing detected sound for its particular wake word. In this regard, a higher sensitivity level corresponds to a lower confidence threshold (and more false positives), whereas a lower sensitivity level corresponds to a higher confidence threshold (and fewer false positives). For example, lowering a wake-word engine's confidence threshold configures it to trigger a wake-word event when it identifies words that have a lower likelihood that they are the actual particular wake word, whereas raising the confidence threshold configures the engine to trigger a wake-word event when it identifies words that have a higher likelihood that they are the actual particular wake word. Within examples, a sensitivity level of the keyword engine 771 may be based on more or more confidence scores, such as the confidence score in spotting a command keyword and/or a confidence score in determining an intent. Other examples of sensitivity levels are also possible.

In example implementations, sensitivity level parameters (e.g., the range of sensitivities) for a particular wake-word engine can be updated, which may occur in a variety of manners. As one possibility, a VAS or other third-party provider of a given wake-word engine may provide to the NMD 703 a wake-word engine update that modifies one or more sensitivity level parameters for the given VAS wake-word engine 770a. By contrast, the sensitive level parameters of the keyword engine 771 may be configured by the manufacturer of the NMD 703 or by another cloud service (e.g., for a custom wake-word engine).

Notably, within certain examples, the NMD 703 foregoes sending any data representing the detected sound S_{D} (e.g., the messages M_{V}) to a VAS when processing a voice input 780 including a command keyword. In implementations including the local keyword engine 771, the NMD 703 can further process the voice utterance portion of the voice input 780 (in addition to the keyword word portion) without necessarily sending the voice utterance portion of the voice input 780 to the VAS. Accordingly, speaking a voice input 780 (with a command keyword) to the NMD 703 may provide increased privacy relative to other NMDs that process all voice inputs using a VAS.

As indicated above, the keywords in the library of the keyword engine 771 can correspond to parameters. These parameters may define to perform the command corresponding to the detected command keyword. When keywords are recognized in the voice input 780, the command corresponding to the detected command keyword is performed according to parameters corresponding to the detected keywords.

For instance, an example voice input 780 may be “play music at low volume” with “play” being the command keyword portion (corresponding to a play back command) and “music at low volume” being the voice utterance portion. When analyzing this voice input 780, the keyword engine 771 may recognize that “low volume” is a keyword in its library corresponding to a parameter representing a certain (low) volume level. Accordingly, the keyword engine 771 may determine an intent to play at this lower volume level. Then, when performing the play back command corresponding to “play,” this command is performed according to the parameter representing a certain volume level.

In a second example, another example voice input 780 may be “play my favorites in the Kitchen” with “play” again being the command keyword portion (corresponding to a play back command) and “my favorites in the Kitchen” as the voice utterance portion. When analyzing this voice input 780, the keyword engine 771 may recognize that “favorites” and “Kitchen” match keywords in its library. In particular, “favorites” corresponds to a first parameter representing particular audio content (i.e., a particular playlist that includes a user's favorite audio tracks) while “Kitchen” corresponds to a second parameter representing a target for the playback command (i.e., the kitchen 101h zone. Accordingly, the keyword engine 771 may determine an intent to play this particular playlist in the kitchen 101h zone.

In a third example, a further example voice input 780 may be “volume up” with “volume” being the command keyword portion (corresponding to a volume adjustment command) and “up” being the voice utterance portion. When analyzing this voice input 780, the keyword engine 771 may recognize that “up” is a keyword in its library corresponding to a parameter representing a certain volume increase (e.g., a 10-point increase on a 100-point volume scale). Accordingly, the keyword engine 771 may determine an intent to increase volume. Then, when performing the volume adjustment command corresponding to “volume,” this command is performed according to the parameter representing the certain volume increase.

Within examples, certain command keywords are functionally linked to a subset of the keywords within the library of the keyword engine 771, which may hasten analysis. For instance, the command keyword “skip” may be functionality linked to the keywords “forward” and “backward” and their cognates. Accordingly, when the command keyword “skip” is detected in a given voice input 780, analyzing the voice utterance portion of that voice input 780 with the local keyword engine 771 may involve determining whether the voice input 780 includes any keywords that match these functionally linked keywords (rather than determining whether the voice input 780 includes any keywords that match any keyword in the library of the local keyword engine 771). Since vastly fewer keywords are checked, this analysis is relatively quicker than a full search of the library. By contrast, a nonce VAS wake word such as “Alexa” provides no indication as to the scope of the accompanying voice input.

Some commands may require one or more parameters, as such the command keyword alone does not provide enough information to perform the corresponding command. For example, the command keyword “volume” might require a parameter to specify a volume increase or decrease, as the intent of “volume” of volume alone is unclear. As another example, the command keyword “group” may require two or more parameters identifying the target devices to group.

Accordingly, in some example implementations, when a given command keyword is detected in the voice input 780 by the keyword engine 771, the local keyword engine 771 may determine whether the voice input 780 includes keywords matching keywords in the library corresponding to the required parameters. If the voice input 780 does include keywords matching the required parameters, the NMD 703 proceeds to perform the command (corresponding to the given command keyword) according to the parameters specified by the keywords.

However, if the voice input 780 does include keywords matching the required parameters for the command, the NMD 703 may prompt the user to provide the parameters. For instance, in a first example, the NMD 703 may play an audible prompt such as “I've heard a command, but I need more information” or “Can I help you with something?” Alternatively, the NMD 703 may send a prompt to a user's personal device via a control application (e.g., the software components 132c of the control device(s) 104).

In further examples, the NMD 703 may play an audible prompt customized to the detected command keyword. For instance, after detecting a command keyword corresponding to a volume adjustment command (e.g., “volume”), the audible prompt may include a more specific request such as “Do you want to adjust the volume up or down?” As another example, for a grouping command corresponding to the command keyword “group,” the audible prompt may be “Which devices do you want to group?” Supporting such specific audible prompts may be made practicable by supporting a relatively limited number of command keywords (e.g., less than 100), but other implementations may support more command keywords with the trade-off of requiring additional memory and processing capability.

Within additional examples, when a voice utterance portion does not include keywords corresponding to one or more required parameters, the NMD 703 may perform the corresponding command according to one or more default parameters. For instance, if a playback command does not include keywords indicating target playback devices 102 for play back, the NMD 703 may default to play back on the NMD 703 itself (e.g., if the NMD 703 is implemented within a playback device 102) or to playback on one or more associated play back devices 102 (e.g., play back devices 102 in the same room or zone as the NMD 703). Further, in some examples, the user may configure default parameters using a graphical user interface (e.g., user interface 430) or voice user interface. For example, if a grouping command does not specify the playback devices 102 to group, the NMD 703 may default to instructing two or more pre-configured default playback devices 102 to form a synchrony group. Default parameters may be stored in data storage (e.g., the memory 112b (FIG. 1F)) and accessed when the NMD 703 determines that keywords exclude certain parameters. Other examples are possible as well.

In some cases, the NMD 703 sends the voice input 780 to a VAS when the keyword engine 771 is unable to process the voice input 780 (e.g., when the local keyword engine 771 is unable to find matches to keywords in the library, or when the local keyword engine 771 has a low confidence score as to intent). In an example, to trigger sending the voice input 780, the NMD 703 may generate a bridging event, which causes the voice extractor 773 to process the sound-data stream S_{D}, as discussed above. That is, the NMD 703 generates a bridging event to trigger the voice extractor 773 without a VAS wake-word being detected by the VAS wake word engine 770a (instead based on a command keyword in the voice input 780, as well as the keyword engine 771 being unable to process the voice input 780).

Before sending the voice input 780 to the VAS (e.g., via the messages M_{V}), the NMD 703 may obtain confirmation from the user that the user acquiesces to the voice input 780 being sent to the VAS. For instance, the NMD 703 may play an audible prompt to send the voice input to a default or otherwise configured VAS, such as “I'm sorry, I didn't understand that. May I ask Alexa?” In another example, the NMD 703 may play an audible prompt using a VAS voice (i.e., a voice that is known to most users as being associated with a particular VAS), such as “Can I help you with something?” In such examples, generation of the bridging event (and trigging of the voice extractor 773) is contingent on a second affirmative voice input 780) from the user.

Within certain example implementations, the local keyword engine 771 may process the signal SASR without necessarily a command-keyword event being generated by the keyword engine 771 (i.e., directly). That is, the automatic speech recognition 772 may be configured to perform automatic speech recognition on the sound-data stream S_{D}, which the local keyword engine 771 processes for matching keywords without requiring a command-keyword event. If keywords in the voice input 780 are found to match keywords corresponding to a command (possibly with one or more keywords corresponding to one or more parameters), the NMD 703 performs the command according to the one or more parameters.

In some examples, the library of the local keyword engine 771 is partially customized to the individual user(s). In a first aspect, the library may be customized to the devices that are within the household of the NMD (e.g., the household within the environment 101 (FIG. 1A)). For instance, the library of the local keyword engine 771 may include keywords corresponding to the names of the devices within the household, such as the zone names of the playback devices 102 in the MPS 100. In a second aspect, the library may be customized to the users of the devices within the household. For example, the library of the local keyword engine 771 may include keywords corresponding to names or other identifiers of a user's preferred playlists, artists, albums, and the like. Then, the user may refer to these names or identifiers when directing voice inputs to the keyword engine 771. In some examples, different NMDs 703 of the same media playback system 100 can have different keyword engines 771 with different customized libraries. For example, a first NMD may include a first subset of device and zone names, and a second NMD may include a second subset of device and zone names.

Within example implementations, the NMD 703 may populate the library of the local keyword engine 771 locally within the network 111 (FIG. 1B). As noted above, the NMD 703 may maintain or have access to state variables indicating the respective states of devices connected to the network 111 (e.g., the playback devices 104). These state variables may include names of the various devices. For instance, the kitchen 101h may include the play back device 102b, which are assigned the zone name “Kitchen.” The NMD 703 may read these names from the state variables and include them in the library of the local keyword engine 771 by training the local keyword engine 771 to recognize them as keywords. The keyword entry for a given name may then be associated with the corresponding device in an associated parameter (e.g., by an identifier of the device, such as a MAC address or IP address). The NMD 703 can then use the parameters to customize control commands and direct the commands to a particular device.

In further examples, the NMD 703 may populate the library by discovering devices connected to the network 111. For instance, the NMD 703 may transmit discovery requests via the network 111 according to a protocol configured for device discovery, such as universal plug-and-play (UPnP) or zero-configuration networking. Devices on the network 111 may then respond to the discovery requests and exchange data representing the device names, identifiers, addresses and the like to facilitate communication and control via the network 111. The NMD 703 may read these names from the exchanged messages and include them in the library of the local keyword engine 771 by training the local keyword engine 771 to recognize them as keywords.

As discussed above, an NMD 703 may be configured to communicate with remote computing devices (e.g., cloud servers) associated with multiple different VASes. Although several examples are provided herein with respect to managing interactions between two VASes, in various examples there may be additional VASes (e.g., three, four, five, six, or more VASes), and the interactions between these VASes can be managed using the approaches described herein. In various examples, in response to detecting a particular wake word, the NMD 703 may send voice inputs over a network 102 to the remote computing device(s) associated with the first VAS 190 or one or more additional VASes (FIG. 1B). In some examples, the one or more NMDs 703 only send the voice utterance portion 280b (FIG. 2C) of the voice input 280 to the remote computing device(s) associated with the VAS(es) (and not the wake word portion 280a). In some examples, the one or more NMDs 103 send both the voice utterance portion 280b and the wake word portion 280a (FIG. 3F) to the remote computing device(s) associated with the VAS(es).

FIG. 8 is a message flow diagram illustrating various data exchanges between the MPS 100 and the remote computing devices. The media playback system 100 captures a voice input via a network microphone device in block 801 and detects a wake word in the voice input in block 803 (e.g., via wake-word engine 770a (FIG. 7). Once a particular wake word has been detected (block 803), the MPS 100 may suppress other wake word detector(s) in block 805. For example, if the wake word “Alexa” is detected in the voice utterance in block 803, then the MPS 100 may suppress operation of a second wake-word detector configured to detect a wake word such as “OK, Google.” This can reduce the likelihood of cross-talk between different VASes, by reducing or eliminating the risk that second VAS mistakenly detects its wake word during a user's active dialogue session with a first VAS. This can also preserve user privacy by eliminating the possibility of a user's voice input intended for one VAS being transmitted to a different VAS.

In some examples, suppressing operation of the second wake-word detector involves ceasing providing voice input to the second wake-word detector for a predetermined time, or until a user interaction with the first VAS is deemed to be completed (e.g., after a predetermined time has elapsed since the last interaction-either a text-to-speech output from the first VAS or a user voice input to the first VAS). In some examples, suppression of the second wake-word detector can involve powering down the second wake-word detector to a low-power or no-power state for a predetermined time or until the user interaction with the first VAS is deemed complete.

In some examples, the first wake-word detector can remain active even after the first wake word has been detected and the voice utterance has been transmitted to the first VAS, such that a user may utter the first wake word to interrupt a current output or other activity being performed by the first VAS. For example, if a user asks Alexa to read a news flash briefing, and the play back device begins to play back the text-to-speech (TTS) response from Alexa, a user may interrupt by speaking the wake word followed by a new command.

With continued reference to FIG. 8, in block 807, the media play back system 100 may select an appropriate VAS based on particular wake word detected in block 803. In the illustrated message flow, the first VAS 190 is selected in block 807. In alternative flows, a different VAS may be selected in block 807. Upon this selection, the media play back system 100 transmits one or more messages 809 (e.g., packets) containing the voice utterance (e.g., voice utterance 280b of FIG. 2C) to the first VAS 190. The media play back system 100 may concurrently transmit other information to the first VAS 190 with the message(s) 809. For example, the media playback system 100 may transmit data over a metadata channel, as described in for example, in previously referenced U.S. application Ser. No. 15/438,749.

The first VAS 190 may process the voice input in the message(s) 809 to determine intent (block 811). Based on the intent, the first VAS 190 may send content 813 via messages (e.g., packets) to the media playback system 100. In some instances, the response message(s) 713 may include a payload that directs one or more of the devices of the media play back system 100 to execute instructions. For example, the instructions may direct the media play back system 100 to play back media content, group devices, and/or perform other functions. In addition or alternatively, the first content 813 from the first VAS 190 may include a payload with a request for more information, such as in the case of multi-turn commands.

In block 815, the MPS 100 outputs a response, for example by playing back the first content 813, causing one or more devices of the MPS 100 to perform some action, or transmitting instructions to one or more external devices to perform an action (e.g., instructing a smart thermostat to adjust a temperature setting). In some examples, the MPS 100 may exchange messages for receiving content, such as via a media stream 817 comprising, e.g., audio content.

In block 819, the other wake word detector(s) can be re-enabled. For example, the MPS 100 may resume providing voice input to the other wake-word detector(s) after a predetermined time or after the user's interaction with the first VAS 190 is deemed to be completed (e.g., after a predetermined time has elapsed since the last interaction-either a text-to-speech output from the first VAS or a user voice input to the first VAS). Once the other wake word detector(s) have been re-enabled, a user may initiate interaction with any available VAS by speaking the appropriate wake word or phrase.

### III. Example Systems and Methods for Managing Concurrent Voice Assistant Services

While it can be useful to enable a single NMD to interact with multiple VASes, providing multiple concurrently enabled VASes can lead to poor user experience in some situations. As a result, in some instances, it may be beneficial or necessary to restrict concurrent operation, association, or enablement of two or more VASes on a particular NMD, or within a particular media playback system. For example, it may be useful to prohibit concurrent operation of two VASes with wake words that are too similar, or that are configured to control the same household appliances (e.g., two smart-light VASes). Additionally or alternatively, if the combination of concurrent VASes will place excessive computational demands on the NMD (e.g., processing power, memory consumption, etc.), then the user experience can be improved by prohibiting concurrency of at least some of the selected VASes.

To address these and other problems, an NMD can access a concurrency rules engine that provides concurrency restrictions for VASes associated with one or more network microphone devices. In various examples, such a rules engine can be stored locally on the NMD or can be maintained on one or more remote computing devices that are accessible to the NMD via a network connection. In operation, an NMD that is already associated with at least a first VAS may receive a request to be associated with a second VAS (and/or to enable a wake-word engine associated with the second VAS). For example, a user with an NMD that is enabled to communicate with an AMAZON VAS may wish to add a second voice assistant service to the device, and may instruct the NMD (e.g., via a control device 104) to enable the second VAS on the NMD. A user may indicate this request in any number of ways, such as via a control device 104, by voice input provided to an NMD, or any other form of user selection. Following this request, the NMD may access the rules engine to determine whether any concurrency restrictions apply. If no concurrency restrictions apply, the NMD may proceed to enable the second VAS, after which the NMD can be concurrently associated with the first VAS and the second VAS. If some concurrency restriction does apply (for example, there is a prohibition of concurrent association with both the first VAS and second VAS), the NMD may either disable or otherwise disassociate with the first VAS and enable the second VAS, or the NMD may preclude association with the second VAS and maintain association with the first VAS. In some instances, the concurrency rules engine can include prioritization rules that dictate which VAS will prevail in the event of a concurrency prohibition. In some examples, the most recently selected VAS may prevail in the event of a concurrency restriction. In other examples, a native VAS may prevail over a third-party VAS in the event of a concurrency restriction. According to some examples, an indication can be provided to the user regarding which VAS has been enabled and which, if any, has been disabled.

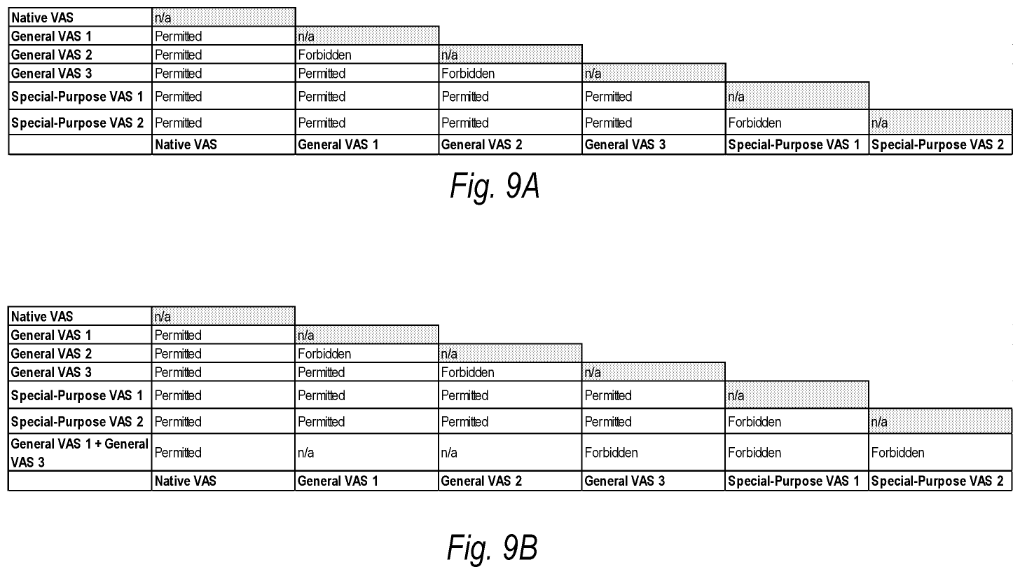

FIGS. 9A and 9B illustrate example concurrency policy tables reflecting concurrency permissions and restrictions of a concurrency rules engine. The tables illustrate a simplified form for discussion purposes only in which one enabled VAS is shown in the left-hand column, and another possibly enabled VAS is shown along the bottom row. At intersections of particular VAS pairs, the policy tables indicate whether such concurrent enablement is permitted or forbidden. As one example, native VAS can be a SONOS VAS operating on a SONOS playback device, General VAS 1 can be an AMAZON VAS (e.g., ALEXA), General VAS 2 can be a GOOGLE VAS (e.g., GOOGLE Assistant), General VAS 3 can be a MICROSOFT VAS (e.g., CORTANA), Special-Purpose VAS 1 can be a PHILIPS VAS for controlling smart-home lights, and Special-Purpose VAS 2 can be an XFINITY VAS for interacting with a smart television.

In the example shown in FIG. 9A, native VAS is permitted to be concurrently enabled with any one of the other VASes. As such, if a user has previously opted to enable native VAS (or if native VAS was enabled by default), a request from the user to enable any one of the other VASes shown will be permitted by the concurrency rules engine. While many of the possible combinations are permitted, the table shown in FIG. 9A forbids the concurrent enablement of General VAS 2 and General VAS 1, and also forbids the concurrent enablement of General VAS 3 and General VAS 2. In such cases, the user may only be permitted to enable one of these VASes at a given time. In some instances, general-purpose VASes may impose their own restrictions on concurrency. For example, the company offering General VAS 1 may contractually require an NMD manufacturer to forbid concurrent enablement of General VAS 1 and General VAS 2 on the same NMD.

Another restriction illustrated in FIG. 9A is the concurrent enablement of Special-Purpose VAS 1 and Special-Purpose VAS 2. Such restrictions may be provided because, for example, the wake words associated with these VASes are too similar, or other incompatibilities (e.g., two smart-light VASes may not be enabled on the same NMD to avoid poor user experience when trying to control lights via voice control).

FIG. 9B illustrates another example of a policy table, with an additional row reflecting concurrent enablement of General VAS 1 and General VAS 3. In this row, the policy table indicates that an NMD that has these two VASes enabled may additionally concurrently enable native VAS, but may not enable any of the other VASes shown in the table. This restriction can reflect a conservation of computational resources of the NMD. For example, because running multiple wake-word engines on an NMD can be computationally intensive, the policy table may limit concurrent operation of two general-purpose VASes such that no additional third-party VASes are permitted.

In operation, a user may initiate a request to enable a particular VAS on the user's NMD. The NMD may access a concurrency rules engine that includes restrictions such as those illustrated in the policy tables in FIGS. 9A and 9B. If there are any concurrency restrictions, the NMD may preclude concurrent enablement by: (i) disabling one or more previously enabled VASes on the NMD, and enabling the newly requested VAS: (ii) precluding enablement of the newly requested VAS: or (iii) outputting a message to the user indicating a concurrency restriction and asking which VAS should be enabled and which should be disabled. In this latter case, an input from the user (e.g., received via voice control (e.g., via native VAS) or via control device 104) can be used to determine which VAS to enable and which to disable.

Although the tables shown in FIGS. 9A and 9B are relatively simplified, indicating policies around two or three concurrent VASes, in various examples a concurrency rules engine may include rules governing concurrent operation or enablement of any number of VASes on a single NMD. In some examples, forbidden combinations can be restricted by uninstalling or deleting software associated with a particular VAS from the NMD. Additionally or alternatively, forbidden combinations can be restricted by disabling a wake-word engine associated with a particular VAS such that the disabled wake-word engine does not process voice input captured via the NMD.

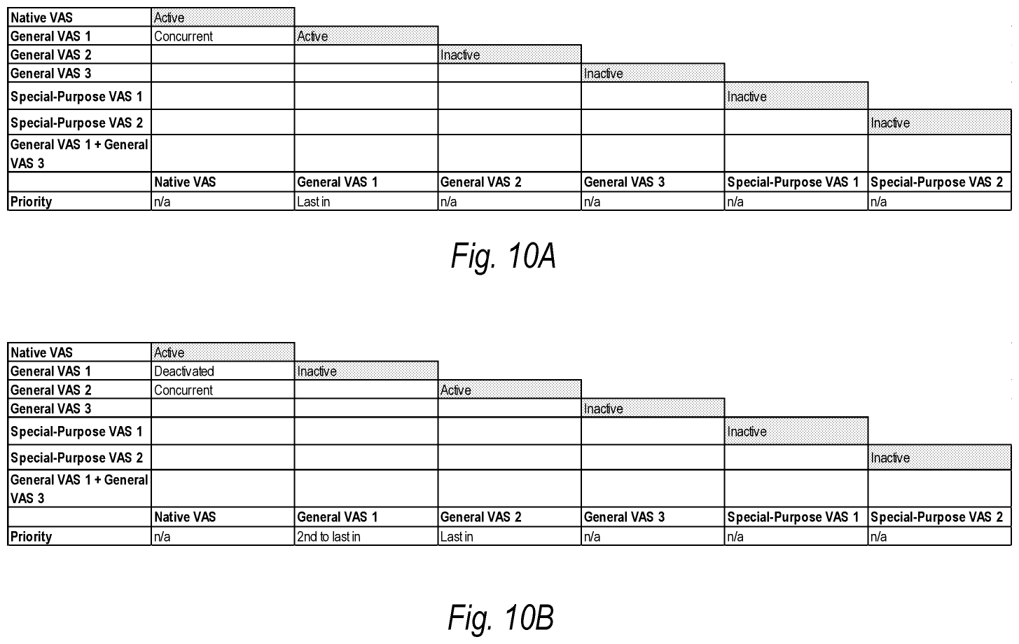

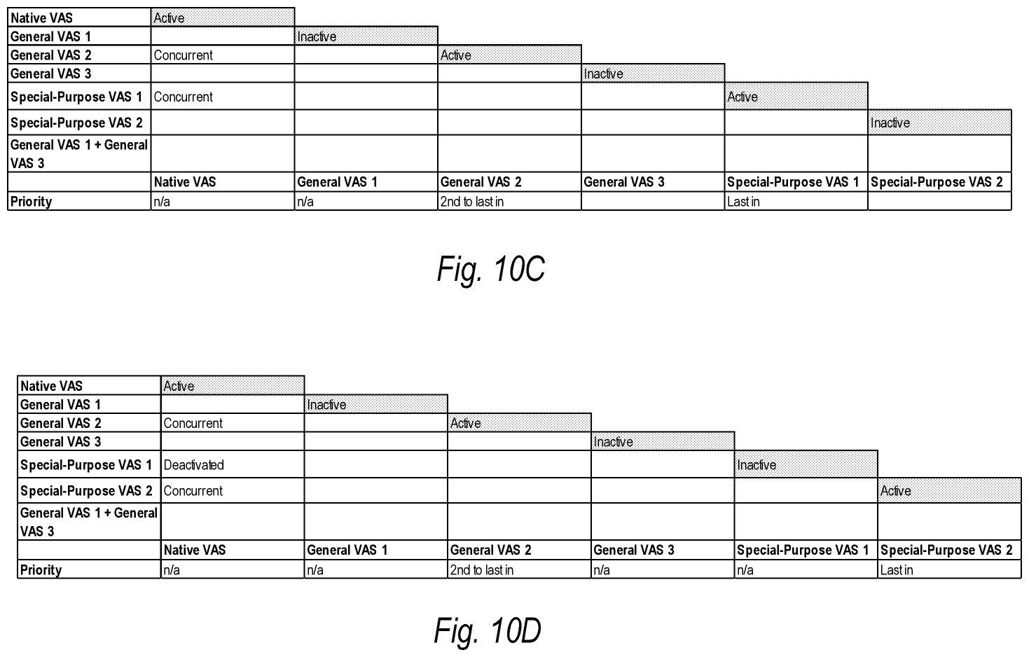

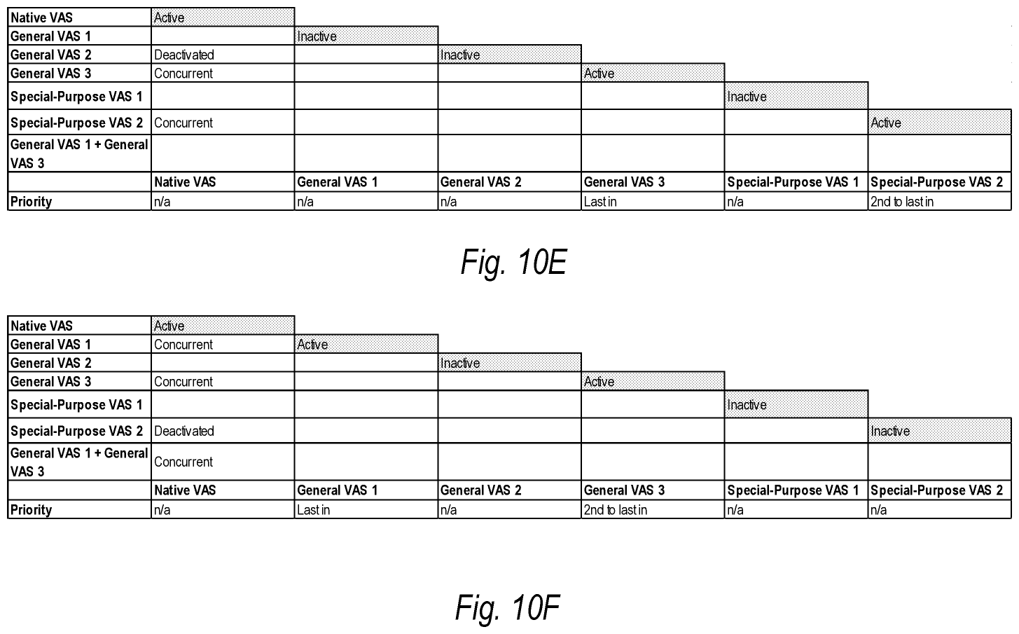

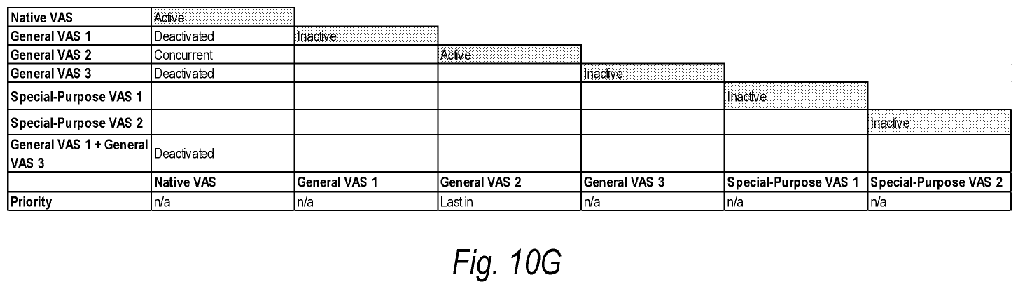

FIGS. 10A-10G are tables illustrating the status of activated (e.g., enabled or operational) and deactivated (e.g., disabled, non-operational) VASes over time in an example process. For example, in the configuration shown in FIG. 10A, the user may initially enable native VAS (or native VAS may be pre-enabled by default) and the user may also enable General VAS 1, such that these two VASes are concurrently enabled on the NMD. In this example, these two VASes are permitted to be concurrently enabled (e.g., as governed by a concurrency rules engine).

Next, the user may enable (e.g., install or activate) General VAS 2. Because a concurrency rules engine forbids concurrent enablement of General VAS 1 and General VAS 2, the NMD may deactivate (e.g., disable, delete, or uninstall) General VAS 1 and enable General VAS 2, as reflected in FIG. 10B. In the case of a concurrency restriction, the concurrency rules engine may also dictate which VAS is to be disabled, for example on the basis of that VAS's priority. The tables shown in FIGS. 10A-10G indicate a priority ranking along the bottom row, which identifies which VAS was “last in” (i.e., the most recent to be selected for activation). One example prioritization policy is to enable the last in VAS (e.g., the VAS most recently actively selected by a user) in the event of conflict, such that the prioritization rules follow a “first in, first out” policy. Additionally or alternatively, certain VASes can be exceptions to the prioritization rules. For example, once native VAS has been enabled, native VAS can be an exception to the prioritization rules, such that it is never disabled as a result of a concurrency restriction, but rather is only disabled if a user specifically opts to disable native VAS. The prioritization rules shown here are but one example. In other instances, the prioritization can be based on other factors, such as computational demands, type of VAS, contractual obligations, etc.

Next, the user may opt to enable (e.g., activate or install) Special-Purpose VAS 1. Since this does not violate any concurrency policy (e.g., as reflected in the policy tables shown in FIGS. 9A and 9B), Special-Purpose VAS 1 is activated, and all three of General VAS 2, Special-Purpose VAS 1, and native VAS are permitted to operate concurrently on the NMD, as reflected in FIG. 10C.

With reference to FIG. 10D, the user may then enable (e.g., activate or install) Special-Purpose VAS 2. Since the concurrency rules engine forbids concurrent enablement of the Special-Purpose VAS 1 and Special-Purpose VAS 2 (e.g., as reflected in the policy tables shown in FIGS. 9A and 9B), Special-Purpose VAS 1 can be deactivated (e.g., disabled, deleted, or uninstalled) from the NMD. Deactivation of Special-Purpose VAS 1 can accord with the “first in, first out” prioritization rules, since the Special-Purpose VAS 2 has been most recently selected by the user for enablement.

At a later time, the user may choose to enable General VAS 3, which violates concurrency policies that do not permit the concurrent enablement of General VAS 2 and General VAS 3. In this scenario, because General VAS 3 has been selected by the user more recently than General VAS 2 (as shown in the priority row), General VAS 2 is deactivated and General VAS 3 is activated, as shown in FIG. 10E. At this stage, the native VAS, Special-Purpose VAS 2, and General VAS 3 are all concurrently enabled on the NMD.

Next, at a later time, as reflected in FIG. 10F, the user re-enables (e.g., re-installs or re-activates) General VAS 1. This configuration violates a concurrency restriction (e.g., as shown in the policy table of FIG. 9B), which permits forbids concurrent enablement of any additional VASes if General VAS 1 and General VAS 3 are both concurrently enabled. As such, as a result of this concurrency restriction, Special-Purpose VAS 2 is disabled, and General VAS 1 and General VAS 2 are enabled.

Finally, the user may choose to re-enable General VAS 2. Because this violates a concurrency restriction (e.g., as shown in the policy table of FIG. 9B, General VAS 2 cannot be concurrently enabled with General VAS 1+General VAS 2), both General VAS 1 and General VAS 2 are disabled, leaving only General VAS 2 and the native VAS concurrently enabled on the NMD.

The process illustrated in FIGS. 10A-10G reflects one example for explanation purposes only. As will be understood by one of ordinary skill in the art, the particular concurrency restrictions, prioritization rules, and implementations of enablement or disablement of particular VASes can take many forms.

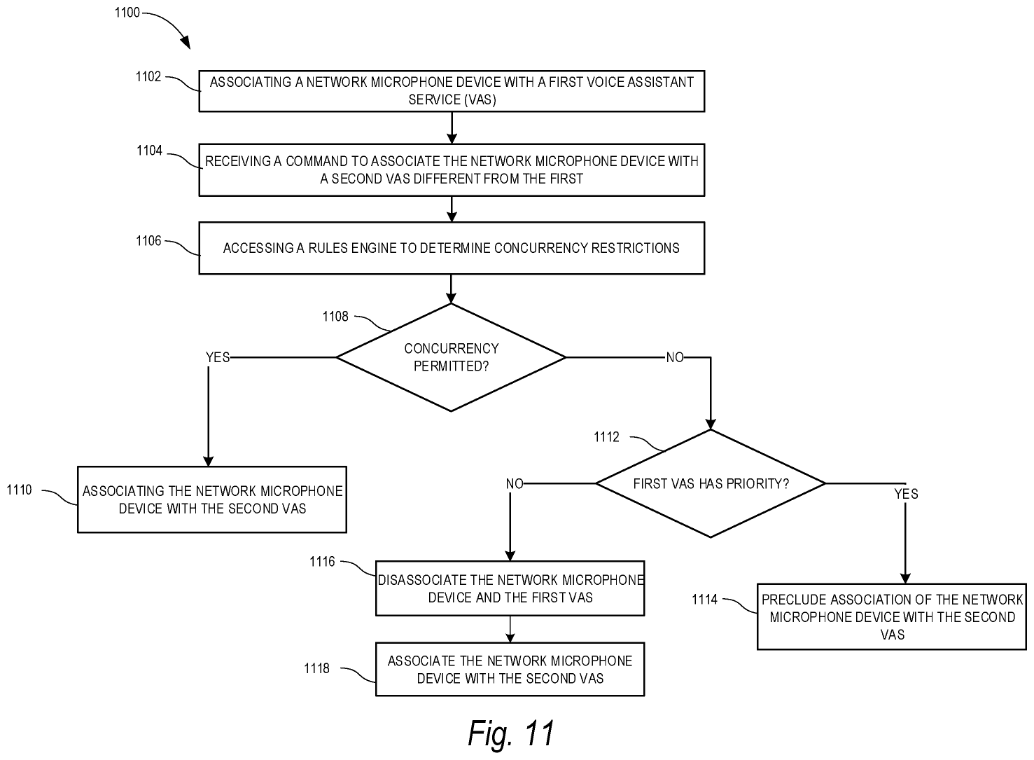

FIG. 11 is an example method 1100 for managing interactions between a network microphone device and multiple VASes. Various examples of method 1100 include one or more operations, functions, and actions illustrated by blocks 1102 through 1118. Although the blocks are illustrated in sequential order, these blocks may also be performed in parallel, and/or in a different order than the order disclosed and described herein. Also, the various blocks may be combined into fewer blocks, divided into additional blocks, and/or removed based upon a desired implementation.

Method 1100 begins at block 1102, which involves associating a network microphone device (NMD) with a first voice assistant service (VAS). Such association can include, for example, (i) downloading, installing, and/or software on the NMD to enable the NMD to operably communicate with the first VAS; and/or (ii) enabling a wake-word engine configured to detect one or more wake words associated with the first VAS such that the wake-word engine processes voice input captured by the NMD.

At block 1104, method 1100 involves receiving a command to associate the NMD with a second VAS different from the first. Such a command can be received, for example, over a network from a control device in response to a user selection. In one example, the first VAS can be an AMAZON VAS, and the second VAS can be a GOOGLE VAS. At block 1106, the method includes accessing a rules engine to determine concurrency restrictions. In various examples, the rules engine can include a set of rules, policies, or other restrictions (or criteria or algorithms for generating such rules or restrictions) that limit concurrent activation of certain VASes on a single NMD or among multiple NMDs within a single media playback system. The rules engine can be stored locally on the NMD or can be stored remotely and accessed via a network. In some examples, the NMD can transmit information to one or more remote computing devices (e.g., the identity of the first VAS, the second VAS, and any other relevant information), and the remote computing device(s) can access the rules engine and return any restrictions to the NMD via transmission over a network.

In decision block 1108, if concurrency is permitted, the method proceeds to block 1110 to associate the NMD with the second VAS. In this instance, there is no restriction with respect to concurrent activation of the first VAS and the second VAS, and so the NMD is permitted to concurrently activate both VASes.

If, in decision block 1108, concurrency is not permitted, the method proceeds to decision block 1112. If the first VAS has priority, then the method 1100 terminates in precluding associating of the NMD with the second VAS. For example, if the first VAS is a native VAS, a last-in VAS, or otherwise has priority over the second VAS, then the NMD maintains association with the first VAS and precludes association of the NMD with the second VAS. In some instances, an indication of this result can be output to the user, for example via graphical representation displayed on a control device, via audible output via the NMD or other device, or other such indication that the requested association of the second VAS has been precluded.

Returning to block 1112, if the first VAS does not have priority, then in block 1116 the NMD is disassociated from the first VAS, and in block 1118 the NMD is associated with the second VAS. Disassociating the first VAS can include, for example: (i) disabling, deactivating, or uninstalling software from the NMD that facilitates communication between the NMD and the first VAS: or (ii) disabling or deactivating one or more wake-word engines configured to detect wake word(s) associated with the first VAS. In some instances, an indication of this result can be output to the user, for example via graphical representation via a control device, audible output via the NMD or other device, or other such indication that the second VAS has been associated and the first VAS has been disabled or otherwise disassociated.

### IV. Example Processes and User Interfaces for Managing Concurrent Voice Assistant Services

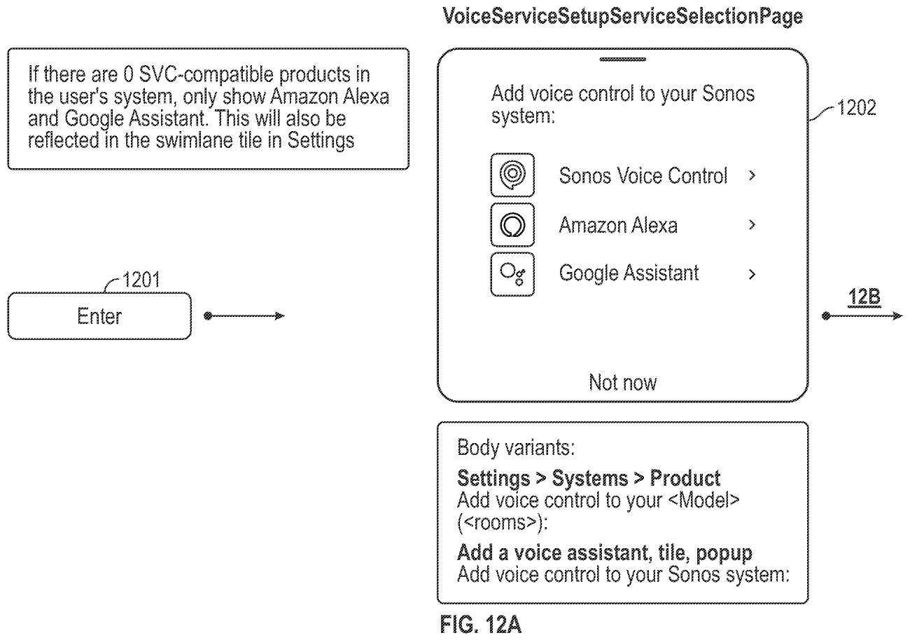

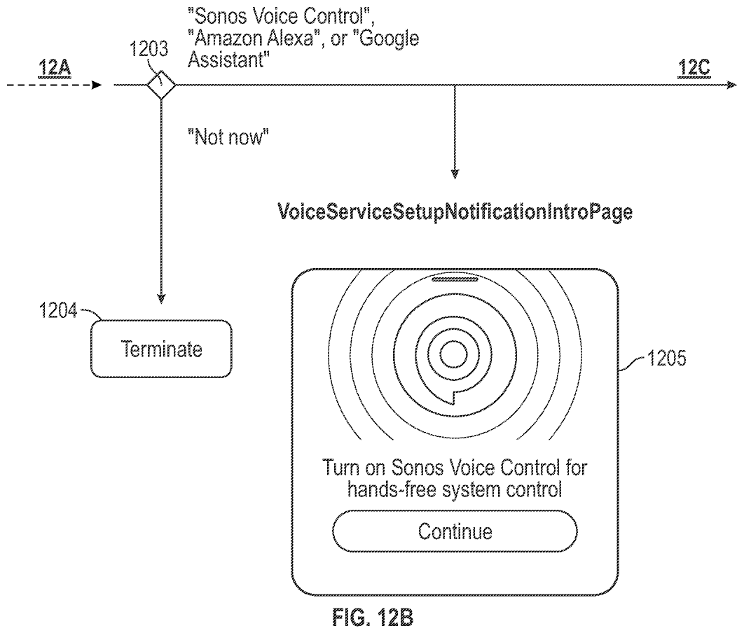

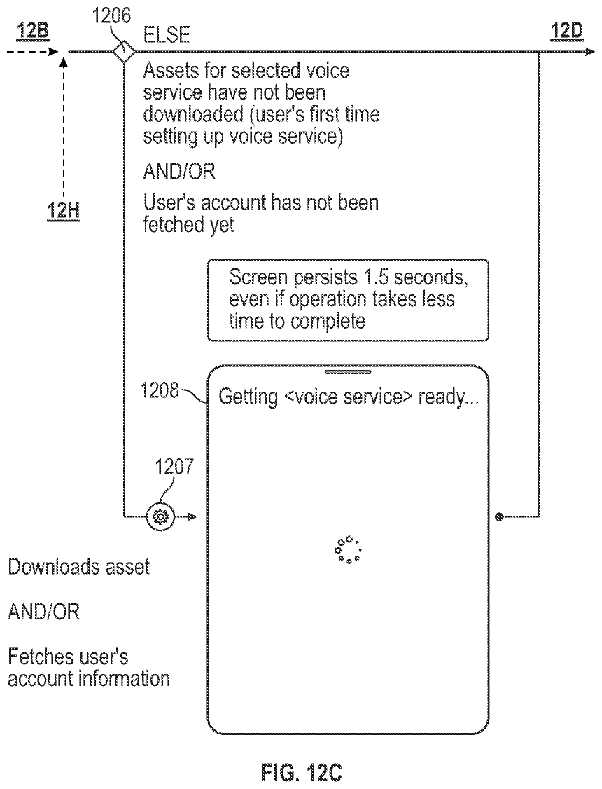

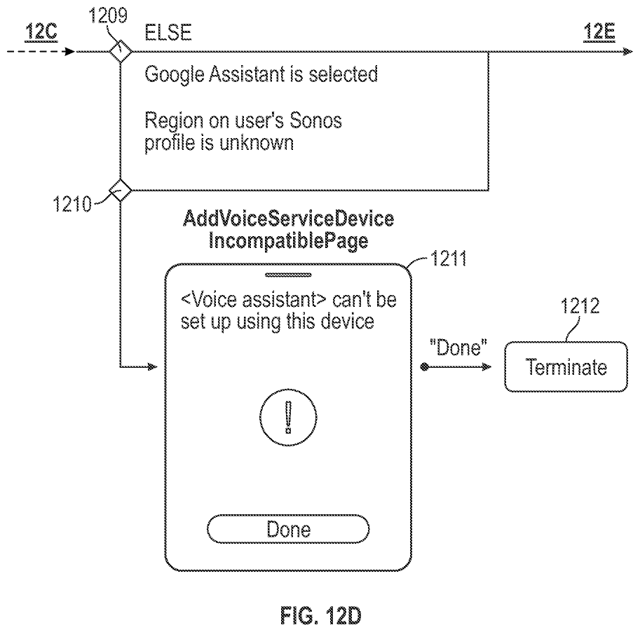

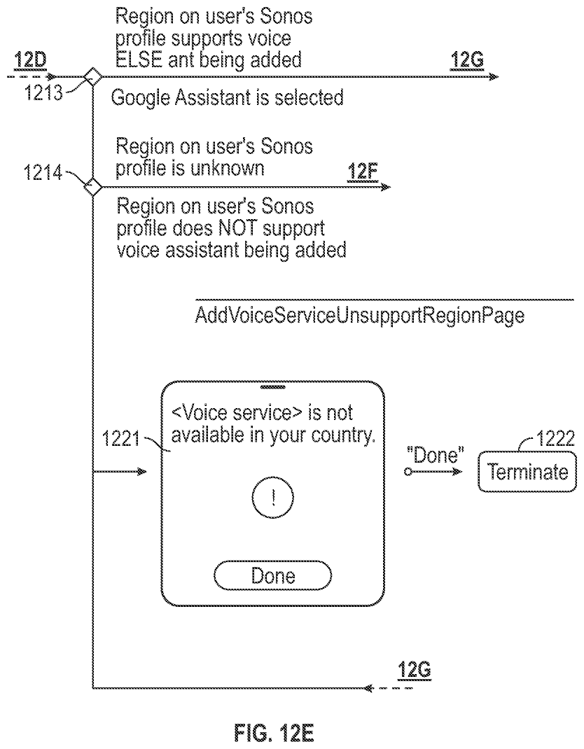

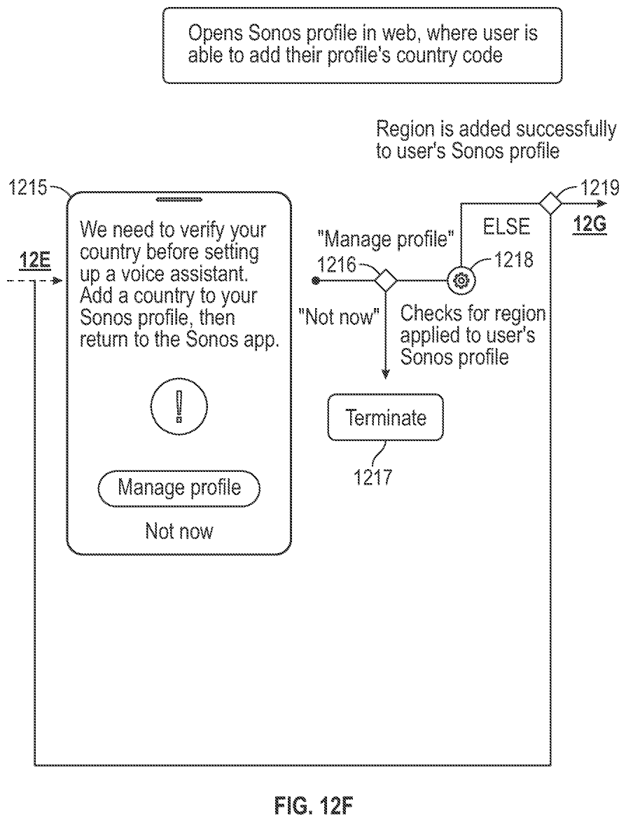

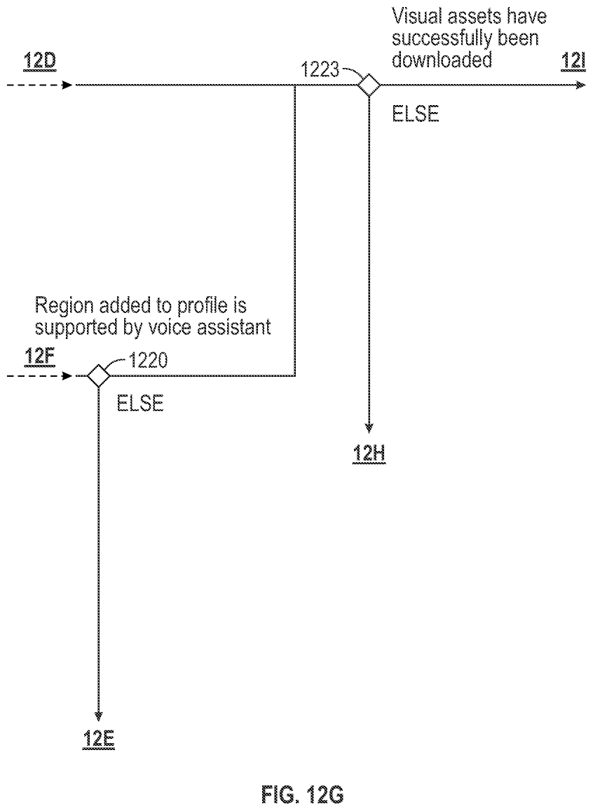

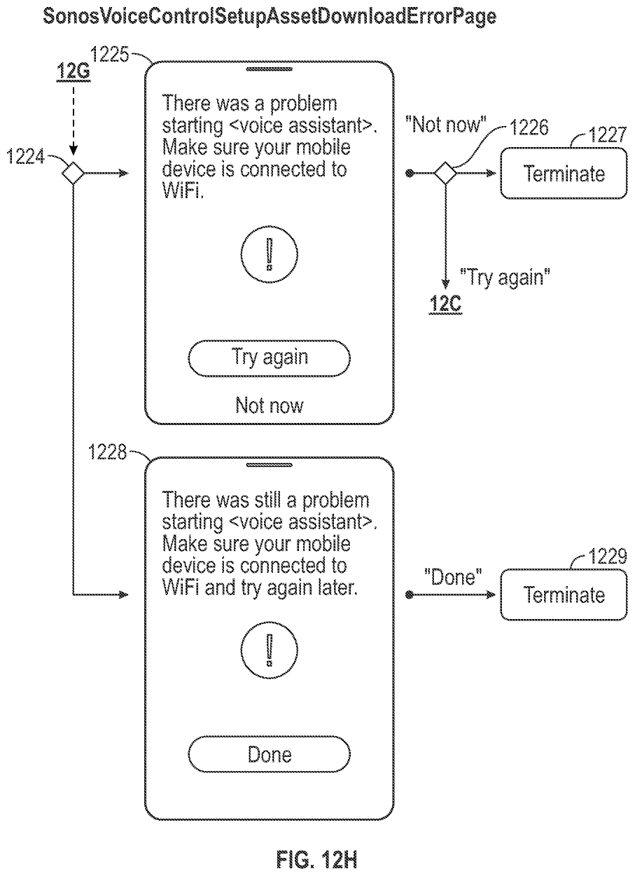

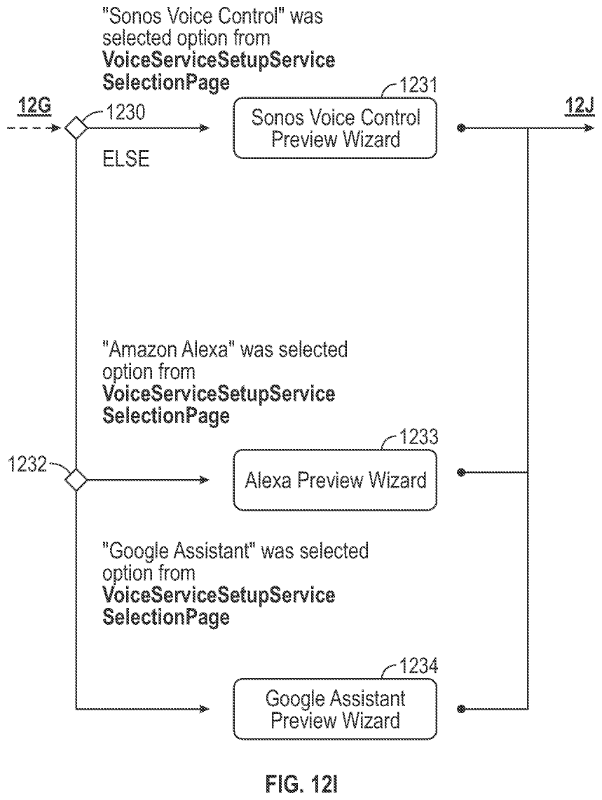

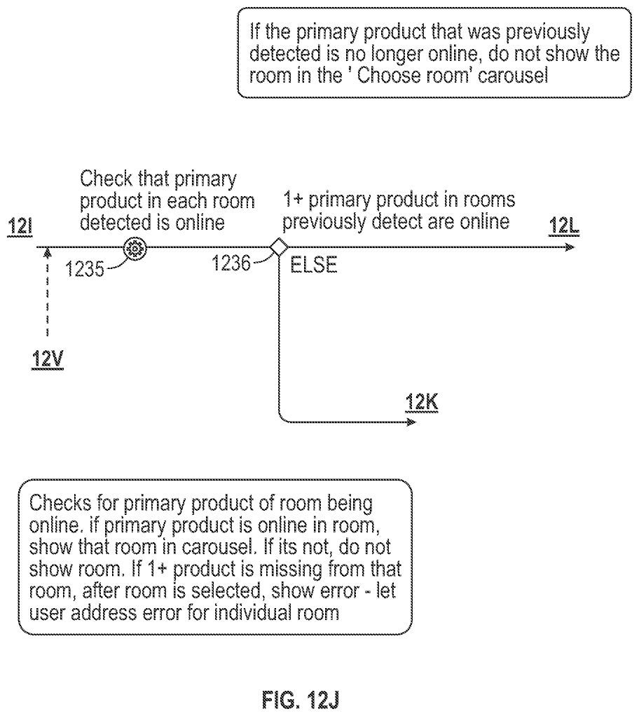

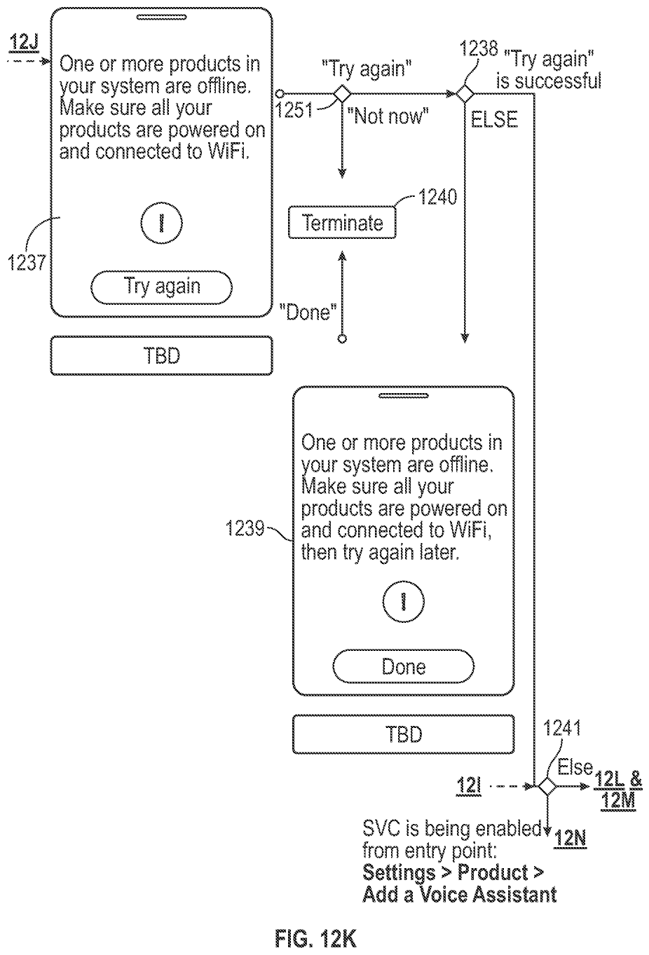

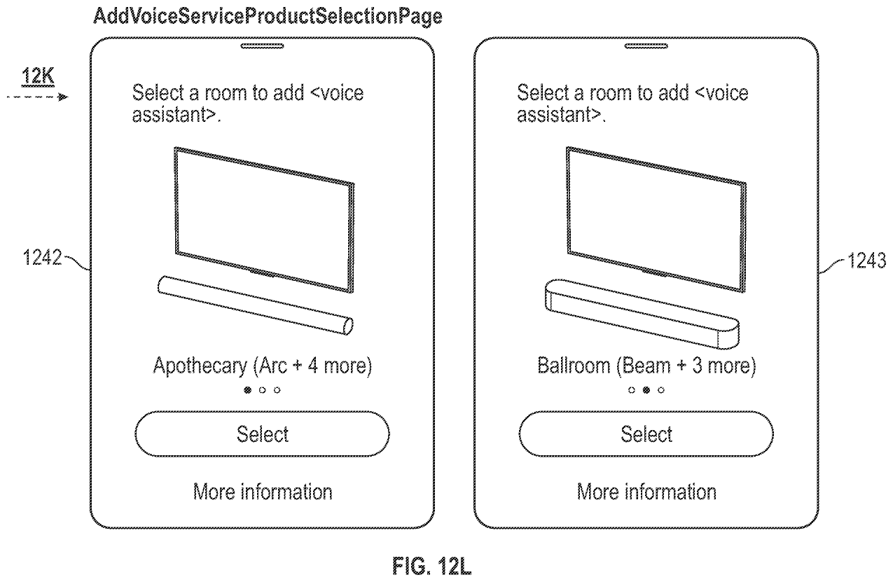

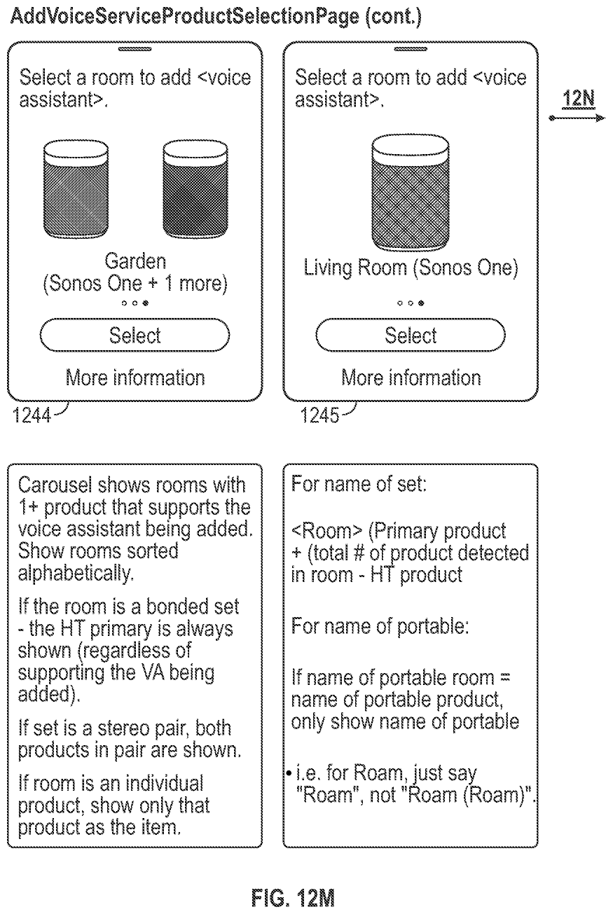

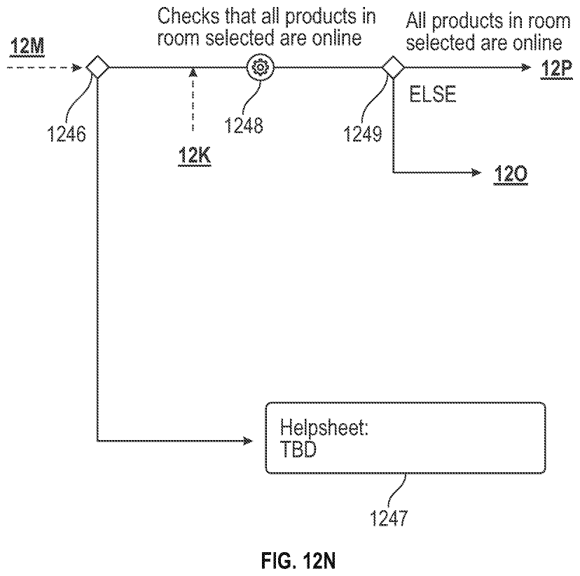

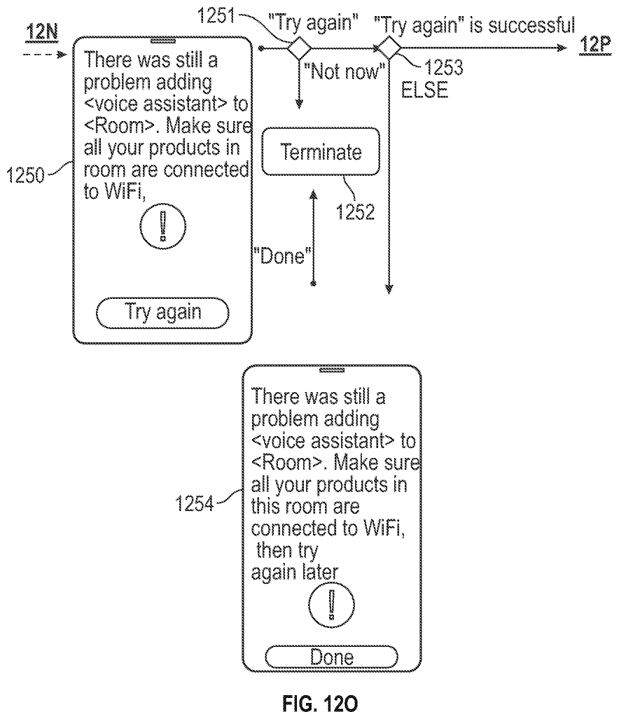

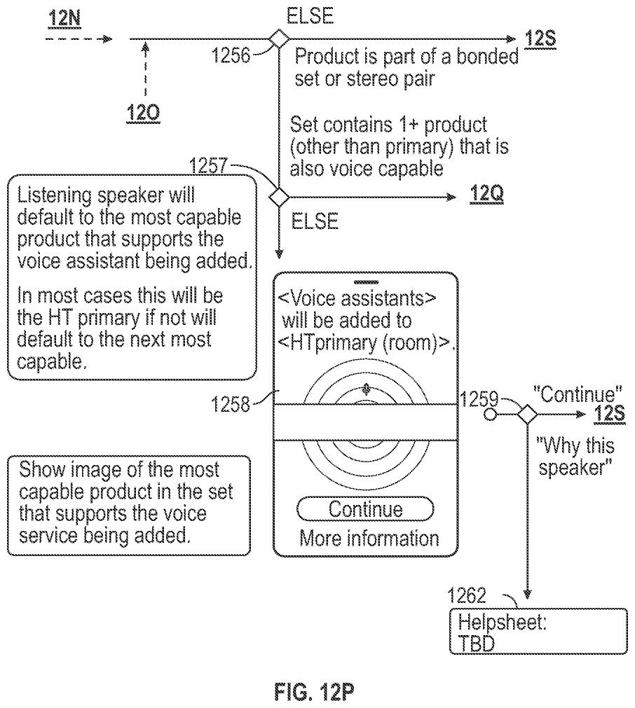

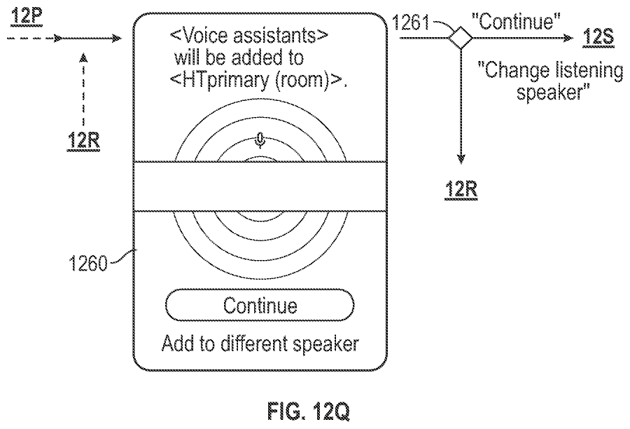

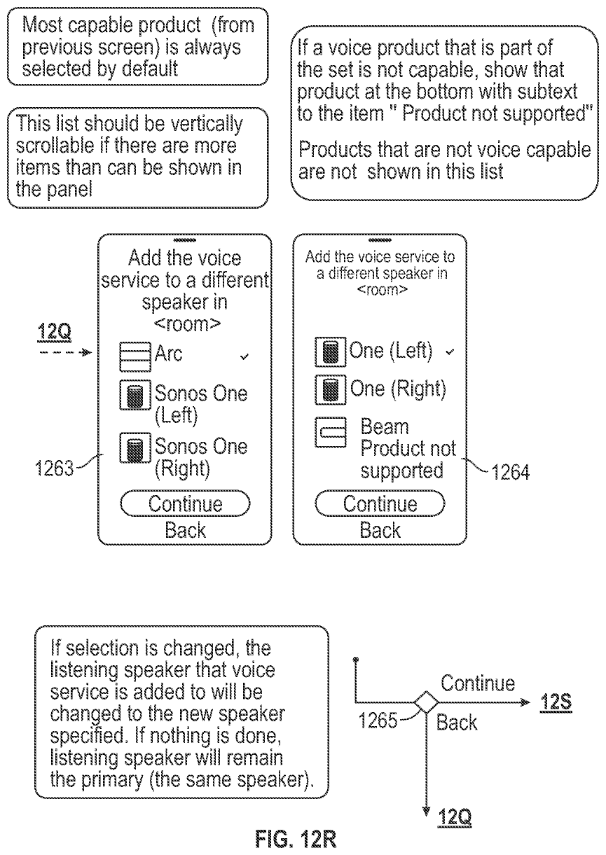

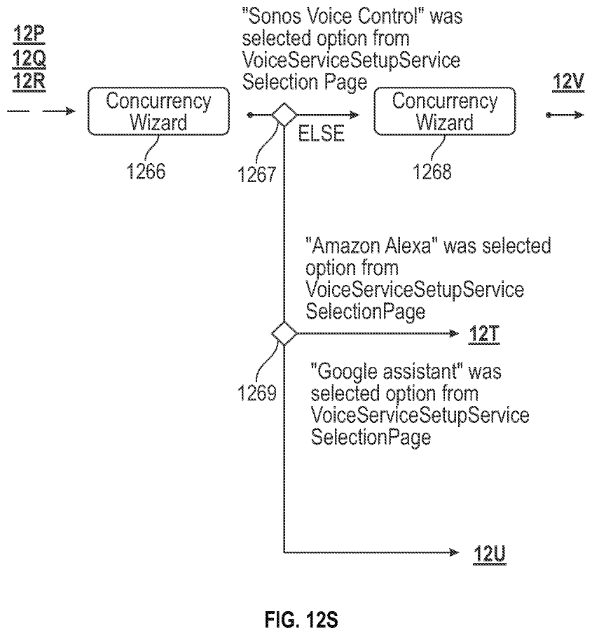

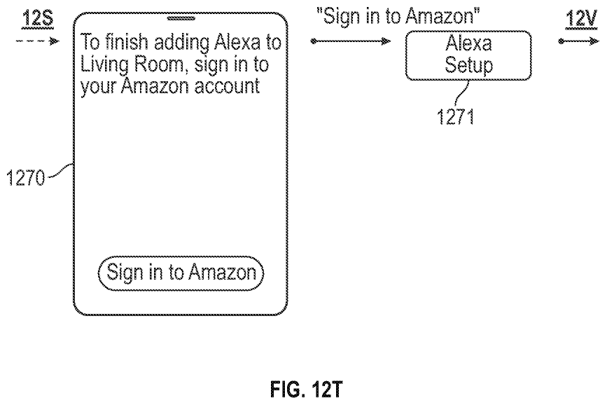

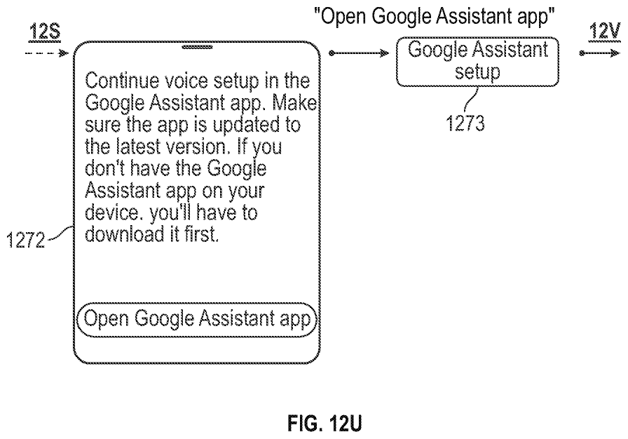

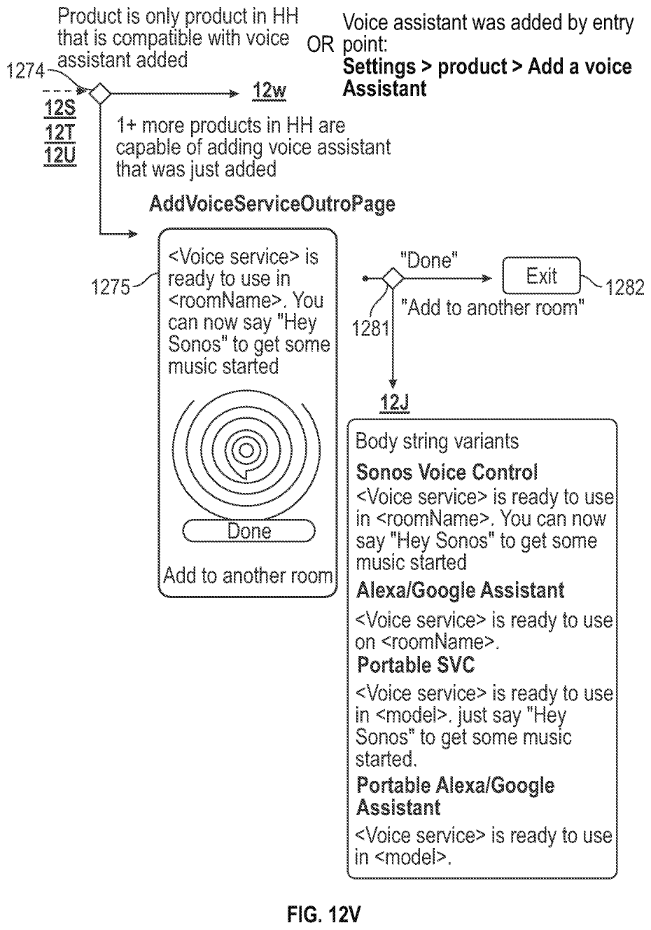

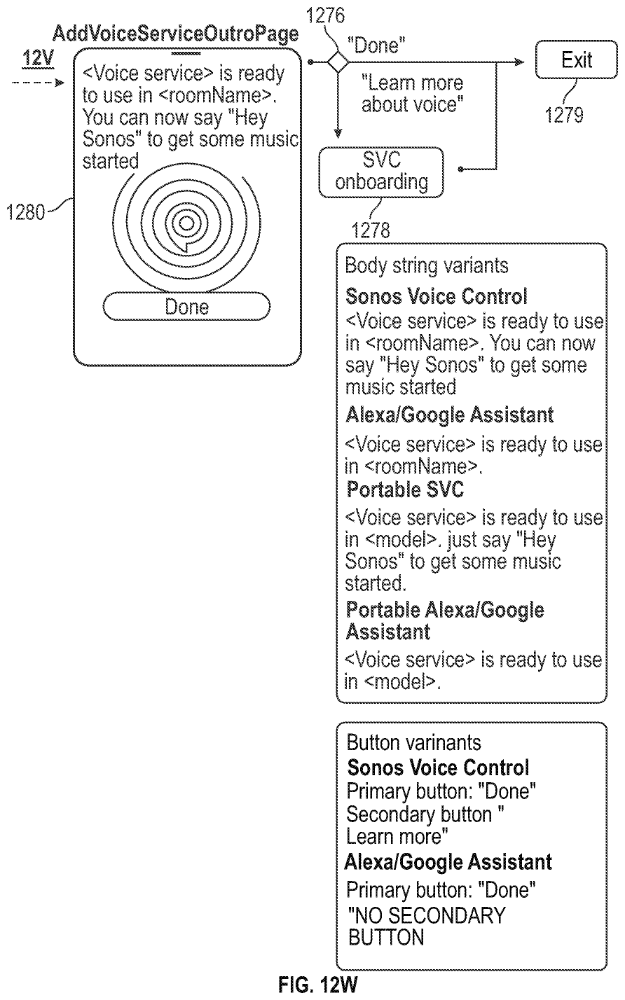

FIGS. 12A-15J illustrate example processes and associated user interfaces. These user interfaces can be displayed, for example, via a control device such as a smartphone, tablet, laptop, etc., or any other suitable device or display. In the examples illustrated here, the processes are divided among different figures, with labeled arrows indicating the relationship between the process diagrams on each sheet. For example, in FIG. 12A, the process continues as shown in FIG. 12B. This relationship is indicated by the arrow labeled 12B in FIG. 12A.

As used herein, the “system” can include any suitable component or combination of components of the media play back system 100 described above. For example, many aspects of the processes shown and described herein can be performed by an application running on a control device (e.g., a smartphone running an “app”). Additionally or alternatively, at least some aspects of these processes may be performed by other devices, such as remote computing devices (e.g., cloud-based servers) associated with the MPS 100 and/or other remote computing devices (e.g., remote computing devices associated with a VAS, such as the GOOGLE Assistant VAS, the AMAZON Alexa VAS, etc.).

FIGS. 12A-12W illustrate and example process and accompanying user interfaces for associating one or more playback devices with one or more voice assistant services (VASes). Referring to FIG. 12A, the process begins at stage 1201 with a user entering the VAS setup, which results with interface 1201 being displayed to the user. The interface 1202 provides the user with the option to add a specific VAS to the play back device. Through the interface 1202, the user may select one of the displayed VASes or may select “Not Now.”

After the user makes her selection, the process continues, as shown in FIG. 12B, to decision block 1203. At decision block 1203, if the user selects “Not Now,” the process continues to stage 1204 and terminates. If, at decision block 1203, the user selects one of the VASes (e.g., Sonos Voice Control, Amazon Alexa, or Google Assistant as shown in this example), the process continues. If the native VAS is selected (e.g., Sonos Voice Control in this example), then interface 1205 is displayed to a user, allowing the user to turn on the native VAS for hands-free system control by selecting “Continue” through the interface 1205.

As shown in FIG. 12C, if the user selects a non-native VAS, the process continues to decision block 1206. At decision block 1206, the system determines (A) if assets for the selected VAS have not been download to the control device and/or (B) if the user's account has not been fetched yet. If either option (A) and/or option (B) are true, the process continues to event 1207. If both option (A) and option (B) are false, the process continues as shown in FIG. 12D. At event 1207, the system downloads the asset(s) for the selected VAS and/or fetches the user's account information. As event 1207 occurs, the interface 1208 can be displayed, which displays to the user that the system is getting the VAS ready. After event 1207, the process can proceed as shown in FIG. 12D.

Referring to FIG. 12D, the process continues to decision block 1209. At decision block 1209, the system determines whether GOOGLE Assistant was selected by the user. If GOOGLE Assistant was selected by the user, the process continues to decision block 1210, otherwise, the process continues to FIG. 12E. At decision block 1210, the system determines whether the user's control device compatible with the GOOGLE Assistant. If the user's control device is not compatible (e.g., the control device is an AMAZON Kindle), the process displays the interface 1211, which displays that the VAS cannot be set up on the user's control device and provides the user with an option to select “Done” through the interface 1211. If the user selects “Done,” the process continues to stage 1212 and terminates.

As illustrated in FIG. 12E, the process continues to decision block 1213. At decision block 1213, the system determines whether the region on the user's profile supports a VAS being added. If the region does support a VAS being added, the process continues as shown in FIG. 12G, otherwise, the process continues to decision block 1214. At decision block 1214, the system determines whether the region on the user's profile is unknown, or if the region on the user's profile does not support the VAS being added. If the region is unknown, the process continues as shown in FIG. 12F. If the region does not support the VAS, the process continues with displaying the interface 1221. The interface 1221 shows that the VAS is not available in the user's region and provides the user with the option of selecting “Done” through the interface 1221. If the user selects “Done,” the process continues to stage 1222 and terminates.

Referring to FIG. 12F, the process next displays an interface 1215. The interface 1215 displays that the system needs to verify the user's region before setting up a VAS. The interface 1215 provides the user with an option to select “Manage Profile” or to select “Not Now” through the interface 1215. After the interface 1215 is displayed, the process continues to decision block 1216. If the user selected the “Not Now” option from the interface 1215, the process continues to the stage 1217 and terminates. If the user selected the “Manage Profile” option, the process continues to event 1218. At event 1218, the system checks for the region applied to the user's profile and then proceeds to decision block 1219. At decision block 1219, the system determines whether the region was added successfully to the user's profile.

As shown in FIG. 12G, if the region was added successfully, the process continues to decision block 1220, otherwise, the process continues to decision block 1230. At decision block 1220, the system determines whether the region added to the user's profile is supported by the VAS. If the region is supported by the VAS, the process continues to point D, otherwise, the process returns back to FIG. 12E with a user interface 1221 indicating that the particular VAS is not supported in the region. Referring back to FIG. 12G, the process continues with decision block 1223. At decision block 1223, the system determines whether the visual assets have been successfully downloaded, and if so, the process continues as shown in FIG. 12I.

If the visual assets have not been successfully downloaded, the process continues as shown in FIG. 12H to decision block 1224, in which the system determines whether the first error was encountered, or the second error was encountered. If the first error was encountered, the interface 1225 is displayed, which shows the user the there was a problem starting the VAS and to make sure that the user has the control device connected to the Wi-Fi. The interface 1225 provides the user with selecting the options “Try again” or “Not Now.” From the interface 1225, the process continues to decision block 1226. If the user selects “Not Now” from the interface 1225, the process continues to the stage 1227 and terminates. If the user selects “Try again,” the process returns to the process portion shown in FIG. 12C.

If, at decision block 1224, the second error was encountered, the process continues with displaying the interface 1228. The interface 1228 informs the user that there is still a problem starting the VAS and gives the user the option of selecting “Done.” If the user selects “Done,” the process continues to the stage 1229 and terminates.

As illustrated in FIG. 12I, the process continues to decision block 1230. At decision block 1230, the system determines whether the native VAS was selected. If the native VAS was selected, the process continues to the stage 1231 with the native VAS Preview Wizard. Otherwise, the process continues to decision block 1232. At decision block 1232, the process determines whether AMAZON Alexa was selected or if GOOGLE Assistant VAS selected. If AMAZON Alexa was selected, the process continues to the stage 1233 with the AMAZON Alexa Preview Wizard. If GOOGLE Assistant was selected, the process continues to the stage 1234 with the GOOGLE Assistant Preview Wizard.

Referring to FIG. 12J, the process continues to the event 1235 where the system checks that the primary playback device in each room detected is online. Next, the process continues to decision block 1236, where the system determines whether the one or more primary playback devices in the rooms previously detected are online. If the one or more primary playback devices in the rooms previously detected are online, the process continues as shown in FIG. 12L, otherwise the process continues to FIG. 12K.

As shown in FIG. 12K, an interface 1237 is presented that informs the user that one or more playback devices in the user's systems are offline and tells the user to make sure the playback devices are powered on and connected to the Wi-Fi. The interface 1237 also provides the user with the option of selecting “Try again” at decision block 1251. If the user selects “Not now,” the process terminates at stage 1240. If the user selects “Try again,” the process continues to decision block 1238. If, at decision block 1238, the “Try again” function was unsuccessful, the process displays the interface 1239. The interface 1239 informs the user that one or more playback devices in the user's system are offline and that the user should try again later. The interface provides the user with the option to select “Done.” If the user selects “Done,” the process continues to stage 1240 and terminates.

If, at decision block 1238, the “Try again” action function is successful, the process continues to decision block 1241. At decision block 1241, the system determines whether the native VAS is being enabled from a particular entry point (e.g., a user selecting Settings>Product>Add a Voice Assistant). If the native VAS is being enabled from the entry point, the process continues as shown in FIG. 12N, otherwise, the process displays one or more of the interfaces 1242, 1243, 1244, 1245 shown in FIGS. 12L and 12M. The interfaces 1242, 1243, 1244, 1245 display to the user one or more rooms for the user to select to add a VAS and provide the user with an option to select a particular room or to ask for more information.

In FIG. 12N, after one or more of the interfaces 1242, 1243, 1244, 1245 are displayed, the process continues to decision block 1246, where the system determines whether the user selected a particular room, or if the user asked for more information. If the user asked for more information, the stage 1247 is initiated, and a help sheet is displayed.

With continued reference to FIG. 12N, the process continues with event 1248. At event 1248, the system checks that all play back devices in the selected room are online and then the process continues to decision block 1249. At decision block 1249, the system determines whether all the playback devices in the selected room are online. If the play back devices in the selected room are online, the process continues as shown in FIG. 12P, otherwise the process continues as shown in FIG. 12O.

As illustrated in FIG. 12O, responsive to determining that at least some play back devices are not online, the interface 1250 is displayed. The interface 1250 shows that there was a problem adding a VAS to the selected room and provides the user with the option of selecting “Try again.” The process then proceeds to decision block 1251. At decision block 1251, the interface 1250 determines whether the user selected “Try again,” and if the user did select this option, the process continues to decision block 1253. If the user did not select the “Try again” option, the process continues to stage 1252 and terminates.

If, in decision block 1253, the “Try again” function was successful, the process continues as shown in FIG. 12P. Otherwise, the process displays the interface 1254, which informs the user that there was still a problem adding the VAS to the selected room and tells the user to try again at a later time. The interface 1254 provides the user with the option of selecting “Done.” If the user selects “Done,” the process continues to the stage 1252 and terminates.

As illustrated in FIG. 12P, the process continues to decision block 1256, where the system determines whether the play back device in the selected room is part of a bonded set or stereo pair. If the playback devices are not part of a bonded set or stereo pair, the process continues as shown in FIG. 12S, otherwise the process continues to decision block 1257. At decision block 1257, the system determines whether the bonded set playback device and/or stereo pair playback device contains one or more playback devices, other than a primary play back device, that is VAS capable. If not, the process continues as shown in FIG. 12Q. Otherwise, the process continues with displaying the interface 1258. The interface 1258 informs the user that the VAS will be added to the selected room and prompts the user to select the option “Continue” or “Add to different speaker.” The process continues from the interface 1258 to decision block 1259, where the system determines whether the user selected “Continue” or “More information.” If the user selected “Continue,” the process continues as shown in FIG. 12S. If the user selected “More information,” the process continues present the help sheet

Referring to FIG. 12Q, the process continues with displaying the interface 1260. The interface 1260 shows the user that the VAS will be added to the selected room and prompts the user to select “Continue” or “Add to different speaker.” After the interface 1260 is displayed, the process continues to decision block 1261, where the system determines whether the user selected “Continue” or “More information.” If the user selected “Continue,” the process continues as shown in FIG. 12S. If the user selected “Add to different speaker,” the process continues as shown in FIG. 12R.

As illustrated in FIG. 12R, the process continues with displaying one or more of the interfaces 1263, 1264. The interfaces 1263, 1264 ask the user to select a different play back device within the room to add the VAS to, provide a list of the playback devices to select, and prompt the user with the options to “Continue” once a play back device from the list has been selected, or to go “Back.” After one or more of the interfaces 1263, 1264 are displayed, the process continues to decision block 1265. At decision block 1265, if the user selected “Continue,” the process continues as shown in FIG. 12S. If the user selected “Back,” the process returns to the process portion shown in FIG. 12Q.

Referring to FIG. 12S, the process continues with the stage 1266. At stage 1266, the Concurrency Wizard program is run, after which the process continues to decision block 1267. At decision block 1267, the system determines whether the native VAS was selected from the VAS selection page. If the native VAS was not selected, the process continues to decision block 1269. If the native VAS was selected, the process continues to the stage 1268 with setting up the native VAS. After the native VAS setup is complete, the process continues as shown in FIG. 12V.

At decision block 1269, the system determines whether the AMAZON Alexa was selected from the VAS selection page or if the GOOGLE Assistant was selected from the VAS selection page. If AMAZON Alexa was selected, the process continues as shown in FIG. 12T with displaying to interface 1270. The interface 1270 displays to the user that to finish adding AMAZON Alexa to the selected play back device, the user will need to sign in to her AMAZON Account, and displays a prompt to sign in to AMAZON. If the user selects to sign in to her AMAZON Account, the process continues to the stage 1271 with the AMAZON Alexa setup and then continues as shown in FIG. 12V after the setup. If GOOGLE Assistant was selected, the process continues as shown in FIG. 12V

Referring back to FIG. 12S, if, in decision block 1269, GOOGLE Assistant is selected, the process continues as shown in FIG. 12U with displaying the interface 1272. The interface 1272 displays to the user that to finish adding GOOGLE Assistant to the selected play back device, the user will need to finish the setup in the GOOGLE Assistant App. In some examples, the interface 1272 can display a prompt to open the GOOGLE Assistant App. If the user selects to open the GOOGLE Assistant App, the process continues to the stage 1273 with the GOOGLE Assistant setup and then continues as shown in FIG. 12V.

As illustrated in FIG. 12V, the process continues with decision block 1274, at which the system determines (A) whether the selected playback device is the only playback device that is compatible with the added VAS or (B) whether the VAS was added by a particular entry point. If either option (A) or (B) are true, the process continues as shown in FIG. 12W. If, in decision block 1274, one or more products in the household are capable of adding the VAS that was selected by the user, then the process presents interface 1275, which shows the user that the VAS is ready to use in the selected room and prompts the user to select “Done” or “Add to another room.” The process then proceeds to decision block 1281, where the system determines whether the user selected “Done” or “Add to another room.” If the user selected “Add to another room,” the process returns to the process portion shown in FIG. 12J. If the user selected “Done,” the process continues to stage 1282 and exits.

With reference to FIG. 12W, the process continues with displaying the interface 1280. The interface 1280 informs the user that the VAS is ready to use in the selected room and prompts the user to select “Done” or “Learn More.” The process then proceeds to decision block 1276, where the system determines whether the user selected “Done” or “Learn More.” If the user selected “Done,” the process continues to stage 1279 and exits. If the user selected “Learn More,” the process continues with the stage 1278, which runs a native VAS Onboarding program, and then to the stage 1279 and exits.

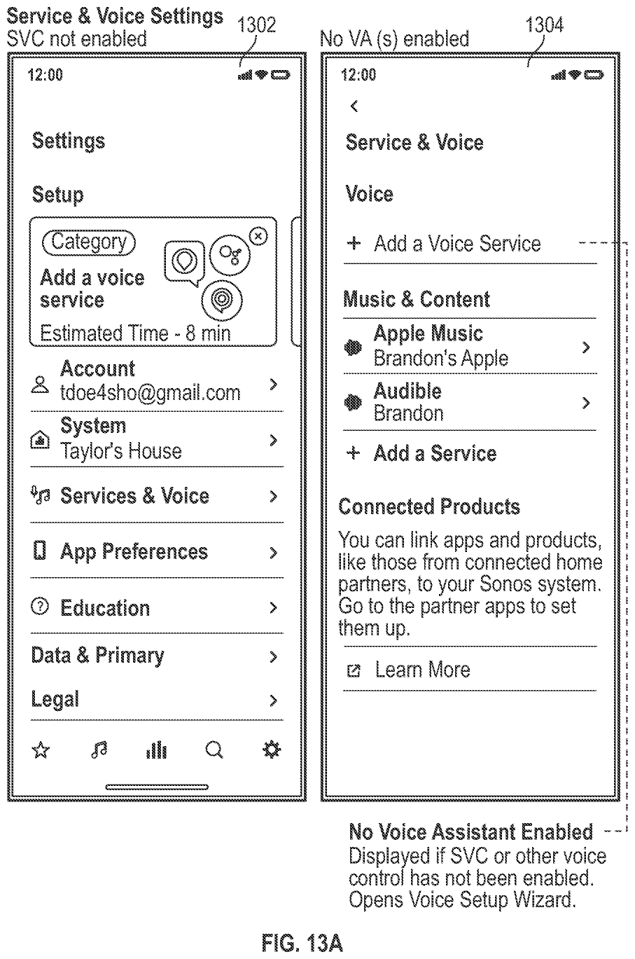

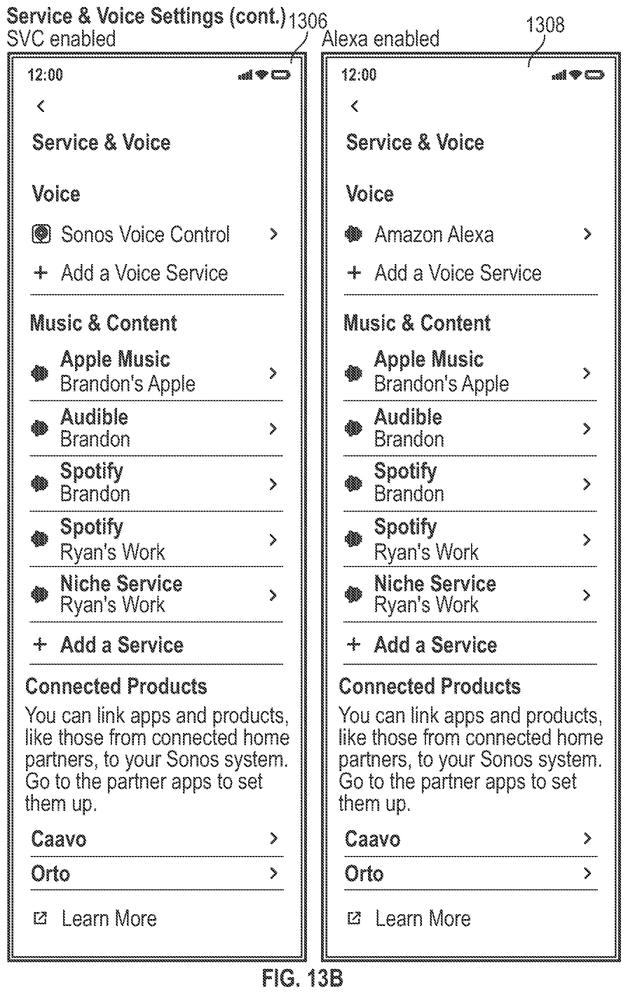

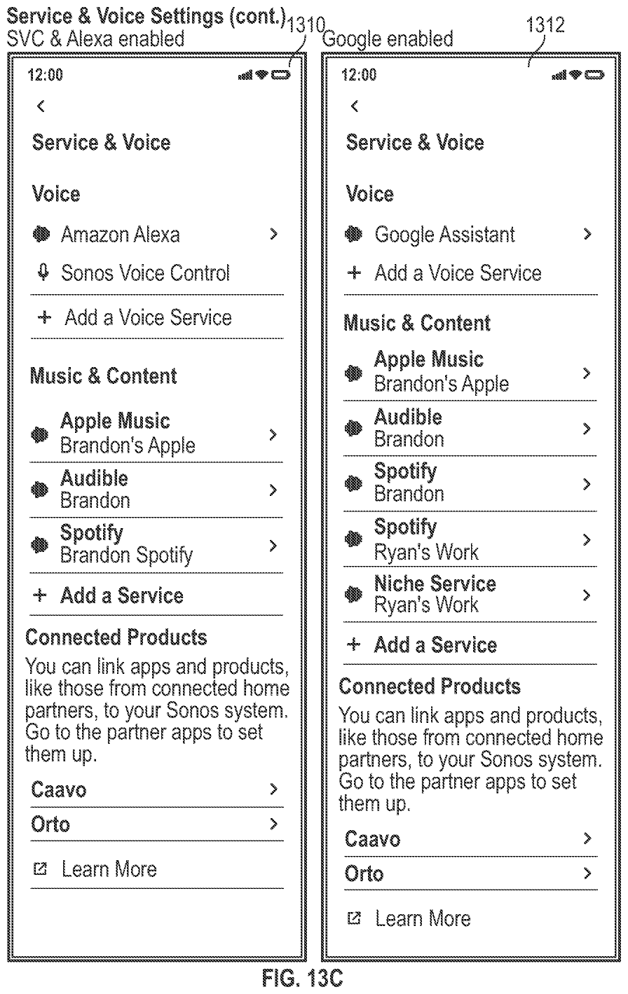

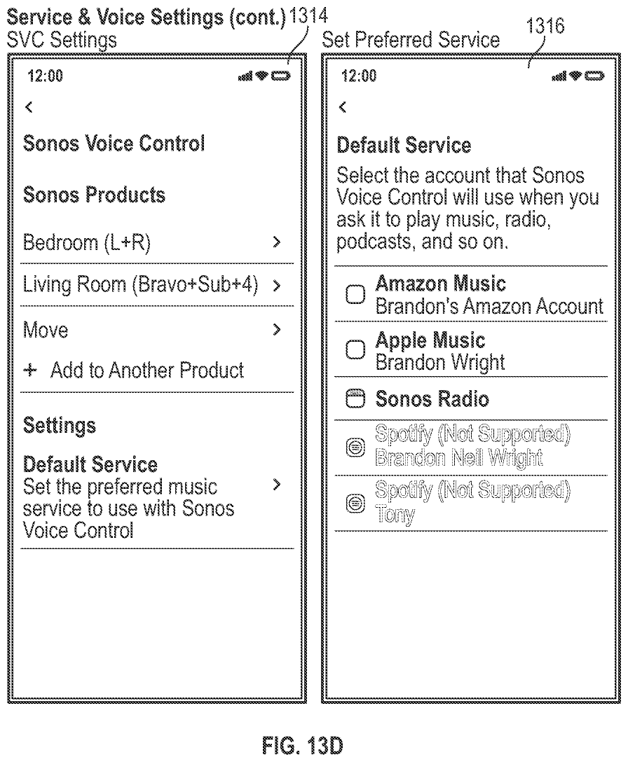

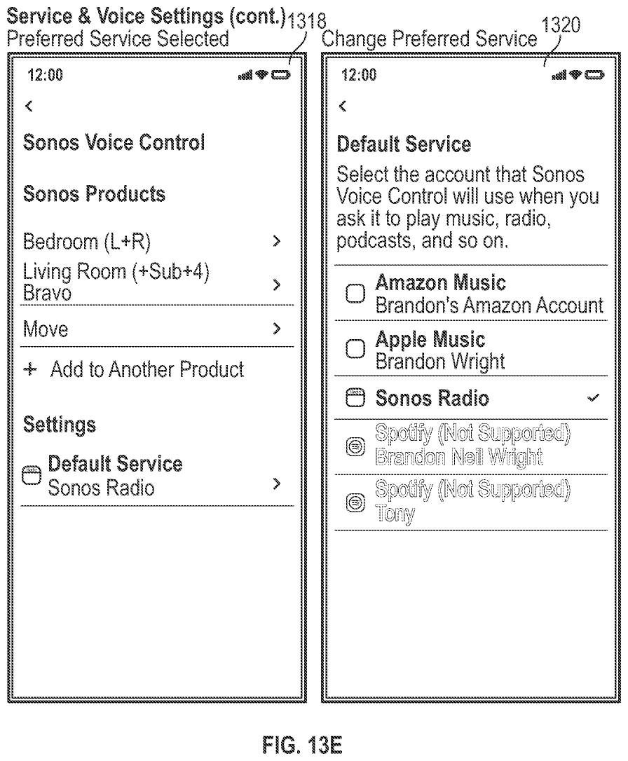

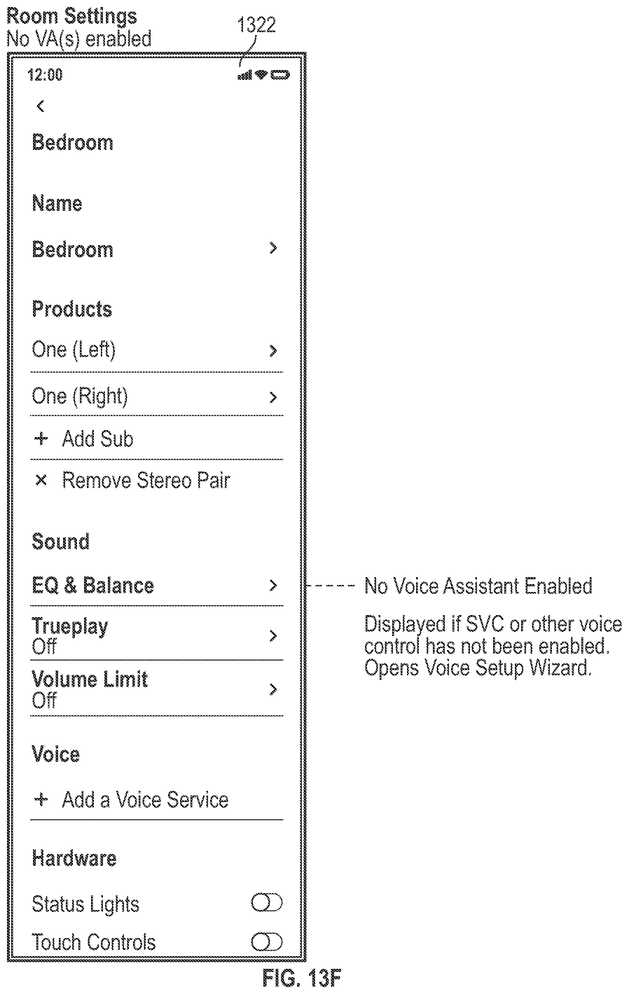

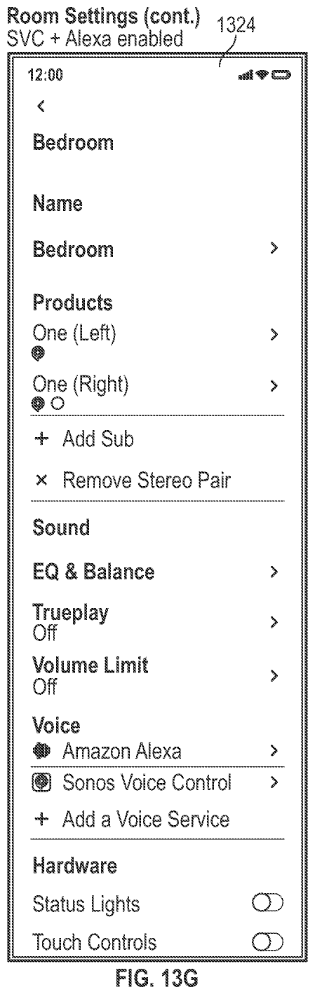

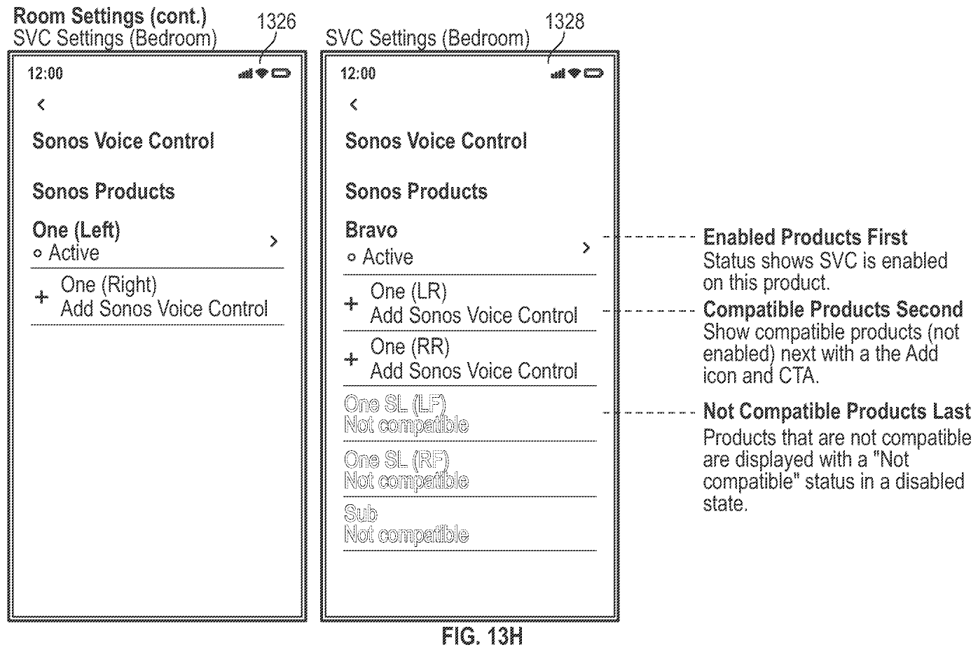

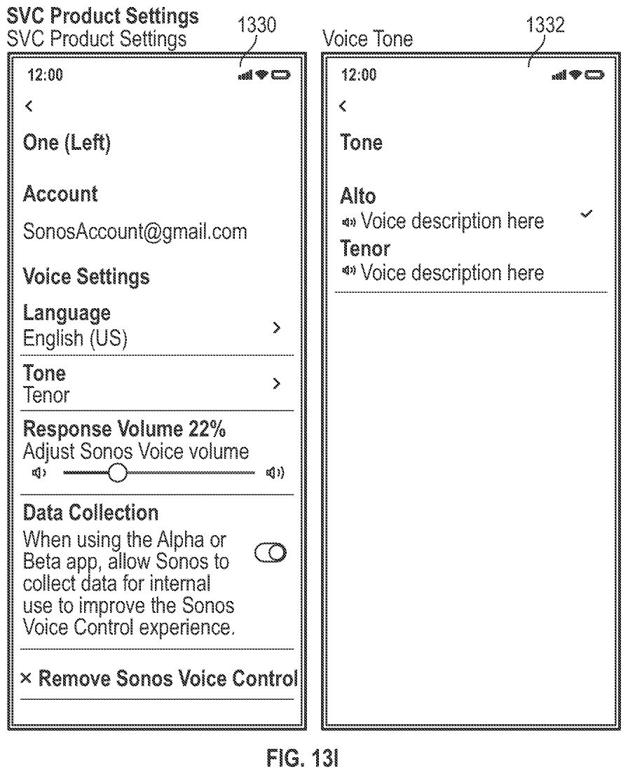

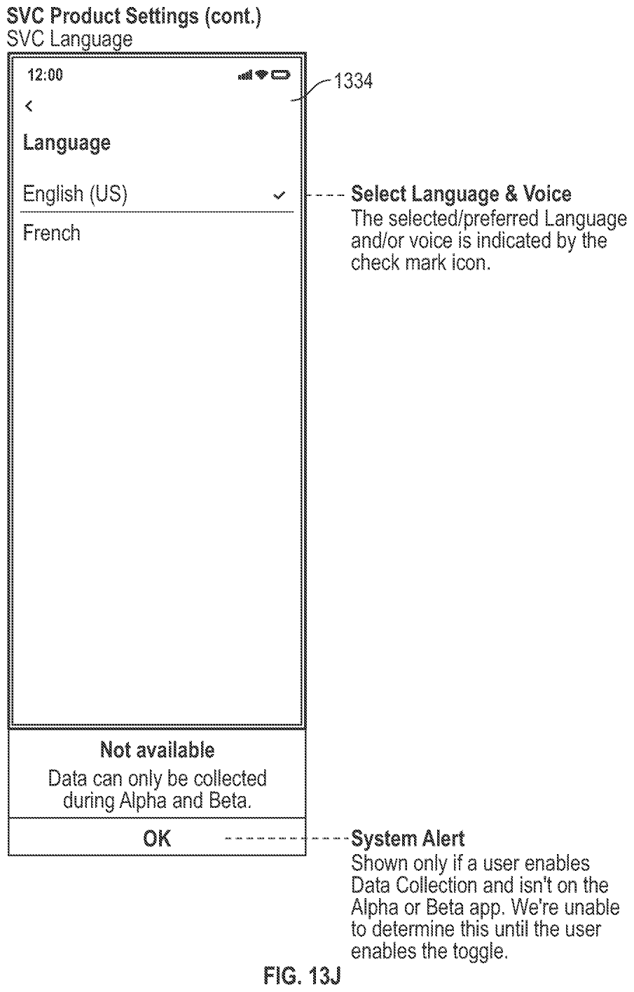

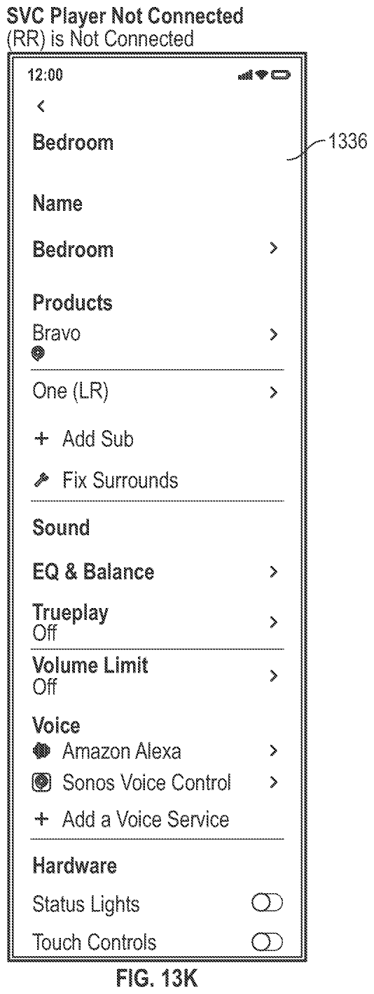

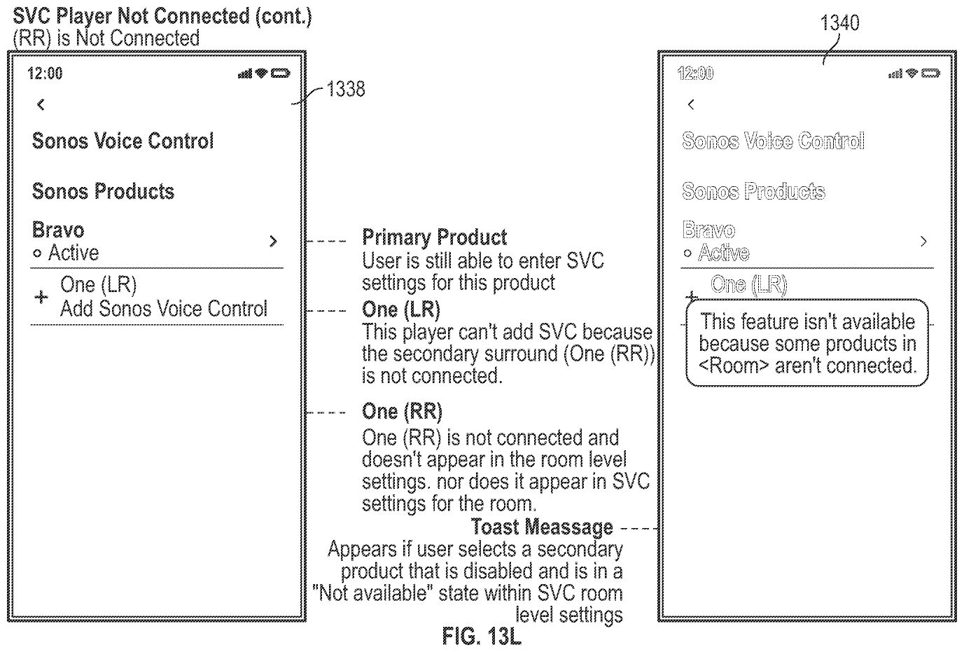

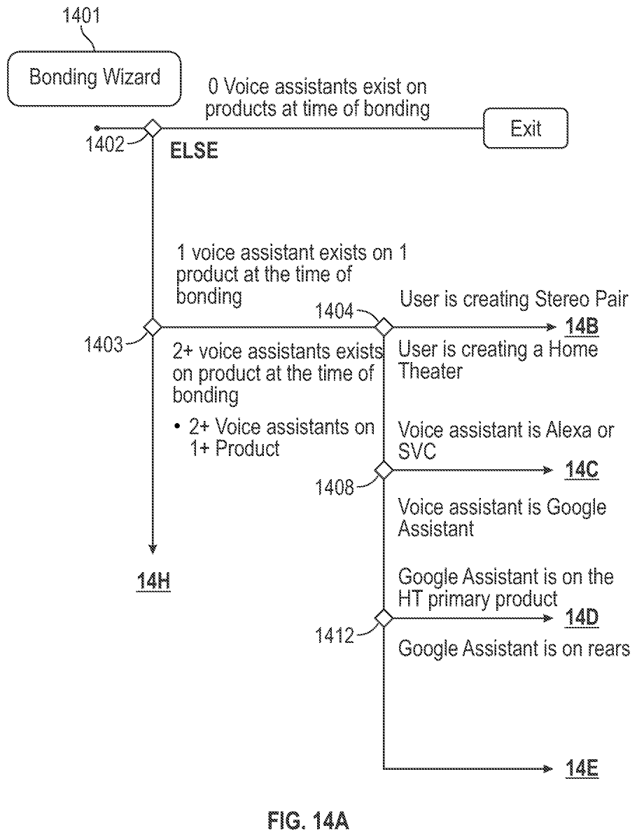

FIGS. 13A-13L illustrate example interfaces for displaying and modifying settings associated with a native VAS (e.g., Sonos Voice Control or SVC for a Sonos-branded play back device). As shown in FIG. 13A, interface 1302 illustrates an example settings menu for a system in which the native VAS is not enabled. The interface 1304 illustrates the settings menu when no VASes are enabled. Referring to FIG. 13B, interface 1306 illustrates an example services and voice menu where the native VAS is enabled on the playback device. The interface 1308 illustrates an example services and voice menu where AMAZON Alexa is enabled on the play back device.

FIG. 13C shows interface 1310, which is an example services and voice menu in which the native VAS and AMAZON Alexa are enabled on the playback device. The interface 1312 illustrates an example services and voice menu in which GOOGLE Assistant is enabled on the playback device. FIG. 13D illustrates several example interfaces that display different setting menus. The interface 1314 illustrates the native VAS settings menu for voice control. The interface 1316 illustrates the default service menu for setting a preferred service. With reference to FIG. 13E, the interface 1318 illustrates the voice control menu for with a preferred service selected. The interface 1320 illustrates the default service menu for changing the preferred service.

FIG. 13F-13H illustrate several example interfaces that display the settings for a particular room. The interface 1322 illustrates the room settings with no VAS enabled on the playback device. The interface 1324 illustrates the room settings with the native VAS and AMAZON Alexa enabled on the play back device. The interface 1326 illustrates a voice control menu that highlights which playback device has a VAS enabled. The interface 1328 illustrates a voice control menu that highlights which playback device has a VAS enabled and which devices are not compatible.

FIGS. 13I and 13J illustrate several example interfaces that display different settings menus. The interface 1330 illustrates the product settings for a native VAS. The interface 1332 illustrates the voice tone settings. The interface 1334 illustrates the language options menu.

FIGS. 13K and 13L illustrate additional example interfaces that display different settings menus. The interface 1336 illustrates a settings menu where a particular playback device is not connected. As shown, an option to “Fix Surrounds” is presented. The interface 1338 illustrates a settings menu in which one of the playback devices cannot add a native VAS because a playback device is not connected. The interface 1340 illustrates a message that is provided when a user selects an unavailable feature because a play back device is not connected.

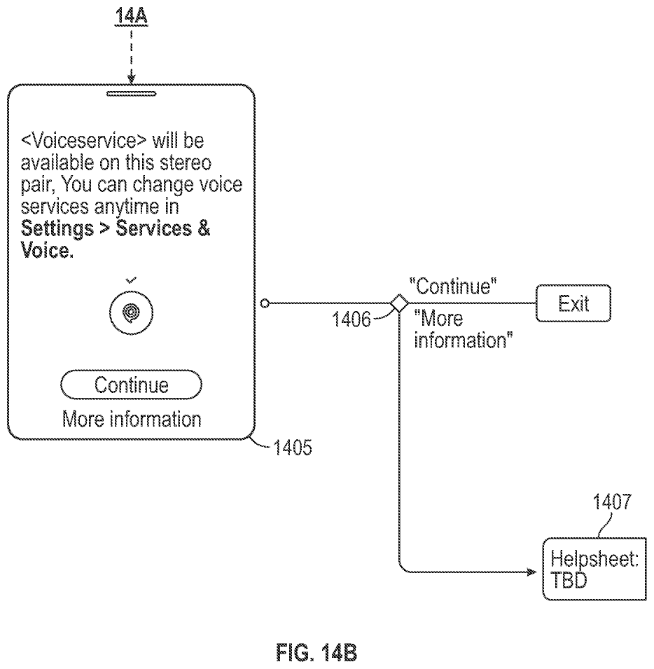

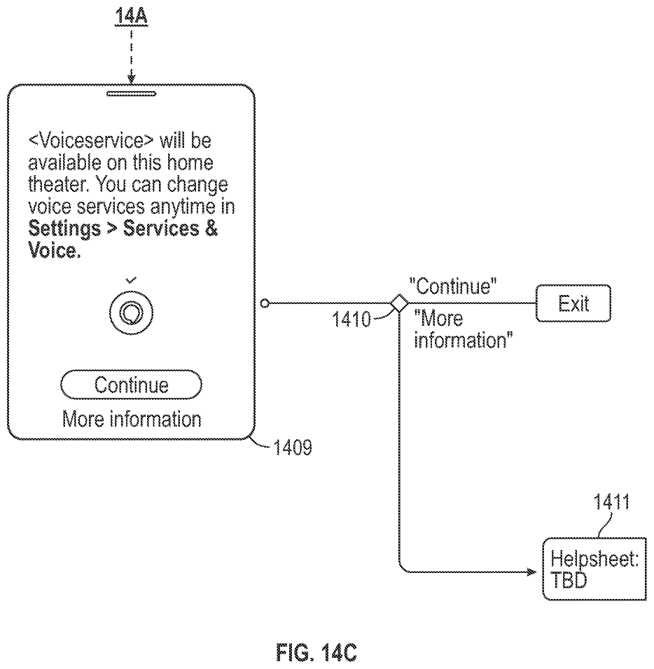

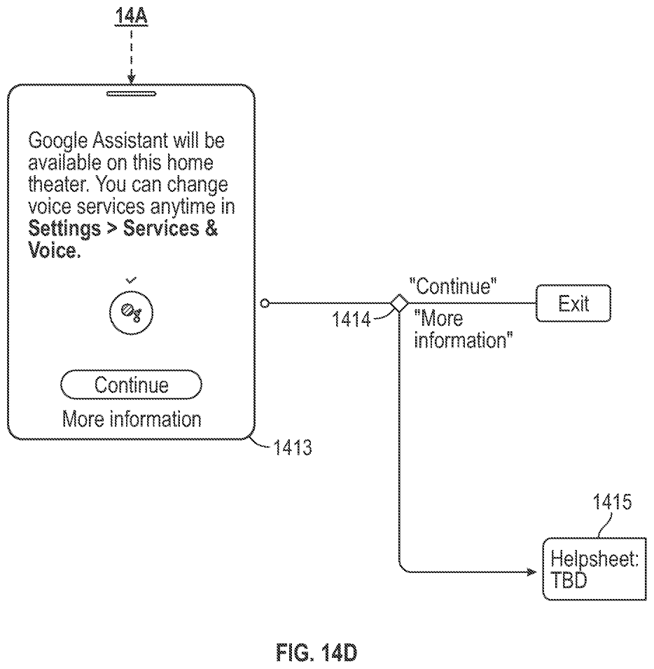

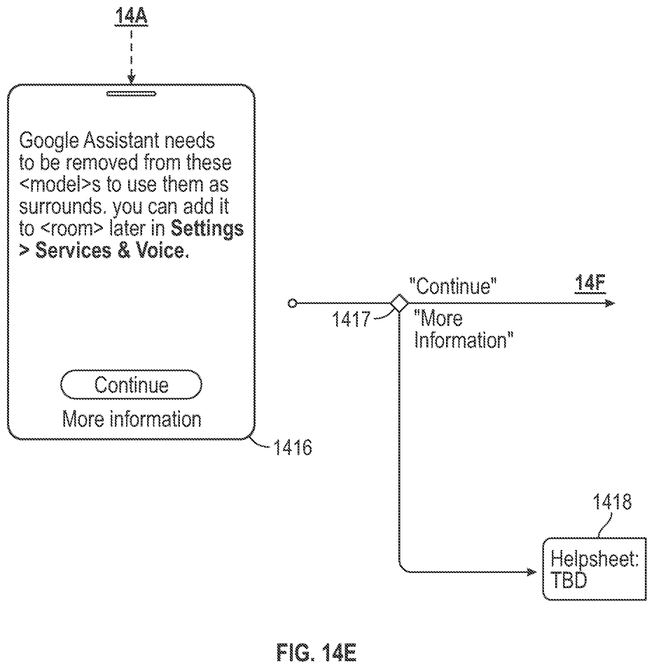

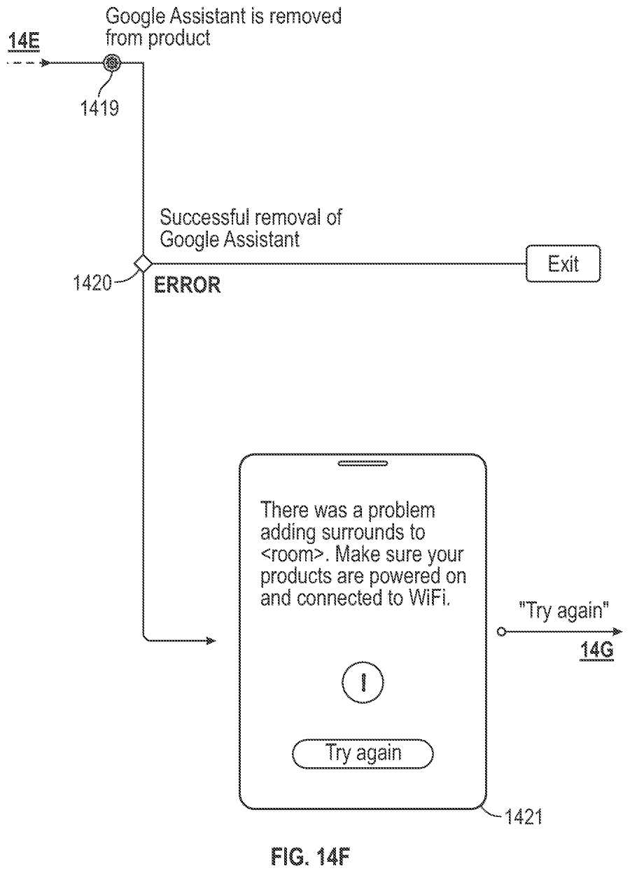

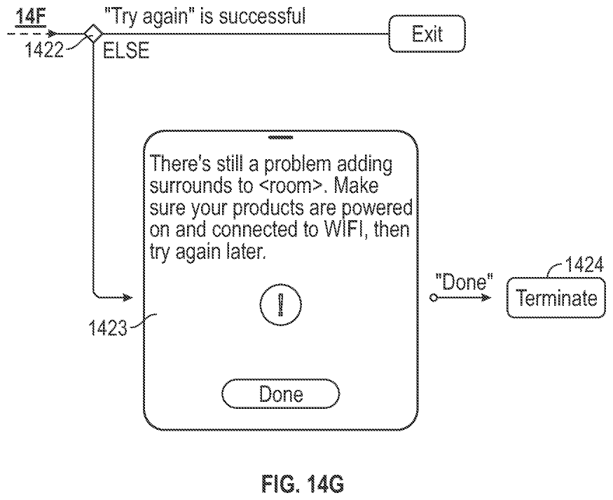

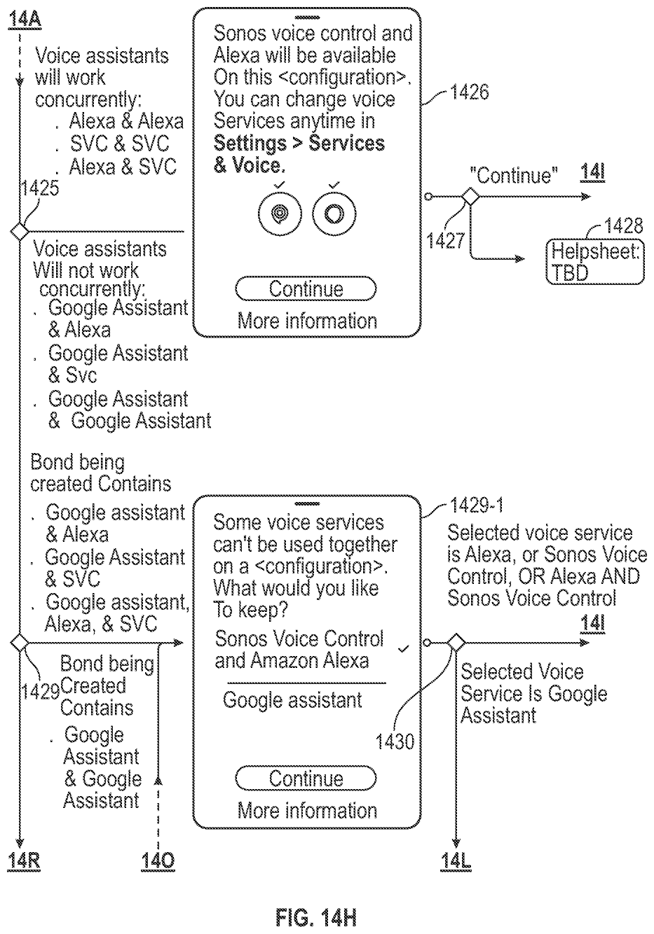

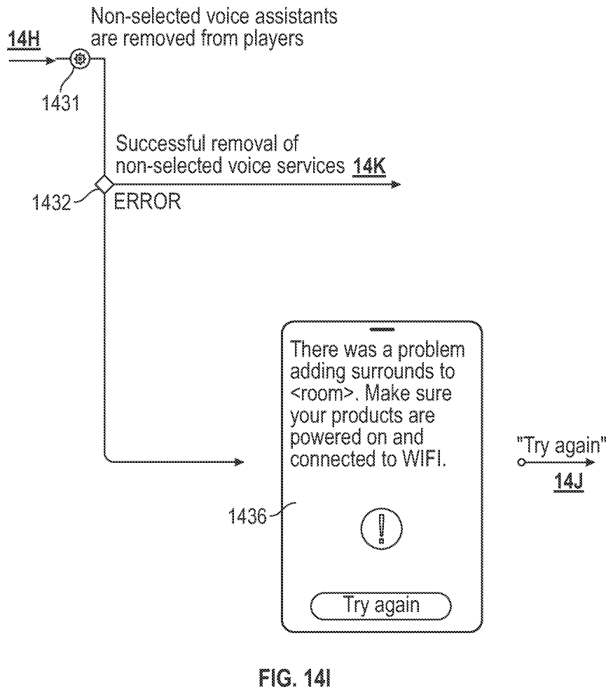

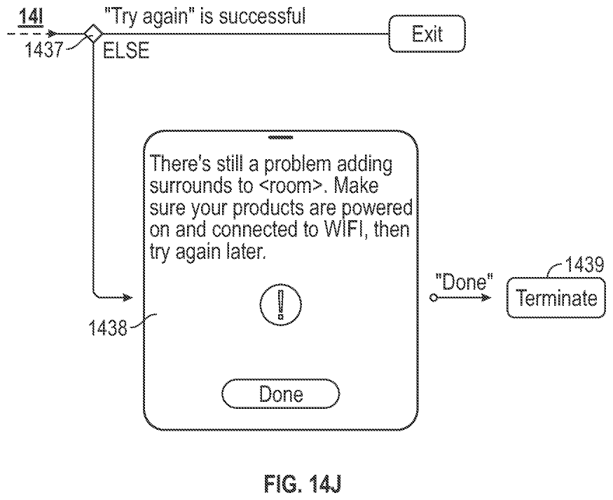

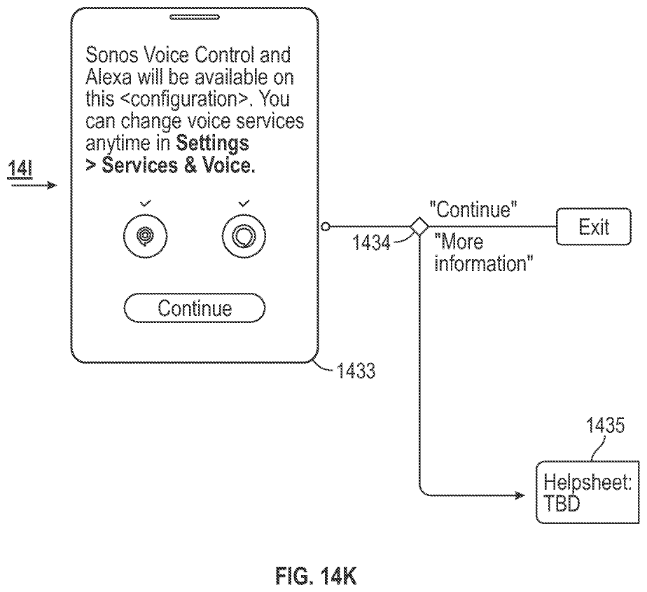

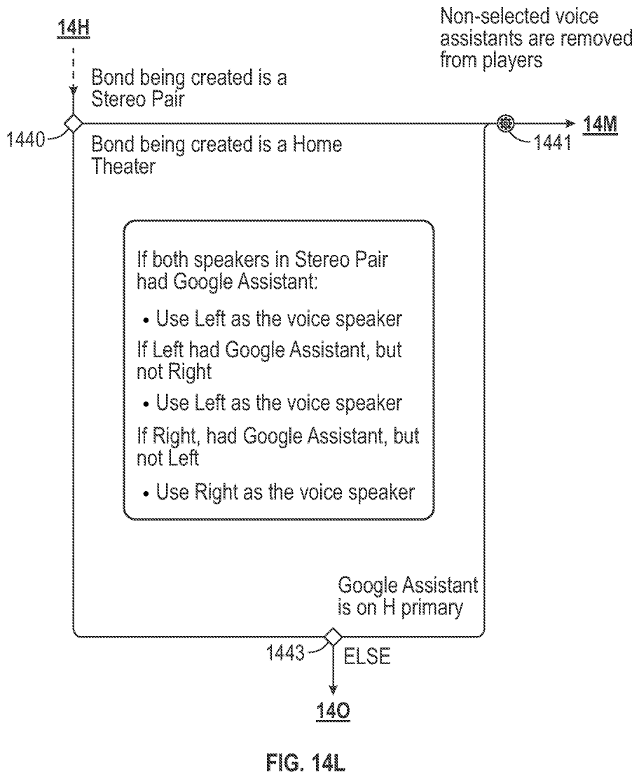

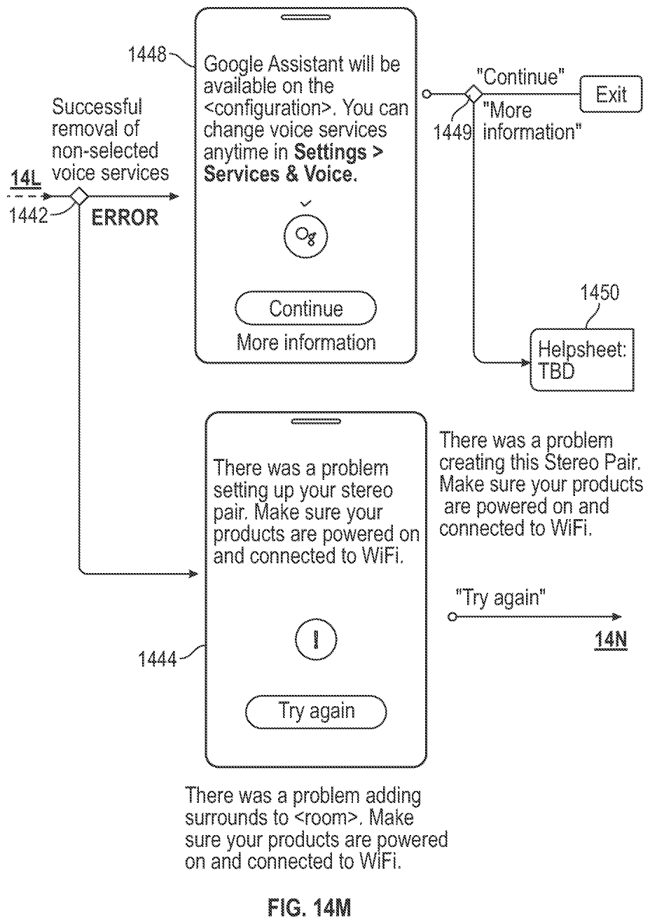

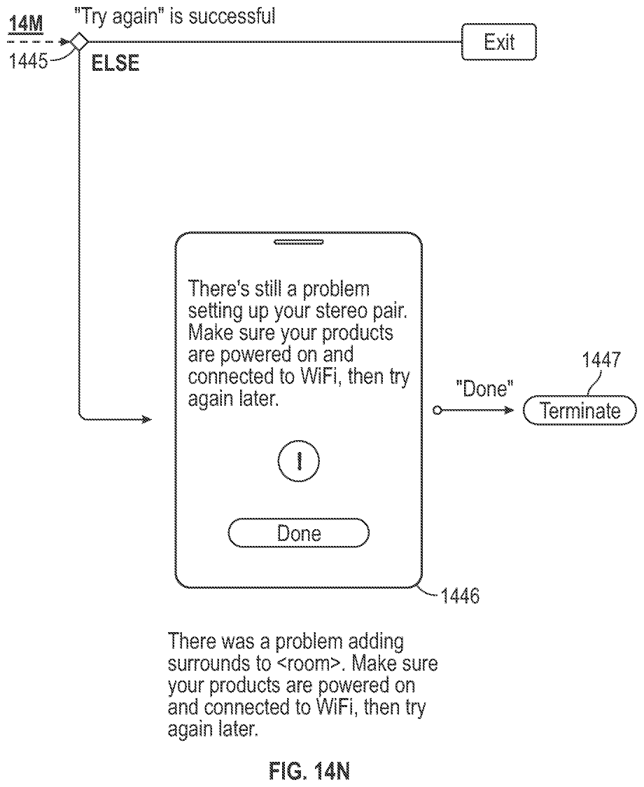

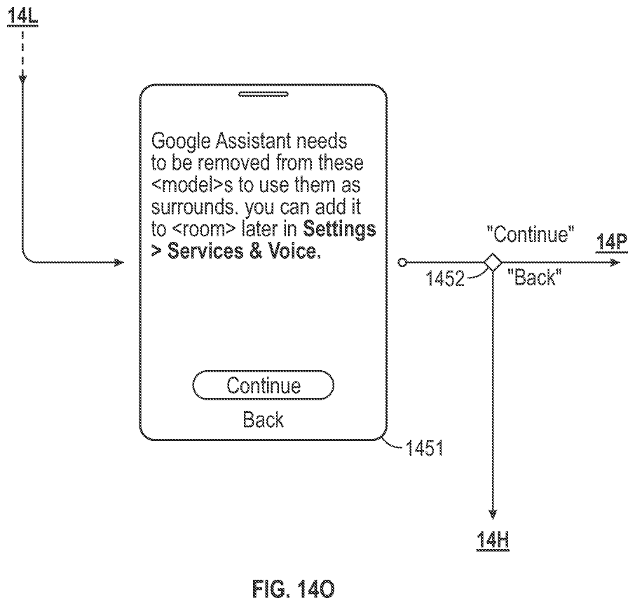

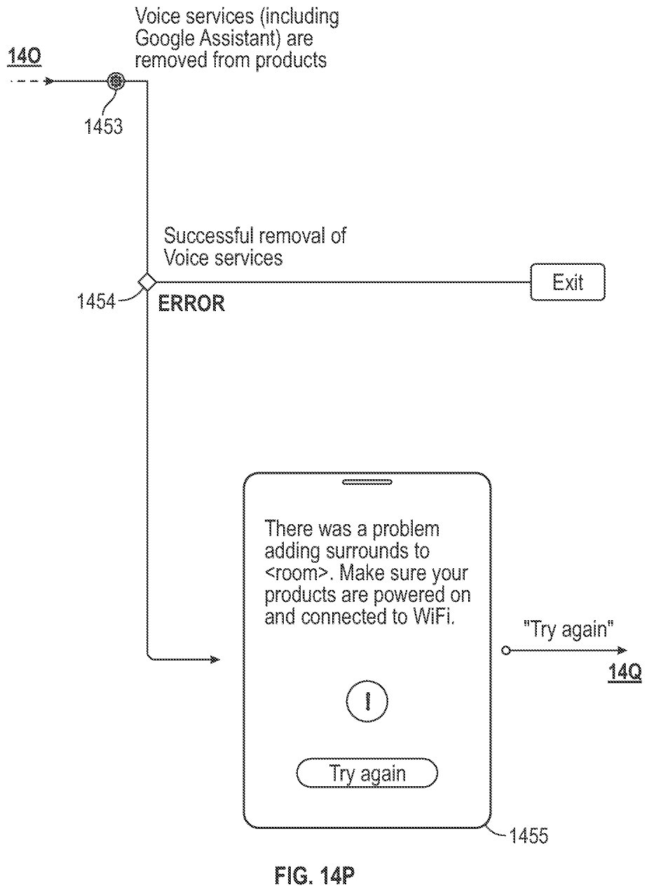

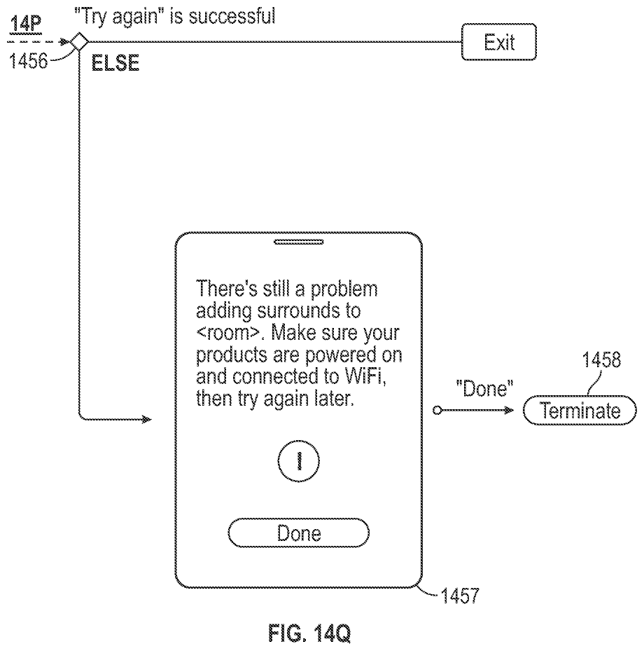

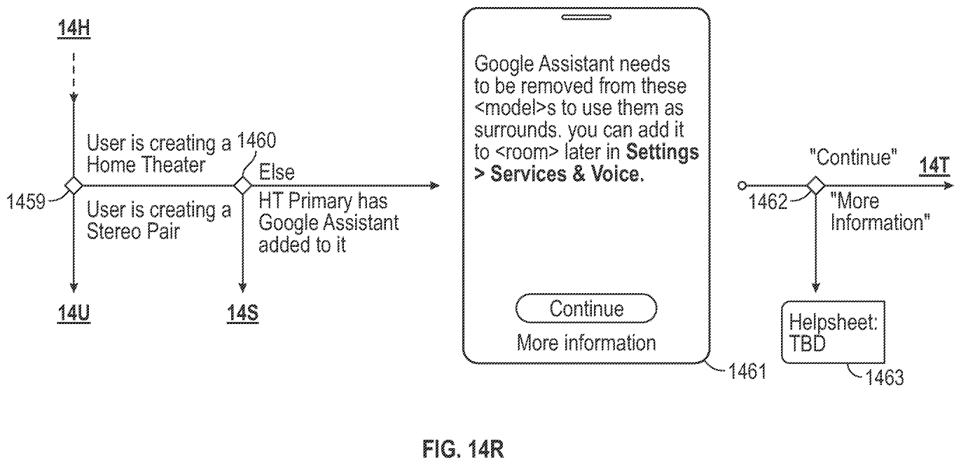

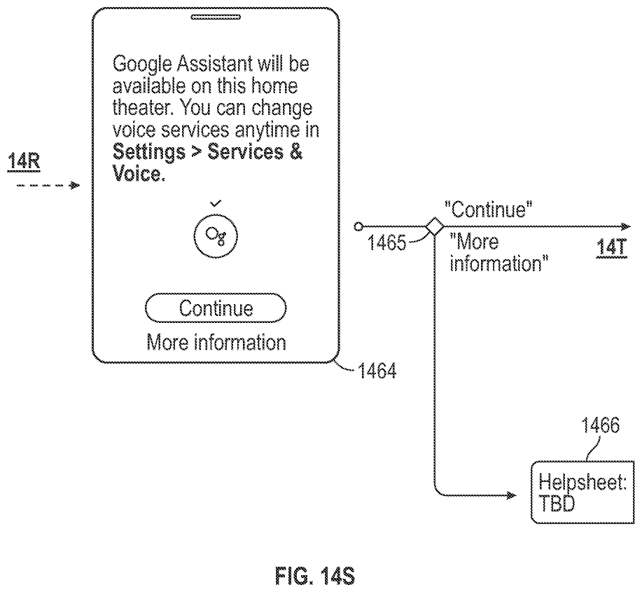

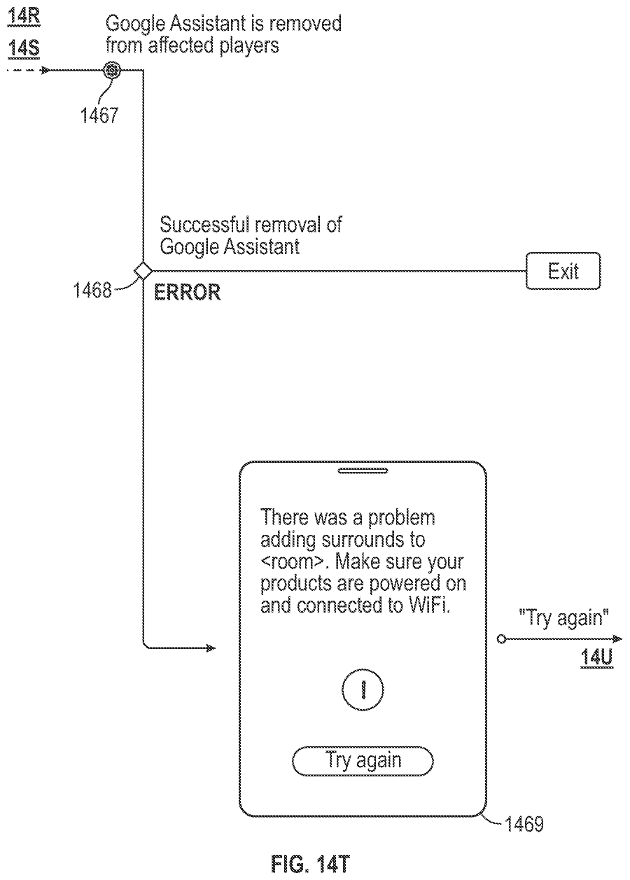

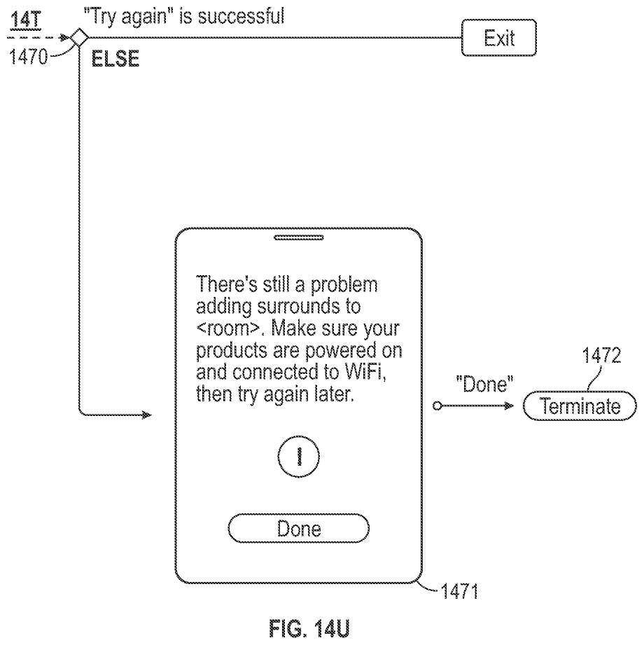

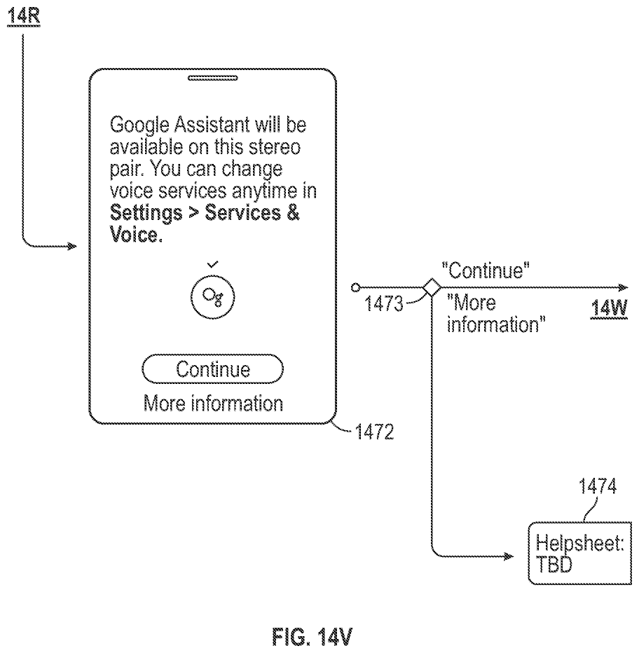

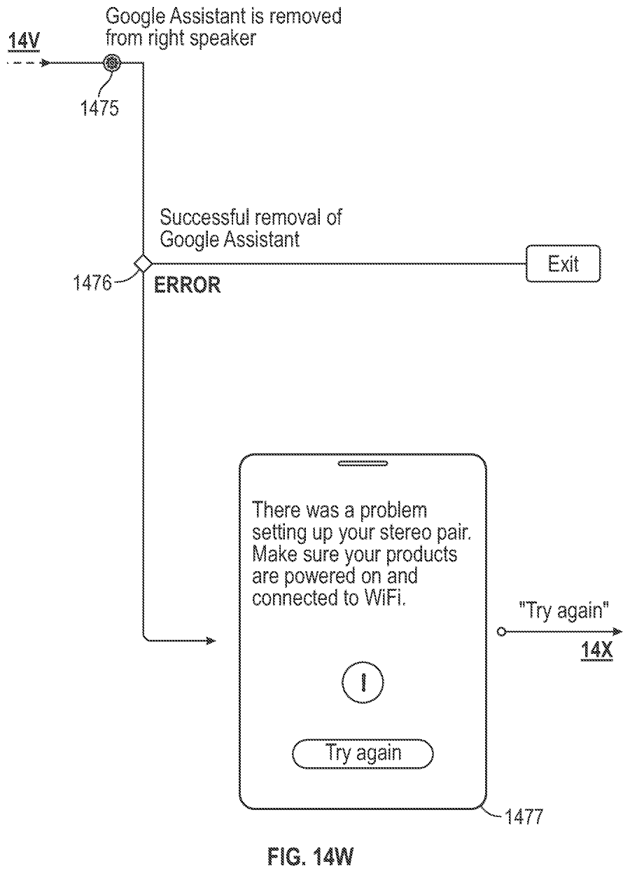

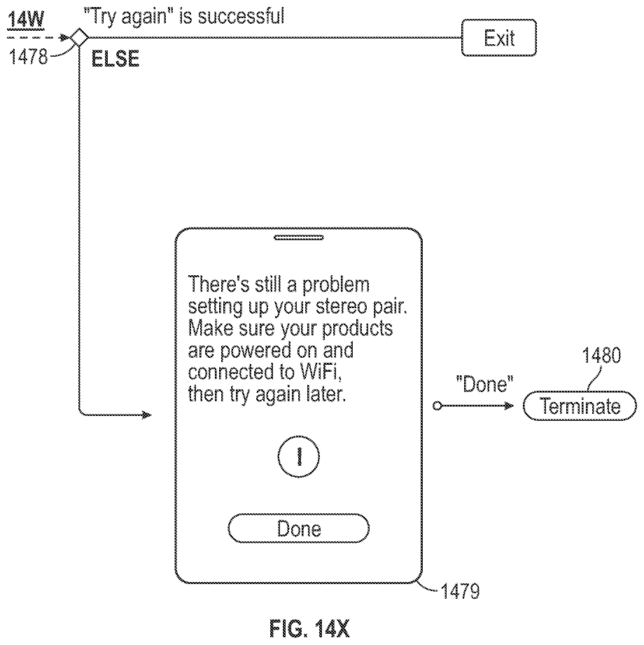

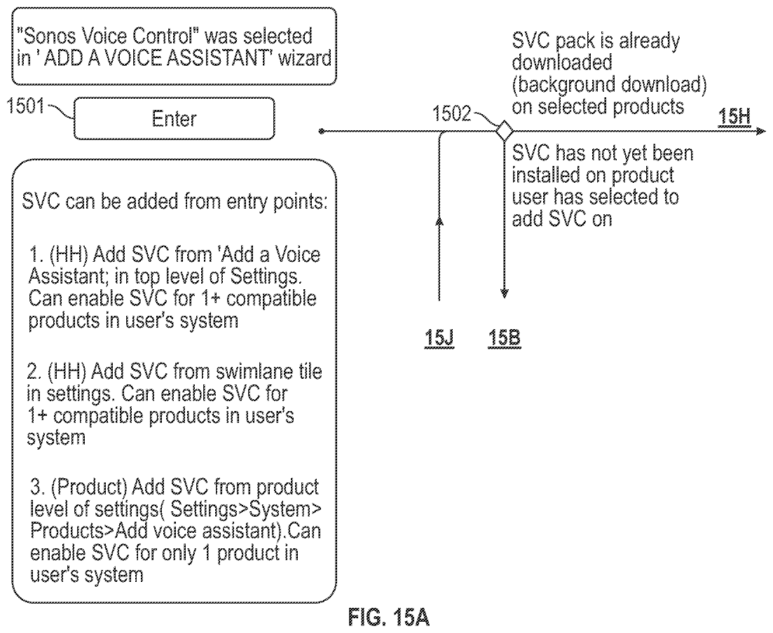

FIGS. 14A-14X illustrate an example process and associated user interfaces for bonding play back devices together and for configuring VAS associations among the play back devices. As noted previously, there may be certain restrictions regarding which playback device(s) can be associated with which VASes. These restrictions can depend on the configuration of the playback devices (e.g., bonded as a stereo pair, home theatre arrangement, etc.), as well as on the particular identify of the various VASes attempted to be associated with the devices.

As shown in FIG. 14A, at stage 1401, a user initiates a bonding wizard process. This can be invoked via a request made via a control device or otherwise to bond two or more playback devices together for synchronous playback. In decision block 1402, the system determines whether there are voice assistants in existence (i.e., downloaded and/or enabled) on any of the play back devices of the system. If there are zero VASes existing on the play back device(s) at the time of bonding, the process exits as there are no VAS-related restrictions to bonding the play back devices or otherwise forming a synchrony group. In decision block 1403, the system determines whether there are one or more VASes on the playback device at the time of bonding. If there are two or more VASes on the playback devices, the process continues decision block 1404, with determining whether the user is creating a stereo pair or whether the user is creating a home theater arrangement. If the user is creating a stereo pair, the process continues to the steps shown in FIG. 14B.

If the user is creating a home theatre arrangement, the process continues to decision block 1408, in which the system determines whether the voice assistant to be added is AMAZON Alexa, the native VAS (e.g., Sonos Voice Control), or GOOGLE Assistant. If the selected VAS is either AMAZON Alexa or the native VAS, the process continues as shown in FIG. 14C.

If, in decision block 1408, the selected VAS is GOOGLE Assistant, the process continues to decision block 1412. Here, the system determines whether GOOGLE Assistant will be on the home theatre primary product (e.g., the soundbar, or the most capable device of the home theatre arrangement (e.g., most memory, fastest processor, highest computational capacity, fastest network connection, etc.) or on non-primary products (e.g., surround-sound playback devices). If the GOOGLE Assistant VAS is on the primary product, the process continues as shown in FIG. 14D, otherwise the process continues as shown in FIG. 14E.

As shown in FIG. 14B, the process continues with displaying the interface 1405. The interface 1405 informs the user that a particular VAS will be available on the stereo pair. The interface 1405 can prompt the user to select “Continue” or “More information.” After the interface 1405, the process continues with decision block 1406, where the system determines whether the user selects “Continue” or “More information.” If the user selects “Continue,” the process continues to exit. If the user selected “More information,” the process continues to the stage 1407 and displays a help sheet.

Referring to FIG. 14C, the process continues with displaying the interface 1409. The interface 1409 informs the user that the specific VAS will be available on the home theater. The interface 1409 can prompt the user to select “Continue” or “More information.” After the interface 1409, the process continues with decision block 1410, where the system determines whether the user selected “Continue” or “More information.” If the user selected “Continue,” the process continues to exit. If the user selected “More information,” the process continues to the stage 1411 and displays a help sheet.

As illustrated in FIG. 14D, from the process portion shown in FIG. 14A, the process continues with displaying the interface 1413. The interface 1413 informs the user that GOOGLE Assistant will be available on the playback device. The interface 1413 can prompt the user to select “Continue” or “More information.” After the interface 1413, the process continues with decision block 1414, where the system determines whether the user selected “Continue” or “More information.” If the user selected “Continue,” the process continues to exit. If the user selected “More information,” the process continues to the stage 1415 and displays a help sheet.

Referring now to FIG. 14E, the process continues with displaying the interface 1416. The interface 1416 can inform the user that GOOGLE Assistant needs to be removed from the playback device to use the playback device as a surround. The interface 1416 can prompt the user to select “Continue” or “More information.” After the interface 1416, the process continues to decision block 1417, where the system determines whether the user selected “Continue” or “More information.” If the user selected “More information,” the process continues to the stage 1418 and displays a help sheet. If the user selected “Continue,” the process continues to event 1419, as shown in FIG. 14F, in which GOOGLE Assistant is removed from the play back device. After event 1419, the process continues to decision block 1420.

With continued reference to FIG. 14F, the process continues with displaying the interface 1421 if there is an error removing the GOOGLE Assistant as reflected in decision block 1420. The interface 1421 informs the user that there was a problem with the play back devices and prompts the user to “Try again.” If the user selects “Try again,” the process continues as shown in FIG. 14G.

As shown in FIG. 14G, the process continues to decision block 1422, in which the system determines whether the “Try again” function was successful. If the “Try again” function was successful, the process continues to exit, otherwise, the system displays the interface 1423. The interface 1423 informs the user that there is still a problem with the play back device and to try again at a later time. The interface 1423 prompts the user to select “Done.” If the user selects “Done,” the process continues to stage 1424 and terminates.

Referring now to FIG. 14H, the process continues to decision block 1425. At decision block 1425, the system determines whether the VASes will work concurrently. As noted previously, there may be various concurrency restrictions that depend on the identity of the VASes, on the hardware capabilities of the play back devices, and/or other suitable factors. The concurrency can restrict operation of VASes on a single play back device, or concurrent operation of devices that are bonded as part of a stereo pair, home theatre arrangement, or other such configuration. If, in decision block 1425, the VASes will work concurrently, the process continues with displaying the interface 1426. The interface 1426 informs the user that the VASes will be available in this configuration. The interface 1426 can prompt the user to select “Continue” or “More information.” After the interface 1426, the process continues with decision block 1427, where the system determines whether the user selected “Continue” or “More information.” If the user selected “Continue,” the process continues as shown in FIG. 14I. If the user selected “More information,” the process continues to the stage 1428 and displays a help sheet.

Returning to decision block 1425, if the VASes cannot work concurrently, the process proceed to decision block 1429. At decision block 1429, the system determines whether the bond being created contains GOOGLE Assistant with another VAS or with another play back device having GOOGLE Assistant. If the bonded group being created contains two GOOGLE Assistants, the process continues as shown in FIG. 14R. If the bonded group being created contains another VAS, the process continues with displaying the interface 1429-1. The interface 1429-1 informs the user that some VASes cannot be used together on a configuration. The interface 1429-1 can prompt the user to select which VAS the user would like to keep and to select “Continue” or “More information.” If the user selects a VAS, the process continues to decision block 1430, in which the system determines which VAS was selected. If the user selected GOOGLE Assistant, the process continues as shown in FIG. 14L. If the user selected another VAS, the process continues as shown in FIG. 14I.

Referring now to FIG. 14I, at event 1431, non-selected VASes are removed from the play back devices. After the event 1431, the process continues to decision block 1432. At decision block 1432, the system determines whether the non-selected VASes were successfully removed. If the VASes were successfully removed, the process continues as shown in FIG. 14K. If there was an error, the process continues with displaying the interface 1436. The interface 1436 informs the user that there was a problem with the surround play back devices and prompts the user to “Try again.” If the user selects “Try again,” the process continues as shown in FIG. 14J.

As illustrated in FIG. 14J, the process continues to decision block 1437, in which the system determines whether the “Try again” function was successful. If the “Try again” function was successful, the process continues to exit, otherwise, the system displays the interface 1438. The interface 1438 informs the user that there is still a problem with the surround play back device and to try again at a later time. The interface 1438 prompts the user to select “Done.” If the user selects “Done,” the process continues to stage 1439 and terminates.

FIG. 14K illustrates the process continuing with displaying the interface 1433. The interface 1433 shows the user that one or more VASes will be available on this configuration (e.g., the Sonos Voice Control VAS and AMAZON Alexa). The interface 1433 can prompt the user to select “Continue” or “More information.” After the interface 1433, the process continues with decision block 1434, where the system determines whether the user selected “Continue” or “More information.” If the user selected “Continue,” the process continues to exit. If the user selected “More information,” the process continues to the stage 1435 and displays a help sheet.

Referring to FIG. 14L, the process continues to decision block 1440. At decision block 1440, the system determines whether the bond being created is a stereo pair or a home theater. If the bond is a stereo pair, the process continues to the event 1441, where non-selected VASes are removed from the playback devices. After the event 1441, the process continues as shown in FIG. 14M. If, at decision block 1440, if the bond being created is a home theater, the process continues decision block 1443, where the system determines whether GOOGLE Assistant is on the primary playback device. If GOOGLE Assistant is on the primary play back device, the process continues to the event 1441, otherwise, the process continues as shown in FIG. 14O.

Turning now to FIG. 14M, the process continues to decision block 1442, in which the system determines whether the VASes were successfully removed. If the VASes were successfully removed, the process continues with displaying the interface 1448. The interface 1448 informs the user that GOOGLE Assistant can be available on this configuration. The interface 1448 can prompt the user to select “Continue” or “More information.” After the interface 1448, the process continues with decision block 1449, in which the system determines whether the user selected “Continue” or “More information.” If the user selected “Continue,” the process continues to exit. If the user selected “More information,” the process continues to the stage 1450 and displays a help sheet.

If, at decision block 1442, there is an error, the process continues with displaying the interface 1444. The interface 1444 informs the user that there was a problem with setting up the stereo pair and prompts the user to “Try again.” If the user selects “Try again,” the process continues as shown in FIG. 14N.

As illustrated in FIG. 14N, the process continues at decision block 1445, in which the system determines whether the “Try again” function was successful. If the “Try again” function was successful, the process continues to exit, otherwise, the system displays the interface 1446. The interface 1446 informs the user that there is still a problem with the stereo pair and to try again at a later time. The interface 1446 prompts the user to select “Done.” If the user selects “Done,” the process continues to stage 1447 and terminates.

Referring to FIG. 14O, the process continues from that shown in FIG. 14L to displaying the interface 1451. The interface 1451 informs the user that GOOGLE Assistant needs to be removed from the play back device. The interface 1451 can prompt the user to select “Continue” or “Back.” After the interface 1451, the process continues to decision block 1452. At decision block 1452, the system determines whether the user selected “Continue” or “Back.” If the user selected “Back,” the process returns to that process portion shown in FIG. 14H. If the user selected “Continue” the process continues as shown in FIG. 14P.

As illustrated in FIG. 14P, at event 1453, the VAS is removed from the playback device(s). After the event 1453, the process continues to decision block 1454, in which the system determines whether the VAS was successfully removed or if there was an error. If the VAS was successfully removed, the process continues to exit. If there was an error, the process continues with displaying the interface 1455. The interface 1455 informs the user that there was a problem with the playback devices and prompts the user to “Try again.” If the user selects “Try again,” the process continues as shown in FIG. 14Q.

Referring now to FIG. 14Q, the process continues to decision block 1456, in which the system determines whether the “Try again” function was successful. If the “Try again” function was successful, the process continues to exit, otherwise, the system displays the interface 1457. The interface 1457 informs the user that there is still a problem with the playback device and to try again at a later time. The interface 1457 prompts the user to select “Done.” If the user selects “Done,” the process continues to stage 1458 and terminates.

As illustrated in FIG. 14R, the process continues to decision block 1459. At decision block 1459, the system determines whether the user is creating a home theater or if the user is creating a stereo pair. If the user is creating a stereo pair, the process continues as shown in FIG. 14U. If the user is creating a home theater, the process continues to decision block 1460, where the system determines whether the primary playback device has GOOGLE Assistant added. If the primary playback device has GOOGLE Assistant added, the process continues as shown in FIG. 14S, otherwise, the process continues with displaying the interface 1461. The interface 1461 can inform the user that GOOGLE Assistant needs to be removed from the play back device. The interface 1461 can prompt the user to select “Continue” or “More information.” After the interface 1461, the process continues with decision block 1462, in which the system determines whether the user selected “Continue” or “More information.” If the user selected “Continue,” the process continues as shown in FIG. 14R. If the user selected “More information,” the process continues to the stage 1463 and displays a help sheet.

Referring to FIG. 14S, the process continues with displaying the interface 1464. The interface 1464 shows the user that GOOGLE Assistant will be available on this home theater. The interface 1464 can prompt the user to select “Continue” or “More information.” After the interface 1464, the process continues with decision block 1465, in which the system determines whether the user selected “Continue” or “More information.” If the user selected “Continue,” the process continues as shown in FIG. 14T. If the user selected “More information,” the process continues to the stage 1466 and displays a help sheet.

As illustrated in FIG. 14T, the process continues with the event 1467, in which the GOOGLE Assistant is removed from the playback device(s). The process then continues to decision block 1468, where the system determines whether GOOGLE Assistant was successfully removed or if there was an error. If GOOGLE Assistant was successfully removed, the process continues to exit. If there was an error, the process continues by displaying the interface 1469. The interface 1469 informs the user that there was a problem with the play back devices and prompts the user to “Try again.” If the user selects “Try again,” the process continues as shown in FIG. 14U.

With reference to FIG. 14U, the process continues to decision block 1470, in which the system determines whether the “Try again” function was successful. If the “Try again” function was successful, the process continues to exit, otherwise, the system displays the interface 1471. The interface 1471 informs the user that there is still a problem with the playback device and to try again at a later time. The interface 1471 prompts the user to select “Done.” If the user selects “Done,” the process continues to stage 1472 and terminates

Referring now to FIG. 14V, the process continues with displaying the interface 1472. The interface 1472 informs the user that GOOGLE Assistant can be available on the stereo pair. This availability may require that the GOOGLE Assistant be removed from one of the devices within the stereo pair (e.g., just the Right playback device). The interface 1472 can prompt the user to select “Continue” or “More information.” After the interface 1472, the process continues with decision block 1473, in which the system determines whether the user selected “Continue” or “More information.” If the user selected “More information,” the process continues to the stage 1474 and displays a help sheet. If the user selected “Continue.” the process continues as shown in FIG. 14W, in which, at event 1475, GOOGLE Assistant is removed from the playback device (e.g., removed from the Right playback device). In some examples, the GOOGLE Assistant may remain associated with the other playback device(s) within the bonded group (e.g., still active on the Left playback device of a stereo pair). After the event 1475, the process continues to decision block 1476, in which the system determines whether the GOOGLE Assistant was successfully removed or if there was an error. If GOOGLE Assistant was successfully removed, the process continues to exit. If there was an error, the process continues with displaying the interface 1477. The interface 1477 informs the user that there was a problem with setting up the stereo pair and prompts the user to “Try again.” If the user selects “Try again,” the process continues as shown in FIG. 14X.

As shown in FIG. 14X, at decision block 1478, the system determines whether the “Try again” function was successful. If the “Try again” function was successful, the process continues to exit, otherwise, the system displays the interface 1479. The interface 1479 informs the user that there is still a problem with the stereo pair and to try again at a later time. The interface 1479 prompts the user to select “Done.” If the user selects “Done,” the process continues to stage 1480 and terminates.

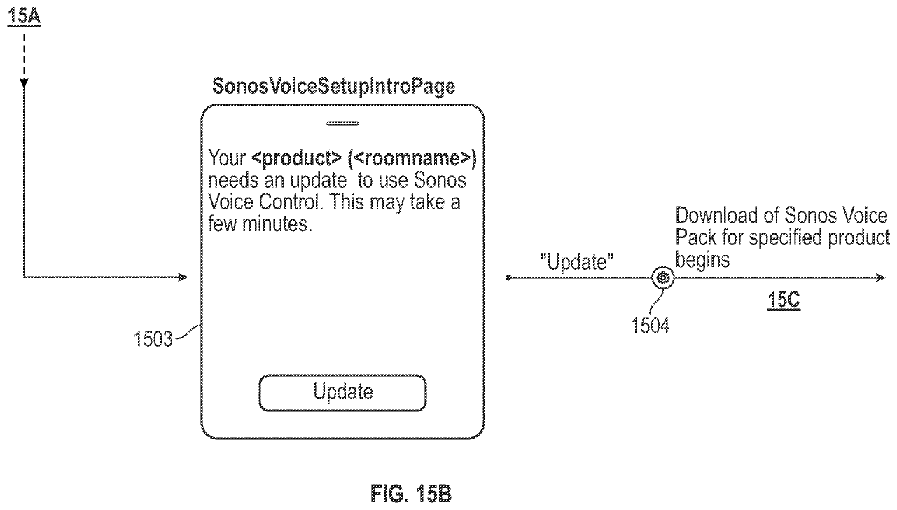

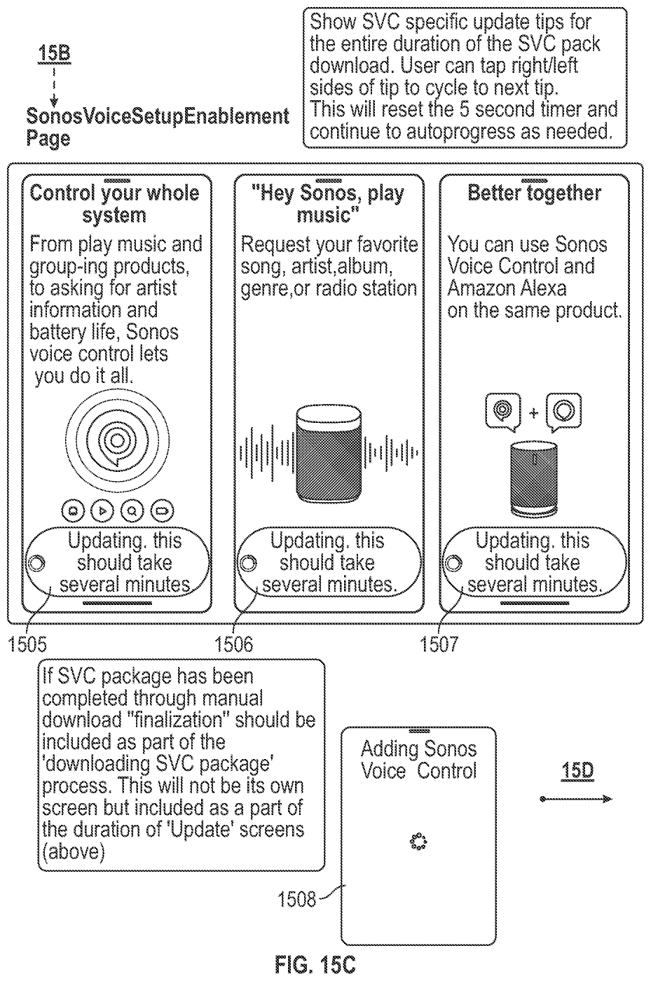

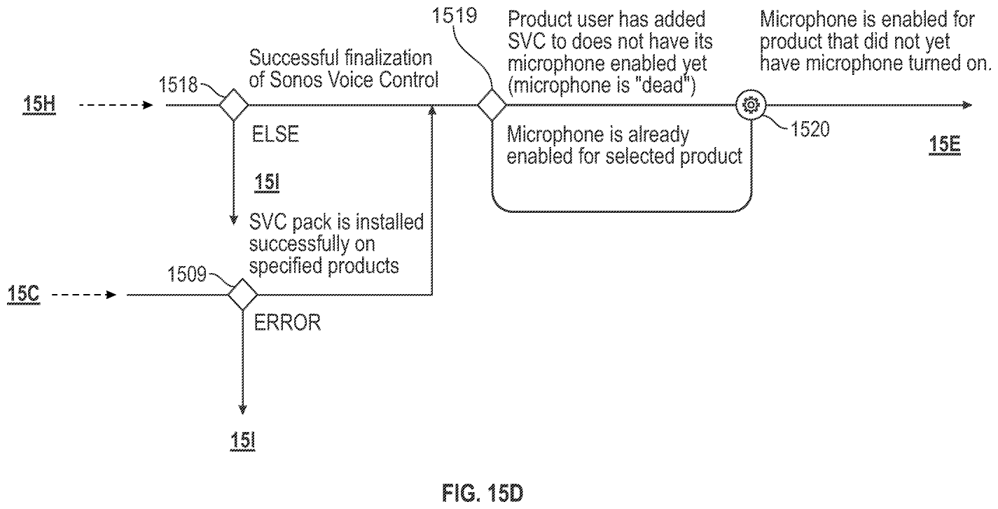

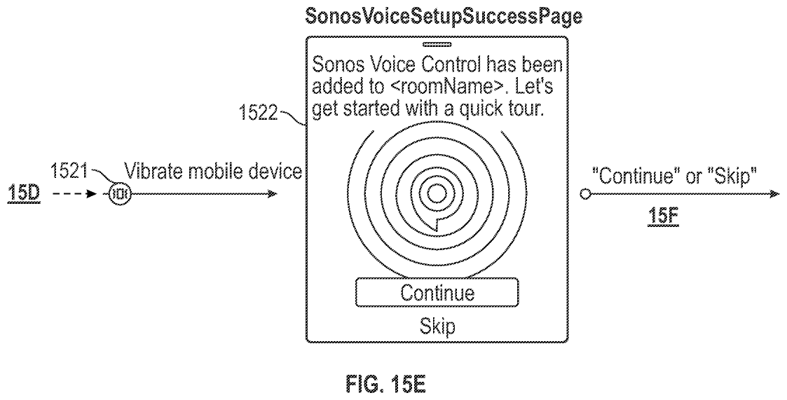

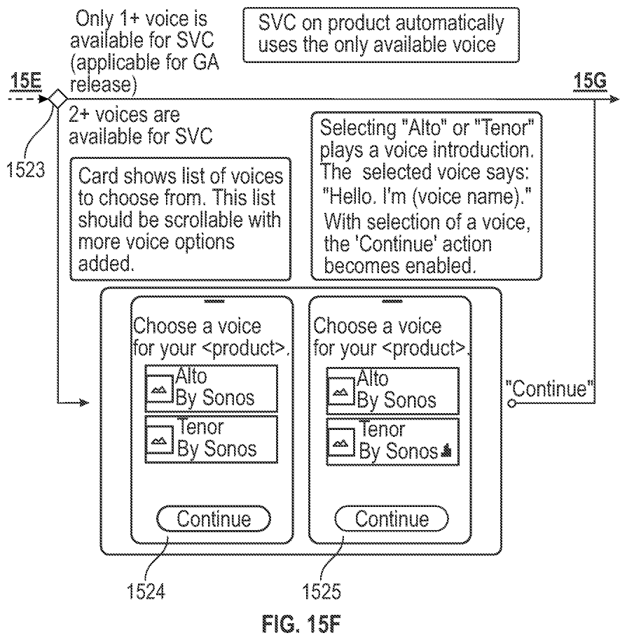

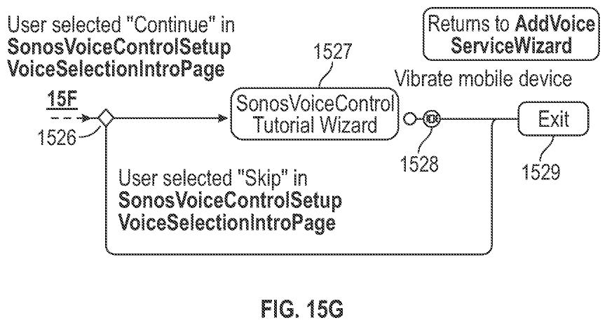

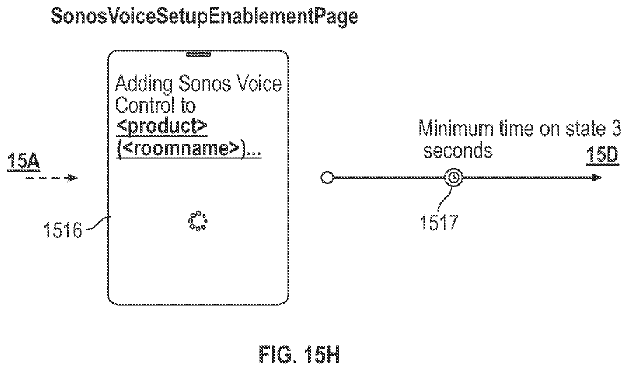

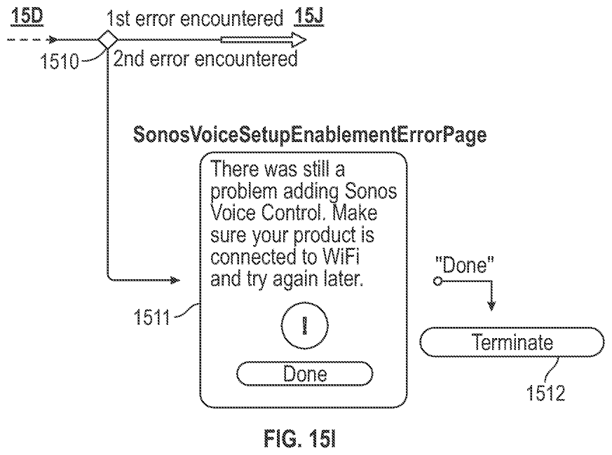

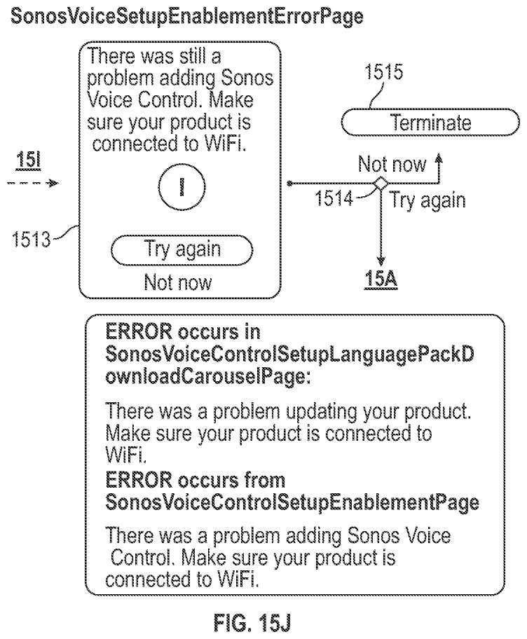

FIGS. 15A-15J illustrate an example process and associated user interfaces for configuring a native VAS (e.g., Sonos Voice Control for Sonos-branded playback devices). Referring to FIG. 15A, the process begins at stage with a user entering the native VAS Setup Wizard. After stage 1501, the process continues to decision block 1502. At decision block 1502, the system determines whether native VAS pack is already downloaded on the selected play back devices or if the native VAS has not yet been installed on the play back device that a user has selected. If the native VAS has been downloaded, the process continues as shown in FIG. 15B. If the native VAS pack is already downloaded, the process continues as shown in FIG. 15H.

Referring now to FIG. 15B, the process continues by displaying the interface 1503. The interface 1503 informs the user that a selected play back device needs an update and prompts the user to select “Update.” If the user selects update, the event 1504 starts and the native VAS is downloaded to the specified play back device. After the event 1504, the process continues as shown in FIG. 14C, in which the process continues with displays one or more of the interfaces 1505, 1506, 1507, 1508. The interfaces 1505, 1506, 1507 can provide helpful tips to the user, such as displaying a particular use of the native VAS on the selected playback device, for example. The interface 1508 can display to the user that the system is adding the native VAS. After displaying one or more of the interfaces 1505, 1506, 1507, 1508, the process continues to FIG. 15D.

As shown in FIG. 15D, at block 1509, the system determines whether the native VAS was successfully downloaded onto the selected playback device, or if there was an error. If there was an error, the process continues as shown in FIG. 15I. If the native VAS was successfully downloaded, the process continues to decision block 1519. At decision block 1519, the system determines whether the playback device has enabled its microphone. If the microphone is not enabled, the process continues to the event 1520, in which the play back device enables its microphone and then proceeds as shown in FIG. 15E. Once the microphone is enabled, the process continues as shown in FIG. 15E. As also shown in FIG. 15D, the process can return from the process portion shown in FIG. 15H to decision block 1518, in which the system determines whether the native VAS was successfully finalized. If the native VAS was successfully finalized, the process continues to decision block 1519, otherwise the process continues as shown in FIG. 15I.

Turning now to FIG. 15E, the process continues with the event 1521. At the event 1521, the system alerts the user by vibrating the control device. After the event 1521, the process involves displaying the interface 1522. The interface 1522 informs the user that the native VAS has been added to a particular area, and then asks the user if she would like a tutorial. The interface 1522 prompts the user to select the option “Continue” or “Skip.” The process then proceeds to that shown in FIG. 15F.

As shown in FIG. 15F, the process continues to decision block 1523, in which the system determines whether there are more than one voice available for the native VAS. If there is only one voice available, the process continues as shown in FIG. 15G. If there are two or more voices available, the process continues by displaying one or more of the interfaces 1524, 1525. The interfaces 1524, 1525 provide the user with a list of voices to select and prompt the user to select “Continue” when the user has made her desired selection. After the interface 1524, 1525, the process continues as shown in FIG. 15G.

Referring to FIG. 14G, the process continues with decision block 1526. At decision block 1526, the system determines whether the user selected “Continue” in the voice selection page, or whether the user skipped the voice selection. If the user selected “Continue,” the process continues to stage 1527, in which the Sonos Voice Control Tutorial Wizard is run. This program can, for example, provide a tutorial with examples for the user, including sample commands and recommended use cases. After stage 1527, the event 1528 starts, which alerts the user by vibrating the control device. After the event 1528, the process continues to the stage 1529 and exits. If the user skipped the voice selection, the process continues to the stage 1529 and exits.

With reference now to FIG. 15H, the process can continue from the process portion shown in FIG. 15A to display the interface 1516. The interface 1516 displays to the user that the system is adding the native VAS to the selected playback device. After the interface 1516, the process continues to the event 1517, in which the system waits a minimum time at this state (e.g., three seconds). After the event 1517, the process continues as shown in FIG. 15D described above.

In FIG. 15I, the process continues from that shown in FIG. 15D, and continues to decision block 1510, in which the system determines whether the first error was encountered or if the second error was encountered. If the first error was encountered, the process continues as shown in FIG. 15J with a possible second attempt. If, however, the second error was encountered, the process continues by displaying the interface 1511. The interface 1511 informs the user that there is still a problem adding the native VAS and to try again later. The interface 1511 prompts the user to select “Done.,” and if the user does so, the process continues to stage 1512 and terminates.

FIG. 15J illustrates the process continuing from that shown in FIG. 15I with displaying the interface 1513. In this instance, since only a first error has been encountered, the user is given the option to try again. As such, the interface 1513 shows the user that there was a problem adding the native VAS to the play back device and to make sure that play back device is connected to Wi-Fi. The interface 1513 also prompts the user to select the options “Try again” or “Not now.” After the interface 1513, the process continues to decision block 1514, in which the system determines whether the user selected “Try again” or “Not Now.” If the user selected “Try again,” the process returns to the process portion shown in FIG. 15A. If the user selected “Not now,” the process terminates at stage 1515.

### V. Conclusion

The above discussions relating to play back devices, controller devices, play back zone configurations, voice assistant services, and media content sources provide only some examples of operating environments within which functions and methods described below may be implemented. Other operating environments and configurations of media play back systems, play back devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways) to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

1.-19. (canceled)

20. A first playback device comprising:
one or more microphones;
one or more processors; and
one or more computer-readable media storing instructions that, when executed by the one or more processors, cause the first playback device to perform operations comprising:
associating the first playback device with a first voice assistant service (VAS);
receiving a command to form a synchrony group for synchronous audio playback, the synchrony group including the first playback device and a second playback device;
obtaining an indication that the second playback device is associated with a second VAS different from the first;
accessing a rules engine to determine concurrency restrictions; and
based at least in part on the determination of the concurrency restrictions:
disassociating the first playback device and the first VAS;
disassociating the second playback device and the second VAS; or
precluding formation of the synchrony group.

21. The first playback device of claim 20, wherein the first VAS is associated with a first wake word, and the second VAS is associated with a second wake word different from the first, and wherein associating the first playback device with the first VAS comprises activating a first wake-word engine configured to detect the first wake word in sound data captured via the one or more microphones.

22. The first playback device of claim 20, wherein the concurrency restrictions are based at least in part on the identity of the first VAS and the identity of the second VAS.

23. The first playback device of claim 20, wherein accessing the rules engine comprises:
transmitting a request to one or more remote computing devices, wherein the request comprises identification of the first VAS and the second VAS; and
after transmitting the request, receiving state information corresponding to the concurrency restrictions.

24. The first playback device of claim 20, wherein the rules engine includes limitations to associating the first playback device with one or more VASes, wherein the limitations comprise at least one of (i) a maximum number of VASes that can be associated with the first playback device, and (ii) an indication of whether particular VASes may be concurrently associated with the first playback device.

25. The first playback device of claim 20, wherein the synchrony group comprises a bonded stereo pair or a home theatre configuration.

26. The first playback device of claim 20, wherein the operations further comprise:
disassociating the second playback device and the second VAS;
forming the synchrony group including the first playback device and the second playback device while the first playback device remains associated with the first VAS;
receiving a command to associate a third VAS with the first playback device and/or the second playback device, the third VAS being different from the second VAS;
accessing the rules engine to determine concurrency restrictions; and
after determining the concurrency restrictions, associating the third VAS with the first playback device and/or the second playback device.

27. The first playback device of claim 20, wherein the operations further comprise:
restricting formation of the synchrony group, the synchrony group is a first synchrony group comprising a bonded group;
after restricting formation of the synchrony group, receiving a command to form a second synchrony group including the first playback device and the second playback device, wherein the second synchrony group is not a bonded group;
accessing the rules engine to determine concurrency restrictions; and
after determining the concurrency restrictions, forming the second synchrony group while the first playback device is associated with the first VAS and the second playback device is associated with the second VAS.

28. A method comprising:
associating a first playback device with a first voice assistant service (VAS);
receiving a command to form a synchrony group for synchronous audio playback, the synchrony group including the first playback device and a second playback device;
obtaining a determination that the second playback device is associated with a second VAS different from the first;
accessing a rules engine to determine concurrency restrictions; and
based at least in part on the determination of the concurrency restrictions:
disassociating the first playback device and the first VAS;
disassociating the second playback device and the second VAS; or
precluding formation of the synchrony group.

29. The method of claim 28, wherein the first VAS is associated with a first wake word, and the second VAS is associated with a second wake word different from the first, and wherein associating the first playback device with the first VAS comprises activating a first wake-word engine configured to detect the first wake word in sound data captured via one or more microphones of the first playback device.

30. The method of claim 28, wherein the concurrency restrictions are based at least in part on the identity of the first VAS and the identity of the second VAS.

31. The method of claim 28, wherein accessing the rules engine comprises:
transmitting a request to one or more remote computing devices, wherein the request comprises identification of the first VAS and the second VAS; and
after transmitting the request, receiving state information corresponding to the concurrency restrictions.

32. The method of claim 28, wherein the rules engine includes limitations to associating the the first playback device with one or more VASes, wherein the limitations comprise at least one of (i) a maximum number of VASes that can be associated with the first playback device, and (ii) an indication of whether particular VASes may be concurrently associated with the first playback device.

33. The method of claim 28, wherein the synchrony group comprises a bonded stereo pair or a home theatre configuration.

34. The method of claim 28, further comprising:
disassociating the second playback device and the second VAS;
forming the synchrony group including the first playback device and the second playback device while the first playback device remains associated with the first VAS;
receiving a command to associate a third VAS with the first playback device and/or the second playback device, the third VAS being different from the second VAS;
accessing the rules engine to determine concurrency restrictions; and
after determining the concurrency restrictions, associating the third VAS with the first playback device and/or the second playback device.

35. The method of claim 28, further comprising:
restricting formation of the synchrony group, the synchrony group is a first synchrony group comprising a bonded group;
after restricting formation of the synchrony group, receiving a command to form a second synchrony group including the first playback device and the second playback device, wherein the second synchrony group is not a bonded group;
accessing the rules engine to determine concurrency restrictions; and
after determining the concurrency restrictions, forming the second synchrony group while the first playback device is associated with the first VAS and the second playback device is associated with the second VAS.

36. A tangible, non-transitory computer-readable medium storing instructions that, when executed by one or more processors of a first playback device, cause the first playback device to perform operations comprising:
associating a first playback device with a first voice assistant service (VAS);
receiving a command to form a synchrony group for synchronous audio playback, the synchrony group including the first playback device and a second playback device;
obtaining a determination that the second playback device is associated with a second VAS different from the first;
accessing a rules engine to determine concurrency restrictions; and
based at least in part on the determination of the concurrency restrictions:
disassociating the first playback device and the first VAS;
disassociating the second playback device and the second VAS; or
precluding formation of the synchrony group.

37. The computer-readable medium of claim 36, wherein the first VAS is associated with a first wake word, and the second VAS is associated with a second wake word different from the first, and wherein associating the first playback device with the first VAS comprises activating a first wake-word engine configured to detect the first wake word in sound data captured via one or more microphones of the first playback device.

38. The computer-readable medium of claim 36, wherein the concurrency restrictions are based at least in part on the identity of the first VAS and the identity of the second VAS.

39. The computer-readable medium of claim 36, wherein accessing the rules engine comprises:
transmitting a request to one or more remote computing devices, wherein the request comprises identification of the first VAS and the second VAS; and
after transmitting the request, receiving state information corresponding to the concurrency restrictions.
